(19) United States
(12) Patent Application Publication
(10) Pub. No.: US 2017/0337838 A1
(43) Pub. Date: Nov. 23, 2017

(54) METHODS AND APPARATUS FOR LEARNING STYLE PREFERENCE ASSESSMENT

(71) Applicant: Tamera Elkon, Dallas, TX (US)

(72) Inventor: Tamera Elkon, Dallas, TX (US)

(21) Appl. No.: 15/599,349

(22) Filed: May 18, 2017

Related U.S. Application Data
(60) Provisional application No. 62/338,408, filed on May 18, 2016.
(60) Provisional application No. 62/347,505, filed on Jun. 8, 2016.
(60) Provisional application No. 62/339,746, filed on May 20, 2016.
(60) Provisional application No. 62/348,081, filed on Jun. 9, 2016.

(51) Int. Cl. G09B 7/04; G06F 3/048; G06F 17/30; G06N 5/02

(52) U.S. Cl. CPC G09B 7/04; G06N 5/025; G06F 3/048; G06F 17/30702

(57) ABSTRACT

Methods for assessing the learning style preference of one or more individuals and providing targeted educational content in response to the assessed learning style preference. In one aspect, various aspects of an individual's preferred learning style (e.g., preferred learning modality, preferred social interaction, preferred method of expression, etc.) are assessed and targeted content (such as e.g., learning style preference-specific educational content) are provided to an individual based on his/her determined preferred learning style. Moreover, as learning style preference assessment occurs over time, the effectiveness of the targeted content can be tracked and an individual users' learning style preference assessment can be readily modified in order to respond to the effectiveness measure of individual ones of the provided targeted content. Apparatus, computer-readable media and systems for implementing the learning style preference assessment and provision of targeted content are also provided.

### PRIORITY

This application claims the benefit of priority to U.S. Provisional Patent Application Ser. No. 62/338,408 filed May 18, 2016 of the same title; U.S. Provisional Patent Application Ser. No. 62/347,505 filed Jun. 8, 2016 and entitled “Methods and Apparatus for Cognitive Ability Assessment”; U.S. Provisional Patent Application Ser. No. 62/339,746 filed May 20, 2016 and entitled “Methods and Apparatus for Utilizing Assessments for Matching Prospective Employees with Employers”; and U.S. Provisional Patent Application Ser. No. 62/348,081 filed Jun. 9, 2016 and entitled “Method and Apparatus for Consumer Preference Assessment and Content/Product Recommendation”, each of the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. Technological Field

The present disclosure relates generally to, inter alia, learning style preference assessment and methodologies and apparatus for evaluating and utilizing the same. Specifically, in one aspect, the present disclosure relates to methods and apparatus for determining a preferred learning style of one or more individuals and automatically providing targeted content based on the determined preferred learning style, thereby enhancing current and/or future performance of the one or more individuals.

### 2. Description of Related Technology

Assessment of learning style preferences is beneficial in determining the optimal format for presenting educational content to individuals (e.g., students, teachers, etc.) in order to present the information in a format for optimal processing and retention of the information. For example, learning style preferences can include an aptitude for auditory/aural learning, while other learning style preferences include an aptitude for visual/spatial learning, etc. In the case of auditory/aural learners, educational or training content may be most effectively received in an auditory format, such as content where the information is spoken verbally in-person or using a recorded sound format or medium. Alternatively, with visual/spatial learners, educational or training content may be most effectively received in a visual format, such as content that incorporates charts and diagrams. Other examples of learning style preferences include aptitudes for interpersonal interactions in groups or self-study, methods of expression in the form of linguistic/verbal communication, physical/kinesthetic learning, naturalistic/scientific learning, and/or mathematical/logical learning.

Several prior approaches or techniques for evaluating a student's preferred learning style exist. These approaches generally include: (i) manual (in-person) testing administered by an educator, counselor, or other professional on an individual basis for a student once they suspect and/or identify an early warning indicator of a potential learning issue; (ii) self-assessment (e.g., student-administered test, parent-administered test, etc.); or (iii) internet-based assessment (e.g., an assessment test from an on-line source). Although such approaches may indicate a learning style preference, there are numerous disadvantages associated with the aforementioned prior techniques. For example, typical prior art evaluation processes may take many months (e.g., six to nine months in some examples) to complete a learning style preference assessment for an individual. In another example, it is often unclear on how to implement and/or utilize a preferred learning style once it has eventually been identified. In even another example, it is difficult to implement learning style preference assessment and provide teaching techniques specific to each learning style preference across a broad range of individuals or groups of individuals (e.g., a student population within a school, student populations across multiple schools, etc.).

Such identification and implementation of educational content adapted to learning style preferences may be particularly critical for use in the classroom such as, for example, with standardized and/or supplemental curriculum. Additionally, in the current education system, there is a lack of an ability to enable communication between students, teachers, parents, tutors, and/or other educational advisors to coordinate education a student having a particular learning style preference. Accordingly, based on the foregoing, there is a need for improved methodologies and apparatus for evaluating and utilizing assessed learning style preferences which addresses the foregoing limitations associated with prior art methodologies.

### SUMMARY

The present disclosure satisfies the foregoing needs by providing, inter alia, methods and apparatus for evaluating and utilizing assessed learning style preferences.

In a first aspect, methods associated with learning style preference assessment are disclosed. In one embodiment, the method includes providing targeted learning style-specific content to one or more individuals based upon evaluating learning style preference assessment of the one or more individuals.

In a second aspect, systems associated with learning style preference assessment are disclosed. In one embodiment, the system is enabled to provide targeted educational content based upon determined learning style preference assessment.

In a third aspect, apparatus associated with learning style preference assessment are disclosed. In one embodiment, the apparatus is enabled to provide targeted educational content.

In a fourth aspect, a non-transitory computer-readable storage medium having a computer program stored thereon is disclosed. In one embodiment, the computer program includes one or more instructions, which when executed by a processing apparatus, provide for learning style preference assessment. In a first variant, the computer program includes one or more instructions, which when executed by a processing apparatus, provide targeted learning style-specific educational content to one or more individuals based on their assessed learning style preference.

In a fifth aspect, methods associated with cognitive ability assessment are disclosed. In one embodiment, the method includes providing cognitive ability level assessment to one or more individuals. In another embodiment, the method includes assessing one or more learning disabilities, psychological factors, or psychological impairments of an individual. In one variant, the method includes providing targeted cognitive condition-specific content. In one implementation, the targeted cognitive condition-specific content comprises intervention plans and treatment content. In another implementation, the targeted cognitive condition-specific content comprises resource or referral content. In another variant, the method includes assessing treatment effectiveness.

In a sixth aspect, systems associated with cognitive ability assessment are disclosed. In one embodiment, a system for providing cognitive ability level assessment to one or more individuals is disclosed. In another embodiment, a system for assessing one or more learning disabilities, psychological factors, or psychological impairments of an individual is disclosed. In one variant, a system for providing targeted cognitive condition-specific content is disclosed. In one implementation, the targeted cognitive condition-specific content comprises treatment content. In another implementation, the targeted cognitive condition-specific content comprises resource or referral content. In another variant, a system for assessing treatment effectiveness is disclosed.

In a seventh aspect, apparatus associated with cognitive ability assessment are disclosed. In one embodiment, an apparatus for providing cognitive ability level assessment to one or more individuals is disclosed. In another embodiment, an apparatus for assessing one or more learning disabilities, psychological factors, or psychological impairments of an individual is disclosed. In one variant, an apparatus for providing targeted cognitive condition-specific content is disclosed. In one implementation, the targeted cognitive condition-specific content comprises treatment content. In another implementation, the targeted cognitive condition-specific content comprises resource or referral content. In another variant, an apparatus for assessing treatment effectiveness is disclosed.

In an eighth aspect, a non-transitory computer-readable storage medium having a computer program stored thereon is disclosed. In one embodiment, the computer program includes one or more instructions, which when executed by a processing apparatus, provide cognitive ability level assessment to one or more individuals. In yet another embodiment, the computer program includes one or more instructions, which when executed by a processing apparatus, assess one or more learning disabilities, psychological factors, or psychological impairments of an individual. In one variant, the computer program includes one or more instructions, which when executed by a processing apparatus, provide targeted cognitive condition-specific content. In one implementation, the targeted cognitive condition-specific content comprises treatment content. In another implementation, the targeted cognitive condition-specific content comprises resource or referral content. In another variant, the computer program includes one or more instructions, which when executed by a processing apparatus, assess treatment effectiveness.

In a ninth aspect, methods associated with learning style preference assessment are disclosed. In one embodiment, the method includes providing a plurality of questions configured to identify one or more learning style preference attributes in a graphical user interface (GUI) displayed on a computing device; receiving a plurality of responses from a test subject, each of the plurality of responses corresponding to respective ones of the plurality of questions; and using an assessment server: calculating a learning style preference for the test subject; and storing the learning style preference in a user profile for the test subject in the database.

In one variant, the plurality of questions are presented in a visual, auditory and/or tactile presentation format.

In another variant, the plurality of responses are useful in determining one or more of interests, executive functioning skills, and/or core values associated with the test subject.

In yet another variant, the method further includes calculating a time between a provided question and a received response for the provided questions; wherein the calculated time is utilized in a hesitation rule algorithm in order to determine a complexity of the provided question.

In a tenth aspect, systems associated with the aforementioned learning style preference assessment are disclosed.

In an eleventh aspect, apparatus associated with the aforementioned learning style preference assessment are disclosed.

In a twelfth aspect, a non-transitory computer-readable storage medium having a computer program stored thereon is disclosed. In one embodiment, the non-transitory computer-readable medium has a computer program stored thereon that when executed, implements the aforementioned learning style preference assessment.

In a thirteenth aspect, methods for providing content/product recommendations based on assessed consumer preferences are disclosed. In one embodiment, the assessed consumer preferences include preferred learning styles and the method further includes causing display of a plurality of questions configured to identify one or more learning style preference attributes in a graphical user interface (GUI) of a computing device; receiving a plurality of responses from a user, each of the plurality of responses corresponding to one of the plurality of questions; calculating a learning style preference for the user or an individual on behalf of the user based on the received responses; and storing the calculated learning style preference in a user profile in a database. In one variant, the method further includes providing a content and/or product recommendation based at least in part on a search query from the user and the calculated learning style.

In a fourteenth aspect, a system for providing content/product recommendations based on assessed consumer preferences are disclosed. In one embodiment, the assessed consumer preferences included preferred learning styles and the system further includes a user computing device, an assessment and content/product recommendation server and a storage device. In one variant, the system is further configured to provide a content/product recommendation to a user based at least in part on a calculated learning style preference associated with the user.

In a fifteenth aspect, an assessment and content/product recommendation server is disclosed. In one embodiment, the assessment and content/product recommendation server is configured to cause a display of a plurality of questions configured to identify one or more learning style preference attributes in a GUI of a computing device; receive a plurality of responses from a user, each of the plurality of responses corresponding to one of the plurality of questions; calculate a learning style preference for the user or an individual on behalf of the user based on the received responses; and store the calculated learning style preference in a user profile in a database. In one variant, the assessment and content/product recommendation server is further configured to provide a content/product recommendation to a user based at least in part on a calculated learning style preference associated with the user.

In a sixteenth aspect, a non-transitory computer-readable storage medium having a computer program with one or more instructions stored thereon is disclosed. In one embodiment, the computer program is configured to, when executed by a processing device, cause a display of a plurality of questions configured to identify one or more consumer preference attributes in a GUI of a computing device; receive a plurality of responses from a user, each of the plurality of responses corresponding to one of the plurality of questions; calculate a consumer preference for the user or an individual on behalf of the user based on the received responses; and store the calculated consume preference in a user profile located in a database. In one variant, the computer program is further configured to, when executed by the processing apparatus, provide a content/product recommendation to a user based at least in part on a calculated learning style preference associated with the user.

Further features of the present disclosure, its nature and various advantages will be more apparent from the accompanying drawings and the following detailed description.

### BRIEF DESCRIPTION OF THE DRAWINGS

The features, objectives, and advantages of the disclosure will become more apparent from the detailed description set forth below when taken in conjunction with the drawings, wherein:

FIG. 1 is a block diagram illustrating one embodiment of a system for providing learning style preference assessment in accordance with the principles of the present disclosure.

FIG. 2 is a block diagram illustrating one embodiment of an apparatus for providing learning style preference assessment in accordance with the principles of the present disclosure.

FIG. 3 is a process flow diagram illustrating one embodiment of a method for providing learning style preference assessment to a user and providing targeted educational content to the assessed user in accordance with the principles of the present disclosure.

FIG. 4 is a process flow diagram illustrating one embodiment of a method for creating a user profile in accordance with the principles of the present disclosure.

FIG. 5 is a logical flow diagram illustrating one embodiment of a method for assessing learning style preference of a user in accordance with the principles of the present disclosure.

FIG. 6 is a logical flow diagram illustrating one embodiment of a method for providing targeted educational content to an assessed user in accordance with the principles of the present disclosure.

FIG. 7 is a table illustrating one embodiment of learning style preference assessment test in accordance with the principles of the present disclosure.

FIG. 8 is a block diagram illustrating one embodiment of learning style preference assessment developmental ability modules in accordance with the principles of the present disclosure.

FIG. 9 is a table illustrating one embodiment of learning style preference codes in accordance with the principles of the present disclosure.

FIG. 10 is a table illustrating one embodiment of possible calculated learning style preference outcomes in accordance with the principles of the present disclosure.

FIG. 11 is a table illustrating one embodiment of educational content formats and associated codes in accordance with the principles of the present disclosure.

FIG. 12 is a screenshot illustrating one embodiment of targeted educational content in accordance with the principles of the present disclosure.

FIG. 13 is a screenshot illustrating an alternative embodiment of targeted educational content in accordance with the principles of the present disclosure.

FIG. 14 is a user interface for one embodiment of a student portal in accordance with the principles of the present disclosure.

FIG. 15 is a user interface for one embodiment of a teacher portal in accordance with the principles of the present disclosure.

FIG. 16 is a block diagram illustrating one embodiment of a system for providing cognitive ability assessment in accordance with the principles of the present disclosure.

FIG. 17 is a block diagram illustrating one embodiment of an apparatus for providing cognitive ability assessment in accordance with the principles of the present disclosure.

FIG. 18 is a logical flow diagram illustrating one embodiment of a method for assessing cognitive ability of an individual and providing targeted treatment for the assessed individual in accordance with the principles of the present disclosure.

FIG. 19 is a logical flow diagram illustrating one embodiment of a method for creating a user profile in accordance with the principles of the present disclosure.

FIG. 20 is a logical flow diagram illustrating one embodiment of a method for providing cognitive ability level assessment in accordance with the principles of the present disclosure.

FIG. 21 is a logical flow diagram illustrating one embodiment of a method for generating a test subject clinical profile in accordance with the principles of the present disclosure.

FIG. 22 is a logical flow diagram illustrating one embodiment of a method for providing targeted treatment content in accordance with the principles of the present disclosure.

FIG. 23 is a logical flow diagram illustrating one embodiment of a method for providing targeted resource and referral content in accordance with the principles of the present disclosure.

FIG. 24 is a schematic diagram of an exemplary embodiment of a GUI for a student portal in accordance with the principles of the present disclosure.

FIG. 25 is a depiction of one embodiment of a graphical user interface (GUI) for a teacher portal in accordance with the principles of the present disclosure.

FIG. 26 is a depiction of one embodiment of a GUI for a parent portal in accordance with the principles of the present disclosure.

FIG. 27 is a depiction of one embodiment of a GUI for a healthcare professional portal in accordance with the principles of the present disclosure.

FIG. 28 is a functional block diagram illustrating exemplary cognitive ability assessment developmental ability modules in accordance with the principles of the present disclosure.

FIG. 29 is a screenshot illustrating one embodiment of a cognitive ability result report in accordance with the principles of the present disclosure.

FIG. 30 is a screenshot illustrating one embodiment of a cognitive ability trend report in accordance with the principles of the present disclosure.

FIG. 31 is a screenshot illustrating one embodiment of a core value and interest assessment in accordance with the principles of the present disclosure.

FIGS. 32-34 are screenshots illustrating exemplary embodiments of targeted treatment content in accordance with the principles of the present disclosure.

FIG. 35 is a block diagram illustrating one embodiment of a system for providing learning style preference assessment in accordance with the principles of the present disclosure.

FIG. 36 is a block diagram illustrating one embodiment of an apparatus for providing learning style preference assessment in accordance with the principles of the present disclosure.

FIG. 37 is a logical flow diagram illustrating one embodiment of a method of assessing learning style preferences in accordance with the principles of the present disclosure.

FIG. 38 is a process flow diagram illustrating one embodiment of a method of learning style preference assessment in accordance with the principles of the present disclosure.

FIG. 39 is a process flow diagram illustrating one embodiment of a method of providing targeted training content in accordance with the principles of the present disclosure.

FIGS. 40A and 40B are logical flow diagrams illustrating one embodiment of a method of generating hiring assessment tests and enabling submission of an application to a business entity in accordance with the principles of the present disclosure.

FIG. 41 is a logical flow diagram illustrating one embodiment of a method of screening applications to a business entity in accordance with the principles of the present disclosure.

FIG. 42 is a table illustrating one embodiment of a learning style preference assessment test in accordance with the principles of the present disclosure.

FIG. 43 is a table illustrating one embodiment of learning style preference codes in accordance with the principles of the present disclosure.

FIG. 44 is a table illustrating one embodiment for possible calculated learning style preference outcomes in accordance with the principles of the present disclosure.

FIG. 45 is a screenshot illustrating one embodiment of targeted training content in accordance with the principles of the present disclosure.

FIG. 46 is a screenshot illustrating a second embodiment of targeted training content in accordance with the principles of the present disclosure.

FIG. 47 is a depiction of one embodiment of a GUI for an employee portal in accordance with the principles of the present disclosure.

FIG. 48 is a depiction of one embodiment of a GUI for a manager portal in accordance with the principles of the present disclosure.

FIG. 49 is a depiction of one embodiment of a GUI for a business entity portal in accordance with the principles of the present disclosure.

FIG. 50 is a schematic diagram of one embodiment of selectable core values that can be associated with career opportunities or selected for hiring assessment in accordance with the principles of the present disclosure.

FIG. 51 is a block diagram illustrating one embodiment of a system for consumer preference assessment and provision of content and/or product recommendations in accordance with the principles of the present disclosure.

FIG. 52 is a block diagram illustrating one embodiment of an apparatus for providing consumer preference assessment and provision of content and/or product recommendations in accordance with the principles of the present disclosure.

FIG. 53 is a logical flow diagram illustrating one embodiment of a method of providing content and/or product recommendations based on consumer preference assessment in accordance with the principles of the present disclosure.

FIG. 54 is a logical flow diagram illustrating one embodiment of a method of consumer preference assessment in accordance with the principles of the present disclosure.

FIG. 55 is a logical flow diagram illustrating one embodiment of a method of providing content and/or product recommendations as well as digital content access in accordance with the principles of the present disclosure.

FIG. 56 is a logical flow diagram illustrating one embodiment of a method of identifying candidates for consumer preference-specific content and/or product recommendation in accordance with the principles of the present disclosure.

FIG. 57 is a table illustrating one embodiment of a learning style preference assessment test in accordance with the principles of the present disclosure.

FIG. 58 is a table illustrating one embodiment of learning style preference codes in accordance with the principles of the present disclosure.

FIG. 59 is a table illustrating one embodiment for possible calculated learning style preference outcomes in accordance with the principles of the present disclosure.

FIG. 60 is a depiction of one embodiment of a GUI for a student user profile in accordance with the principles of the present disclosure.

FIG. 61 is a depiction of one embodiment of a GUI for a consumer user profile in accordance with the principles of the present disclosure.

FIG. 62 is a depiction of one embodiment of a GUI for a provider user profile in accordance with the principles of the present disclosure.

### DETAILED DESCRIPTION

Reference is now made to the drawings wherein like numerals refer to like parts throughout.

As used herein, the term “assessment”, refers to any type of venue, device, or methodology for evaluating preferred learning styles and/or other performance characteristics and/or preferences of an individual, multiple individuals, or groups of individuals.

As used herein, the terms “computer” and “computing device” refer broadly to any type of digital computing or processing device(s) including, without limitation, microcomputers, minicomputers, laptops, hand-held computers, smartphones, tablets, personal digital assistants (PDAs), cellular or satellite-based telephones and any other device or collection of devices capable of running a computer program thereon.

As used herein, the terms “computer program” and “application” refer to any algorithm or sequence of machine-related instructions (regardless of whether rendered or embodied in source or object code) adapted to perform one or more particular tasks. Such computer programs or applications can include any number of differing architectures including, for example, stand-alone applications, distributed applications and object request broker architectures, or other networked applications, and may be stored in any device or any other structured or unstructured digital format including, without limitation, embedded storage, random access memory, hard disk, read-only memory, static memory, optical disc, compact discs (CDs), digital video discs (DVDs), smart card, or magnetic bubble memory.

As used herein, the terms “counselor”, “teacher”, and “tutor” refer to an individual having academic and/or professional experience qualifying he/she to advise or teach another individual, multiple individual, or groups of individuals. In some examples, a mentor, counselor or tutor receives so-called mentorship training and/or completes a mentorship certification.

As used herein the terms “education” and “educational” refer broadly to any type of skill set, knowledge level, or other type of attribute which can be learned, assimilated, or comprehended by the foregoing individual(s) or groups of individuals.

As used herein the term “educational content” refers to any materials intended and/or used for learning and/or teaching. Such educational content includes both so-called digital content such as, for example, CDs, DVDs, and other types of computer readable media, as well as so-called tangible content such as, for example, books, papers, packets, models, games, puzzles, experimentation kits, etc. Educational content can be related to any educational topic such as, for example, STEM, reading/literature, social sciences, history, etc.

As used herein, the terms “eye movement tracking” and “eye tracking” refer to processes, methods, and devices for measuring the point of gaze, duration of gaze, and/or the motion of an eye relative to the head of a user. Various example methods of eye movement tracking include eye-attached tracking (i.e., using a device attached directly to one or both eyes), optical tracking (i.e., using a video camera or other optical sensor to detect infrared light reflected from one or both eyes), and electric potential measurement (i.e., using electrical potentials measured with electrodes placed around one or both eyes). In each of the aforementioned examples, a measurement device is in data communication with the user's computing device in order to record measurements (e.g., point of gaze, duration of gaze, motion, etc.). Further, the user's computing device and/or another computing device or server in data communication with the user's computing device include one or more computer programs configured for eye movement analysis.

As used herein, the terms “Internet” and “internet” are used interchangeably to refer to inter-networks including, without limitation, the Internet.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the term “network interface” refers to any signal, data, or software interface with a component, network or process including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet™), radio frequency tuner (e.g., in-band or OOB, cable modem, etc.), Wi-Fi (802.11a,b,g,n), WiMAX (802.16), PAN (802.15), or IrDA families.

As used herein, the terms “preferred learning style(s)” and “learning style preference(s)” refer to any type of categorization for which an individual, multiple individual, or groups of individuals are adept at, or predisposed for, or adapted to based on their environment or lifestyle acquiring knowledge and/or skill by study, experience, or otherwise being taught. Learning style preferences include, for example, preferred learning modalities such as, for example, physical/kinesthetic, non-physical/kinesthetic, auditory/aural, non-auditory/aural, naturalistic/science, non-naturalistic/science, math/logic, non-math/logic, visual/spatial, non-visual/spatial, reading/writing, non-reading/writing, etc.; preferred social interactions such as, for example, group-oriented, self-oriented, etc.; and/or preferred methods of expression such as, for example, verbal/linguistic, non-verbal/linguistic, etc. In other examples, learning style preferences include other characteristics, features, and/or qualities associated with learning such as, for example, accommodator, converger, diverger, assimilator, activist, reflector, theorist, pragmatist, avoidant, participative, competitive, collaborative, dependent, independent, etc.

As used herein, the term “processor” refers to all types of digital processing devices including, without limitation, digital signal processors (DSPs), reduced instruction set computers (RISC), general-purpose (CISC) processors, microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein, the terms “question” or “task” refers to any mechanism used as part of the aforementioned assessment to evaluate preferred learning styles, executive functioning skills, knowledge-based skills, or other performance and/or preference characteristics of an individual, multiple individuals, or groups of individuals and include, for example, multiple choice, essay, short answer, pictorial, written problems, verbal or written instructions and/or responses, timed responses, etc.

As used herein, the term “server” refers to any computerized component, system or entity regardless of form which is adapted to provide data, files, applications, content, or other services to one or more other devices or entities on a computer network.

As used herein, the term “storage device” refers to without limitation computer hard drives, DVR device, memory, RAID devices or arrays, optical media (e.g., CD-ROMs, Laserdiscs, Blu-Ray, etc.), or any other devices or digital media capable of storing content or other information (e.g., “cloud” storage).

### Overview

The present disclosure advantageously provides for a learning style preference assessment methodology in order to analyze and calculate an individual's preferred learning style (e.g., preferred learning modality, preferred social interaction, preferred method of expression, etc.) as well as provide targeted content (such as e.g., learning style preference-specific educational content) to an individual based on his/her determined preferred learning style. Moreover, the provision of targeted content can be readily adapted in order to provide targeted content for one or more individuals as well as groups of individuals. The present disclosure improves upon prior art assessment approaches by analyzing multiple aspects of an individual's learning capabilities for a variety of potential learning styles over a period of time. Accordingly, as learning style preference assessment occurs over time, the effectiveness of the targeted content can be tracked and an individual users' learning style preference assessment can be readily modified in order to respond to the effectiveness measure of individual ones of the provided targeted content.

Moreover, the disclosure in one exemplary aspect includes an analysis algorithm specifically configured to determine and calculate the learning style areas of strength (as well as weakness) in an individual based on, inter alia, selections, answers, and/or responses received from the individual during assessment. Additionally, learning style preference may be associated with an individual and stored in that individual's user profile and tracked and updated over time (such as e.g., identification of trends) for formative and/or summative assessments. Apparatus and systems associated with the learning style preference methodologies described herein are also disclosed.

### Exemplary Learning Style Assessment System

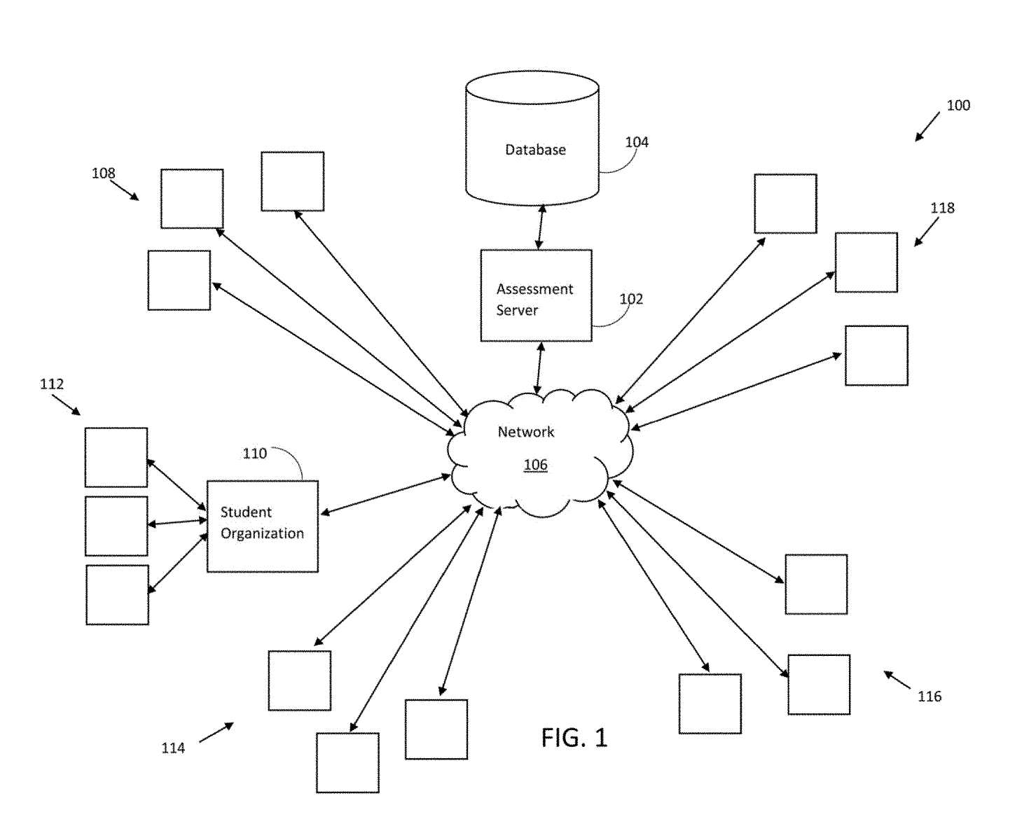

FIG. 1 illustrates an exemplary embodiment of a system 100 for provision of learning style preference assessment. As depicted in FIG. 1, the system includes an assessment server 102 that is in data communication with both a database 104 through a first network interface as well as a network 106 (e.g., the Internet) through a second network interface. In the illustrated embodiment, the assessment server 102 is accessible to various user computing devices 108, 112, 114, 116, 118 via the network 106, although it is readily appreciated that various ones of the user computing devices can be locally connected to the assessment server. Although the database 104 is illustrated as being in data communication with the assessment server 102 locally via the first network interface, it is readily appreciated that the database may be accessed via the network 106 in alternative embodiments. Moreover, in so-called distributed database embodiments, multiple databases can be placed in data communication with the assessment server 102 locally and/or via network 106.

The aforementioned user computing devices include in the illustrated embodiment student computing devices 108, a centralized student organization computing server 110 in data communication with student accessible computing devices 112, teacher computing devices 114, parent computing devices 116, and tutor computing devices 118. While a specific topology is illustrated, it is appreciated that various aspects of the illustrated topology could be readily changed. For example, computing servers (not shown) may be implemented between various ones of the computing devices 108, 114, 116, 118 or various computing devices can be implemented with combined functionality (e.g., a computing device may function as both a parent computing device as well as a student computing device, etc.). In another example, various one of the computing devices may alternatively be in data communication with external databases directly (i.e., without having to go through the assessment server 102) via the network 106. These and other variants would be readily appreciated by one of ordinary skill given the contents of the present disclosure.

### Exemplary Learning Style Preference Assessment Server

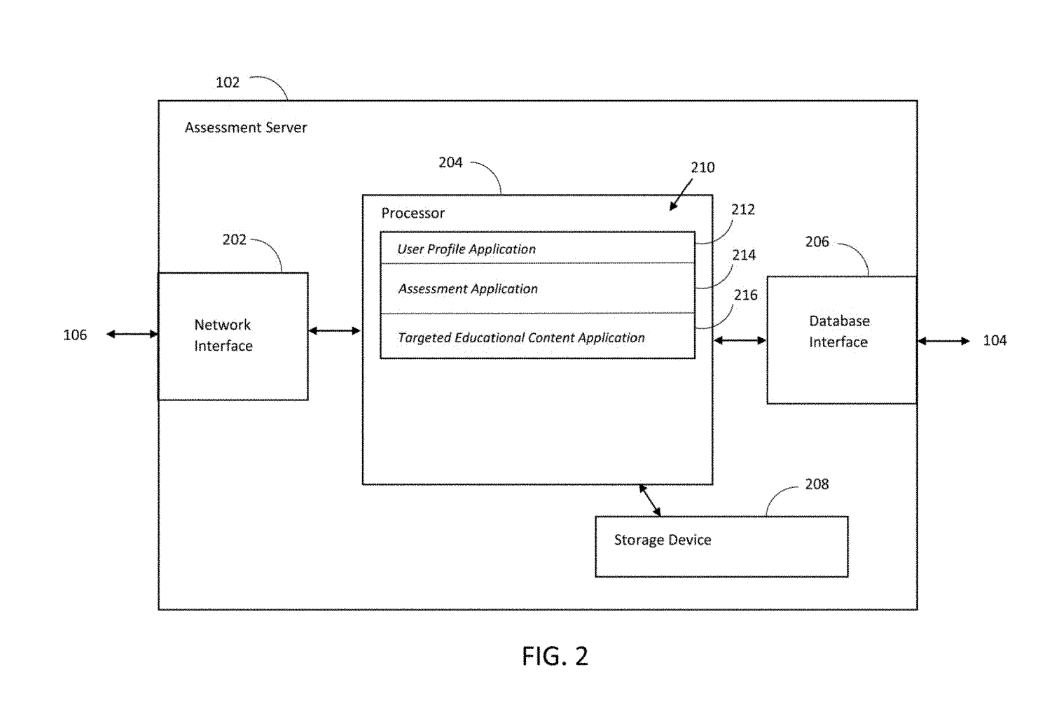

FIG. 2 depicts one exemplary embodiment of an assessment server 102 for use in learning style preference assessment. As depicted, the server 102 generally comprises a network interface 202, a processing apparatus 204, a database network interface 206, and a storage device 208. The network interface 202 enables communication with the network 106 illustrated in FIG. 1, while database network interface 206 enables communication with database 104 illustrated in FIG. 1. In an alternative embodiment, the database 104 can be an internal component of the assessment server (such as consisting of storage device 208). In yet another alternative embodiment, database network interface 206 may be obviated altogether an access to database 104 may occur via network interface 202. The processing apparatus 204 is configured to execute various applications 210 thereon to carry out various functions for the assessment server 102. In the illustrated embodiment, applications 210 include a user profile application 212, an assessment application 214, and a targeted educational content application 216. The aforementioned applications can be stored on storage device 208, the database 104 or a combination of both.

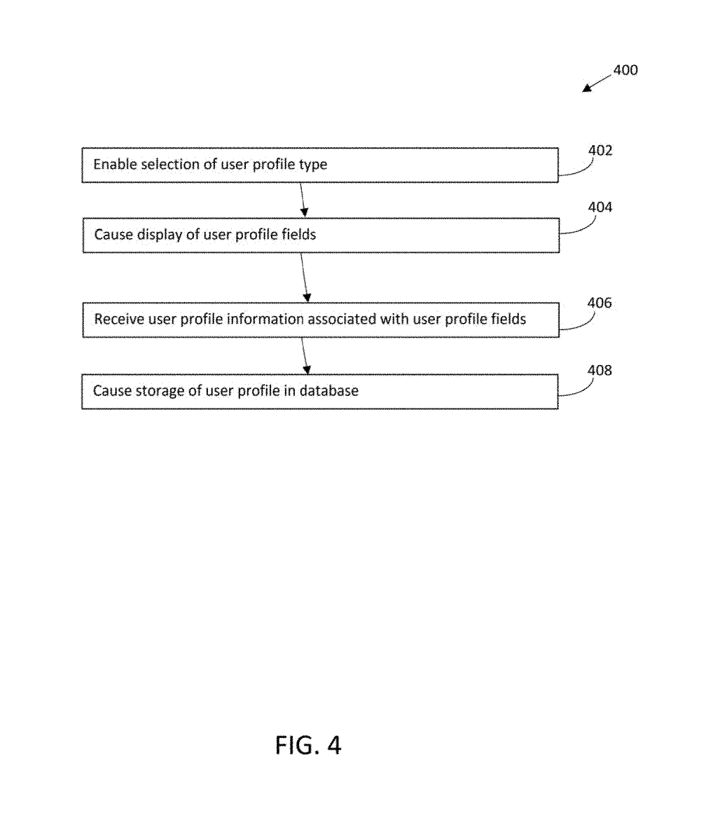

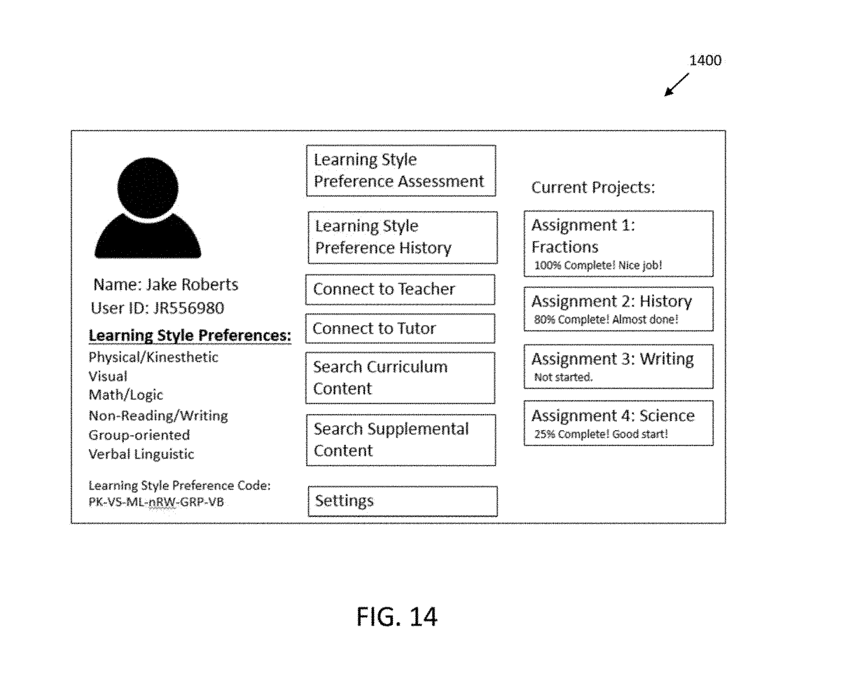

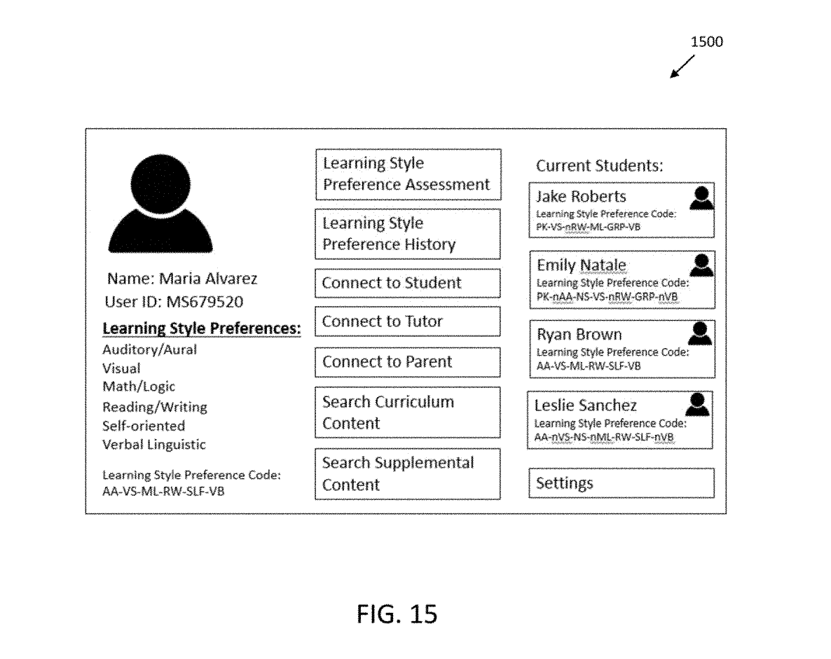

The user profile application 212 enables collection of user information, such as a user's personal information, to create a user profile consisting of, for example, a student profile, a teacher profile, a counselor profile, a parent profile, a tutor profile, etc. along with a stored identity associated with the user (e.g., a unique encoded identity). The aforementioned user information may include name, age, address, identity number, school information, grade level, academic interests, academic goals, career goals, academic experience, professional experience, contact information, ethnicity, etc. Behavioral records, certifications, test scores, graduation date, date of withdrawal, medical conditions, and/or psychological conditions can also be received, associated, and/or stored via the user profile application 212. Moreover, based on the received user information, the user profile application 212 can generate a user portal or profile (e.g., a student portal, a teacher portal, a parent portal, a tutor portal, etc.) in a graphical user interface (GUI) on a computing device of the user. The user portal or profile enables digital communication between individuals (e.g., students, groups of students, teachers, tutors, and/or parents). One exemplary method for generating and utilizing the user profile application 212 is shown and discussed with reference to FIG. 4, while exemplary user portals are depicted in FIGS. 14 and 15.

The assessment application 214 enables testing of an individual to determine a preferred learning style. For example, a series of questions and/or tasks having two or more selectable and/or fill-in answers is provided to the individual. Each of the questions and/or tasks may be configured to test for various aspects of a given user's preferred learning style such as learning modalities (e.g., physical/kinesthetic, non-physical/kinesthetic, auditory/aural, non-auditory/aural, naturalistic/science, non-naturalistic/science, math/logic, non-math/logic, visual/spatial, non-visual/spatial, reading/writing, non-reading/writing, etc.), social interactions (e.g., group-oriented, self-oriented, etc.), methods of expression (e.g., verbal/linguistic, non-verbal/linguistic, etc.). Based on the selections and/or responses received from the individual, the assessment application 214 determines a preferred learning style for the individual. In addition to receiving a selection/response, in one or more implementations, one or more of the questions/tasks for learning style assessment may record and analyze “eye tracking” of the test subject in determining/calculating an outcome. Thus, in examples which record and assess eye tracking, the user computing device is data communication with an eye tracking device such as e.g., an eye wear article or a detection device (e.g., video camera) directed towards the test subject's eyes. In alternate embodiments, eye tracking may be excluded from assessment.

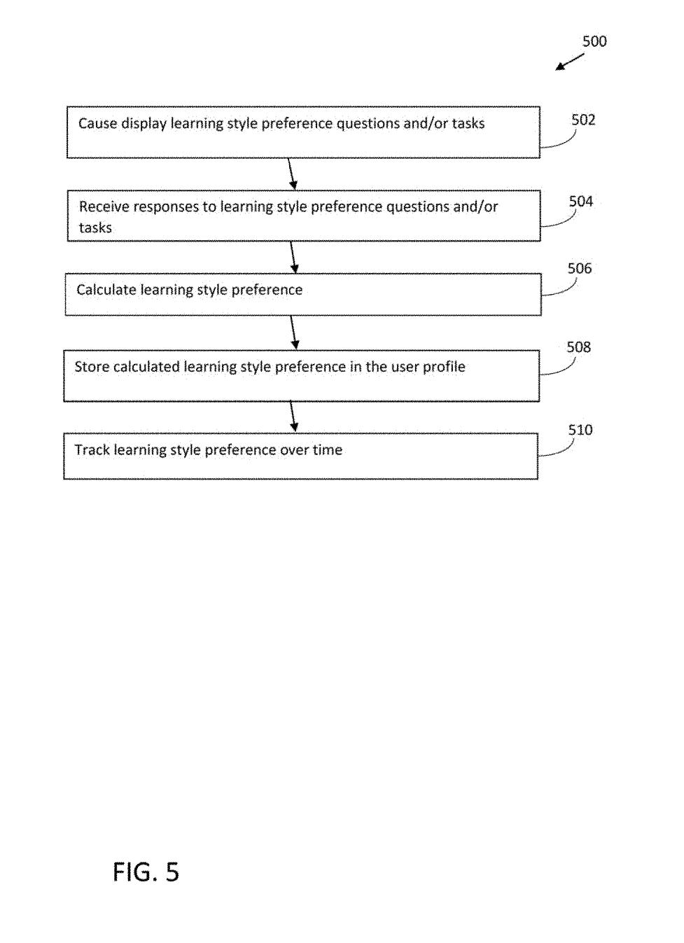

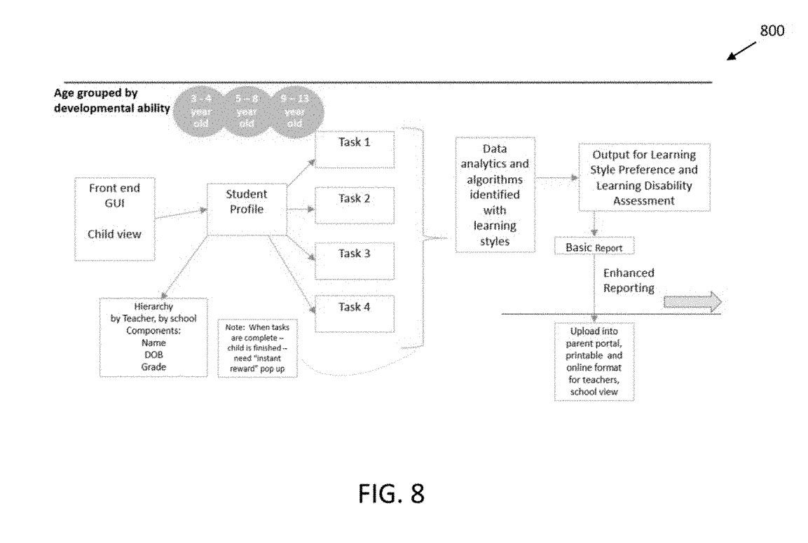

Results of the learning style preference assessment are then stored within the user's user profile. Additionally, execution of the assessment application can be repeated over time in order to identify consistency, changes, and/or patterns in learning style preference for a given individual. For example, the assessment application may be executed at regular intervals such as weekly, monthly, quarterly, bi-annually, annually, etc. One exemplary method for the assessment application 214 is shown and described subsequently herein with reference to FIG. 5, while example questions/tasks, developmental ability modules, and learning style preferences/codes are depicted in FIGS. 8-10.

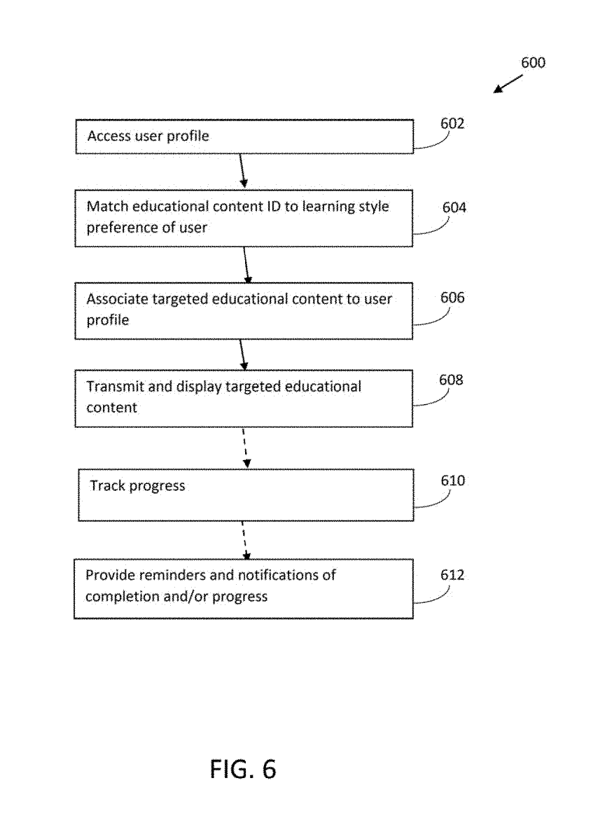

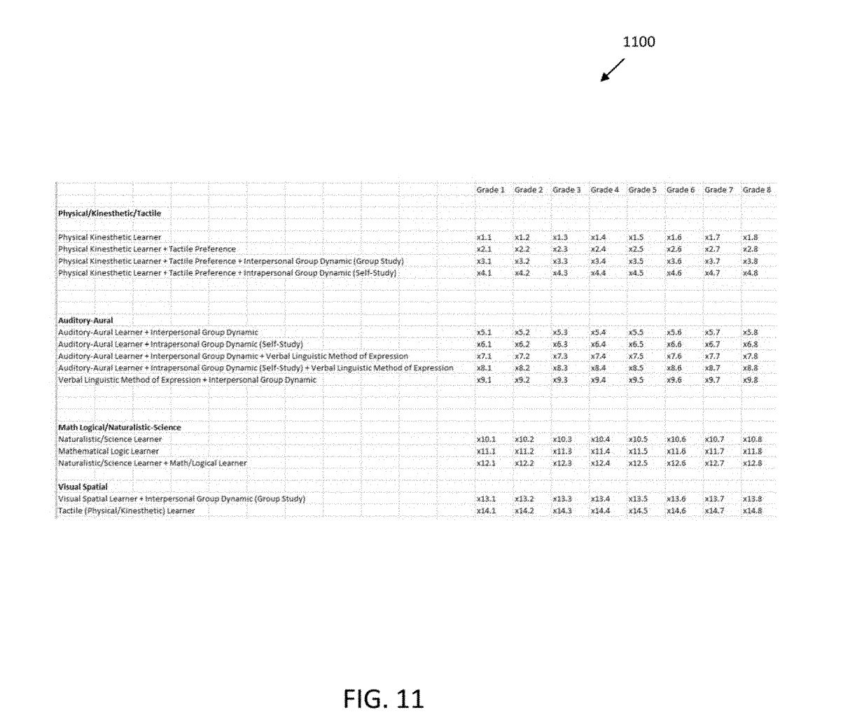

The targeted educational content application 216 enables the matching of standard curriculum, supplemental, and/or examination content for a variety of subjects (e.g., science content, math content, technology content, reading/literature content, social sciences content, history content, etc.) to individuals that is specific to the preferred learning style for each individual as determined, for example, via the assessment application 214. For example, database 104 may store educational digital content in a variety of formats that are designed for and/or facilitate learning in each of the various preferred learning styles. In one example, each of the educational digital content items is encoded with a tag to identify and/or associate the content item with one or more of the preferred learning styles (e.g., learning style preference codes). A look-up table or analysis algorithm for identifying and delivering learning style-specific educational content to individuals is used to match content to each individual and provide the content to the individual such as, for example, through a student portal accessible through a GUI of a computing device. Additionally, educational content may be tangible educational content, such as DVDs, CDs, portable storage media, etc., which may be delivered to the student via a non-digital mechanism (e.g., postal delivery, in-store purchase, etc.). In such examples, database 104 includes inventory data that includes categorization and/or codes (e.g., tags) associating each of the tangible content items with one or more of the preferred learning styles for a given individual. Orders for delivery can be automatically generated based on the learning style preference code of the individual and/or a user facilitated request for this tangible content. One exemplary method of providing targeted educational content is shown and discussed with reference to FIG. 6 described subsequently herein, while examples of educational content and content codes are depicted in FIGS. 11-13.

### Methods

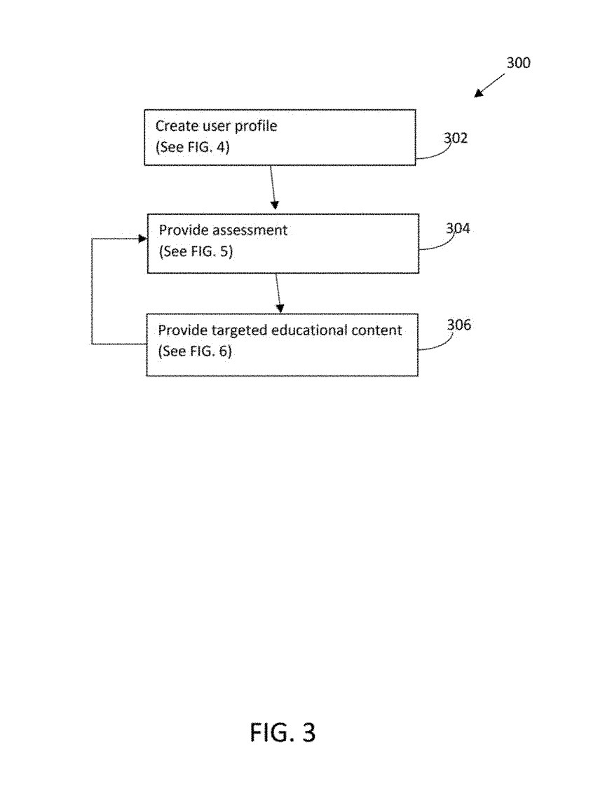

Referring now to FIG. 3 an exemplary methodology 300 for utilizing the various applications executed on the assessment server are illustrated for purposes of facilitating the overall understanding and use of the methodologies described herein. At step 302, a user profile is initially created using the user profile application 212. Next, at step 304, learning style preference(s) for a user is assessed using the assessment application 214. The calculated learning style preference(s) are subsequently stored in the user profile. After the assessment, the method 300 includes providing targeted educational content using the targeted educational content application 216 at step 306. Subsequent to provision of the targeted educational content, the user's learning style preference(s) are updated based at least in part on an evaluation of the effectiveness of the provided targeted educational content in educating the user. The individual steps of the methodology of FIG. 3 are described in additional detail subsequently herein with regards to FIGS. 4-6.

### Creation of User Profiles

An exemplary methodology 400 for creating a user profile is shown in FIG. 4. At step 402, prior to the entering of user information, the user is first presented with user profile types and/or selects a user profile type. For example, the user may be a student and select or enter student criteria to create a student profile. In another example, the user may be a teacher and select or enter teacher criteria to create a teacher profile. In yet another example, the user may be a parent and select and/or enter parent criteria to create a parent profile. In even another example, the user may be a tutor and/or enter tutor criteria to create a tutor profile.

At step 404, various user profile data entry fields are displayed to a user in order to facilitate collection of user information. For example, the data entry fields are displayed on a graphical user interface (GUI) on a user's computing device. These various user profile data entry fields include, for example, name for the user, age of the user, current or prior addresses, user identity number, school information associated with the user, user's current grade level, ethnicity, user's academic interests, user's academic goals, user's career goals, user's academic experience, user's professional experience, etc. Additionally, a credential and/or password may be required to initiate creation of the user profile. Further, the created user profiles can be stored as searchable lists in database 104 for later retrieval of specific user profiles or groups of user profiles and/or user information.

At step 406, the user information is received from the user in the various prompted fields in, for example, the GUI displayed on a user's computing device. Additionally, other user information may be automatically populated such as, for example, the user's academic records, user's behavioral records, certifications, other test scores, medical history, and/or psychological history. The user profile is then saved and stored (such as, for example, storing the user profile in database 104 illustrated in FIG. 1) at step 408. Further, the user and/or the system may create a log in ID and/or password for subsequent user access to system 100.

### Learning Style Preference Assessment

An exemplary methodology 500 for user assessment is shown in FIG. 5. After creating and storing the user profile, learning style preference assessment can be immediately carried out. Alternatively, the user profile may be saved and logged into at a later time to complete assessment. In either example, upon initiation of learning style preference assessment, questions and/or tasks are displayed to the user at step 502. In some implementations, the questions are presented in a multi-sensory fashion such as, for example, in a voice that may be recognizable by the assessment participant. Additionally, in some examples, the auditory questions are presented in combination with a visual scene or character, which assists in the engagement of the assessment participant with the assessment tool (e.g., depending upon the age or development level of the participant). A series of questions and/or tasks having fill-in and/or two or more selectable answers is provided to the user. For example, one question is displayed to the user and after receiving an answer from the user the following question is displayed. Further, a portion of the questions and/or tasks are each configured to test for one or more aspects or attributes of a preferred learning style such as learning modalities (e.g., physical/kinesthetic, non-physical/kinesthetic, auditory/aural, non-auditory/aural, naturalistic/science, non-naturalistic/science, math/logic, non-math/logic, visual/spatial, non-visual/spatial, reading/writing, non-reading/writing, etc.), social interactions (e.g., group-oriented, self-oriented, etc.), and/or methods of expression (e.g., verbal/linguistic, non-verbal/linguistic, etc.). The user's selections, answers, and/or responses are transmitted to and received at the assessment server (step 504), where the learning style preference is calculated (step 506).

Questions and/or tasks for learning style preference and assessment can be designed to target specific developmental ability or age groups. Thus, the questions and/or tasks presented to the user may be based on the age of the user. In one example, a plurality of developmental ability tests are available (i.e., stored in database 104) and selectively provided depending on the age of the user (e.g., 3-4 years old, 5-8 years old, and 9-13 years old) stored in the user profile. For example, in one embodiment, the age groups for the users may be divided up by users that are: (i) 3-4 years old; (ii) 5-8 years old; and (iii) 9-13 years old. In an alternative embodiment, the age groups for the users may be divided up by users that are: (i) 3-6 years old; (ii) 7-8 years old; (iii) 9-10 years old; and (iv) 11-13 years old. In other examples, developmental ability can be based on or classified by different age groupings (e.g., between 3 and 13 years of age) and/or can include more or fewer developmental ability groupings. In even other examples, developmental ability can be based on an alternate user attribute (e.g., user grade level). In yet another example, multi-sensory assessment is performed via the inclusion of visual (i.e., displayed information), touch (e.g., via the use of touch pads, etc.) and auditory cues (e.g., music, etc.) provided by way of the computing device. Moreover, in one or more exemplary implementations, the questions and/or tasks will be further broken down into two types of assessments, namely: (1) quantitative assessment where the learning style preference assessment is based off of specific measurements resultant from the user's selection of an answer to a given question and/or task, as well as; (2) qualitative assessment where the learning style preference assessment measures user's perception of another's reaction. Additionally or alternatively, learning preferences are measured with respect to so-called cognitive learning preferences (i.e., for the same content, a user indicates a preference for, for example, a visual representation as opposed to a mathematical/logical representation, or so-called social learning preferences, i.e. methods of expression such as verbal linguistic (e.g., tell a friend about a book that the user just read, etc.).

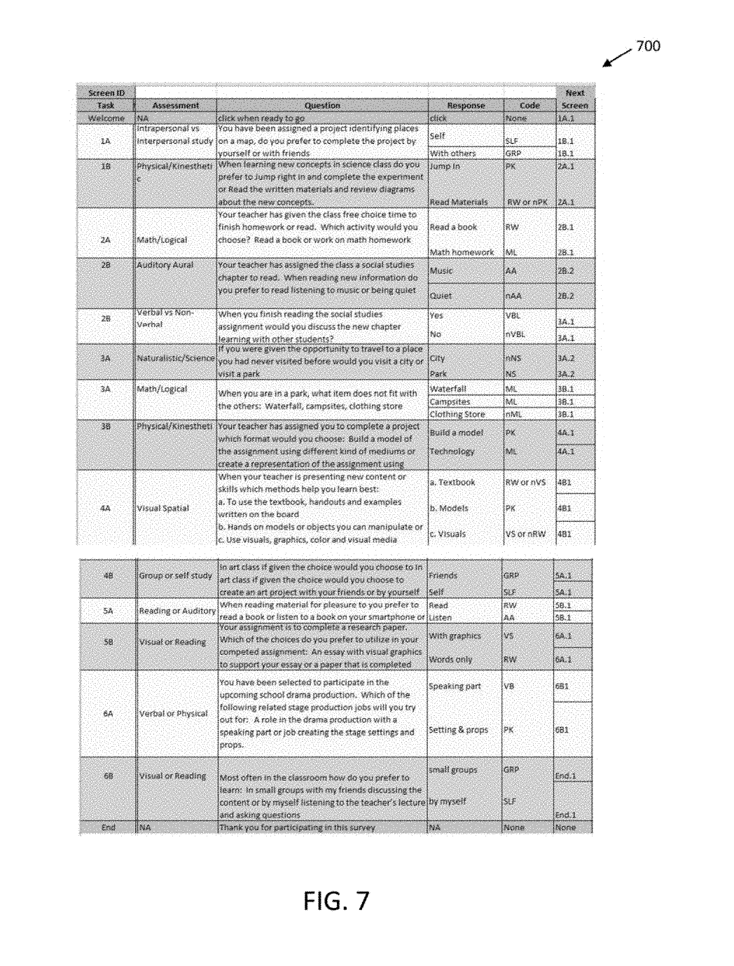

An example table of a series of questions for learning style preference assessment 700 is shown in FIG. 7, which may be stored in database 104 and accessible to assessment server 102. The series of questions 700 are designed to test for a learning style preference of a 9-13 year old developmental ability group. As depicted in FIG. 7, an example assessment table 700 includes columns for: (i) task identity; (ii) learning style preference assessed via each task; (iii) text for each question; (iv) text for possible responses to each question; (v) learning style preference code results associated with each response; and (v) a next screen code for advancing to the following question. Further, a schematic depiction 800 of various learning style preference assessment developmental ability modules is shown in FIG. 8.

In one specific example, as indicated in table 700, Task 1A is configured to determine whether an individual's learning style preference includes a preference for intrapersonal or interpersonal study. In order to carry out the assessment for Task 1A, the text “You have been assigned a project identifying places on a map. Do you prefer to complete the project by yourself or with friends?” is displayed on the GUI along with selectable answers “Self” and “With others”. If the user selects “Self”, the selection is recorded and the learning style preference code “SLF” is associated with Task 1A. Alternatively, if the user selects “With others”, the selection is recorded and the learning style preference code “GRP” is associated with Task 1A.

In another specific example, also indicated in table 700, Task 1B is configured to determine whether an individual's learning style preference includes a preference for physical or kinesthetic study. In order to carry out the assessment task 1B, the text “When learning new concepts in science class do you prefer to jump right in and complete the experiment or first read the written materials and review diagrams about the new concepts?” is displayed on the GUI along with selectable answers “Jump in” and “Read materials”. If the user selects “Jump in”, the selection is recorded and the learning style preference code “PK” is associated with Task 1B. Alternatively, if the user selects “Read materials”, the selection is recorded and the learning style preference code “RW” or “nPK” is associated with Task 1B.

Upon completion of answering each question, the results associated with each task (i.e., Tasks 1A-6B) are transmitted to the assessment server 102 where the learning style preference for the user is calculated (such as, e.g., the assessment application 214 and/or via the analysis algorithm configured to determine and calculate the learning style areas of strength and weakness). It will be appreciated that the table of questions for learning style preference assessment shown in FIG. 7 is merely exemplary and other implementations may include more or fewer questions and/or tasks for assessment of learning style preference.

Another example of a series of questions for learning style preference assessment is included in Appendix A, which may additionally be stored in database 104 and accessible to assessment server 102. The series of questions in Appendix A are designed to test for a learning style preference of a 3-5 year old developmental ability group. Moreover, while Appendix A contains questions in the English language, it is appreciated that in alternative embodiments, the questions may be presented in alternative languages, or combinations of languages, so as to enable multi-lingual assessment for, inter alia, users where English is not their first language. As shown in Appendix A, the series of questions include four “Tasks” each designed to test for one or more specific learning style preference attributes. Moreover, in one or more implementations, the specific format/language for the questions may be dynamically modified so as to, among other things, more effectively assess a user's learning style preference. In other words, the questions contained in, for example, Appendix A can be dynamically updated, while the learning preferences/keys associated with the questions could remain relatively static. In yet other implementations, a subset of the questions contained within Appendix A can be selected for display based upon, for example, the age of the user, determined developmental ability of the user, etc. These and other variants would be readily apparent to one of ordinary skill given the contents of the present disclosure.

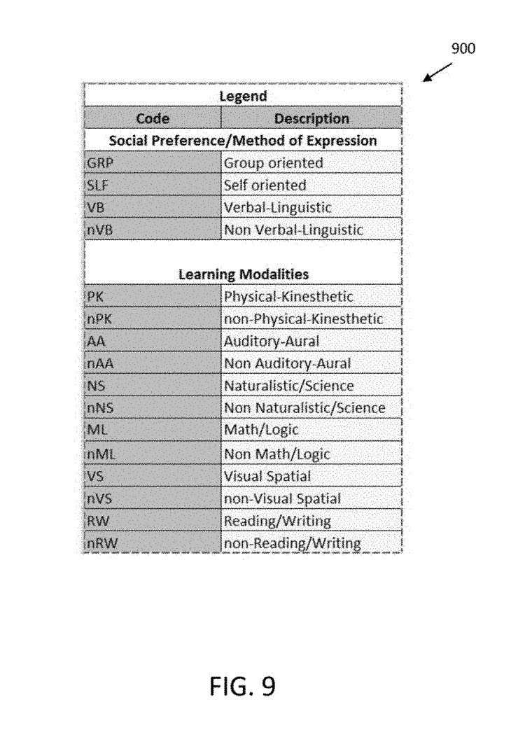

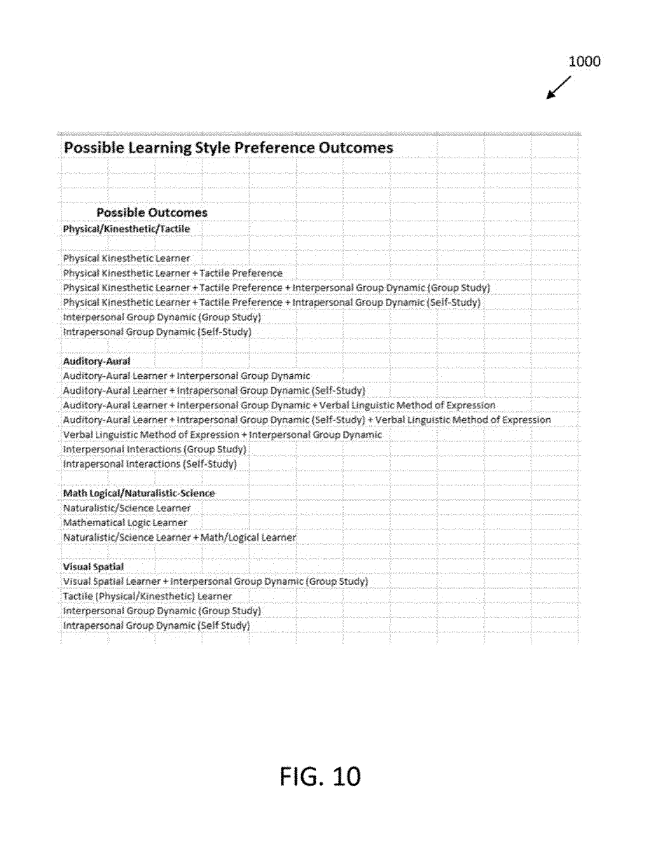

After calculating the encoded user's learning style preference, the encoded learning style preference is translated into a user-readable learning style preference. FIG. 9 shows an example table including a legend 900 indicating learning style preference codes and the corresponding learning style attributes (e.g., social preferences, methods of expression, and learning modalities), while FIG. 10 shows an example Table 1000 including the various possible learning style preference outcomes that may be associated with the user. Returning to FIG. 5, at step 506, the calculated learning style preference outcome (e.g., one or more of the learning style preferences shown in FIG. 10) is stored in the user profile (step 508).

At step 510, learning style preference assessment may optionally be repeated so that a learning style preference of the user can be updated over time and stored in the user profile. For example, the preferred learning style of a user may change as the user develops new cognitive skills. Further, changes and/or consistency in learning style preference may be tracked over time to identify patterns, shifts, and/or trends in one individual, multiple individuals, and/or groups of individuals.

### Provision of Targeted Educational Content

An exemplary method 600 for providing targeted educational content (i.e., educational content specific to a user's learning style preference) is shown in FIG. 6. In some examples, the method 600 is initiated in response to a request for educational content from a user. Specifically, the user may request educational content for a certain subject (e.g., mathematics, science, history, literature, etc.) or educational content according to a specific assignment from the teacher, etc. Alternatively, the method 600 may automatically be carried out after completion of the learning style preference assessment.

At step 602, the assessment server 102 accesses a user profile stored in database 104 to obtain the learning style preference(s) associated with the user (e.g., learning style preference(s) or learning style preference code(s) associated with a user ID) and/or other user information (e.g., age, grade-level, class, etc.). At step 604, method 600 includes the searching and identification of educational content for content that is appropriate and/or designed for one or more specific learning style preferences such as, e.g., those listed in table 1000 shown in FIG. 10. Further, the educational content may additionally be appropriate and/or designed for one or more of a specific age group, a specific subject, a specific class, a specific grade-level, etc.

In order to perform matching of educational content to a user's learning style preference and other user information, database 104 stores and searches digital educational content in multiple formats for a variety of topics. For example, the search may include a look-up table or analysis algorithm for identifying and delivering learning style-specific educational content.

Additionally, or alternatively, assessment server 102 may have searchable access to other educational content such as, for example, content stored in other databases, content accessible via the Internet or other controlled or uncontrolled networks, etc. One example of a targeted educational content look-up 1100 for one subject or topic (e.g., mathematics, science, history, literature, etc.) is shown in FIG. 11. For each of the specified grade-levels (i.e., grades 1-8) database 104 includes various formats of content which are tagged or otherwise identified with a learning style preference indicator. For example, for a user in grade level 2 having an Auditory-Aural Learner+Interpersonal Group Dynamic learning style preference, educational content having a content code “x5.2” will be provided. In another example, for a user in grade level 3 having a Physical Kinesthetic+Tactile+Intrapersonal Group Dynamic learning style preference, educational content having a content code “x4.3” will be provided. Database 104 may include a look-up table such as table 1100 for each educational subject or topic. In other examples, data stored in look-up tables may be organized in an alternative manner (e.g., learning style preference vs. topic/subject for a single grade level, etc.).

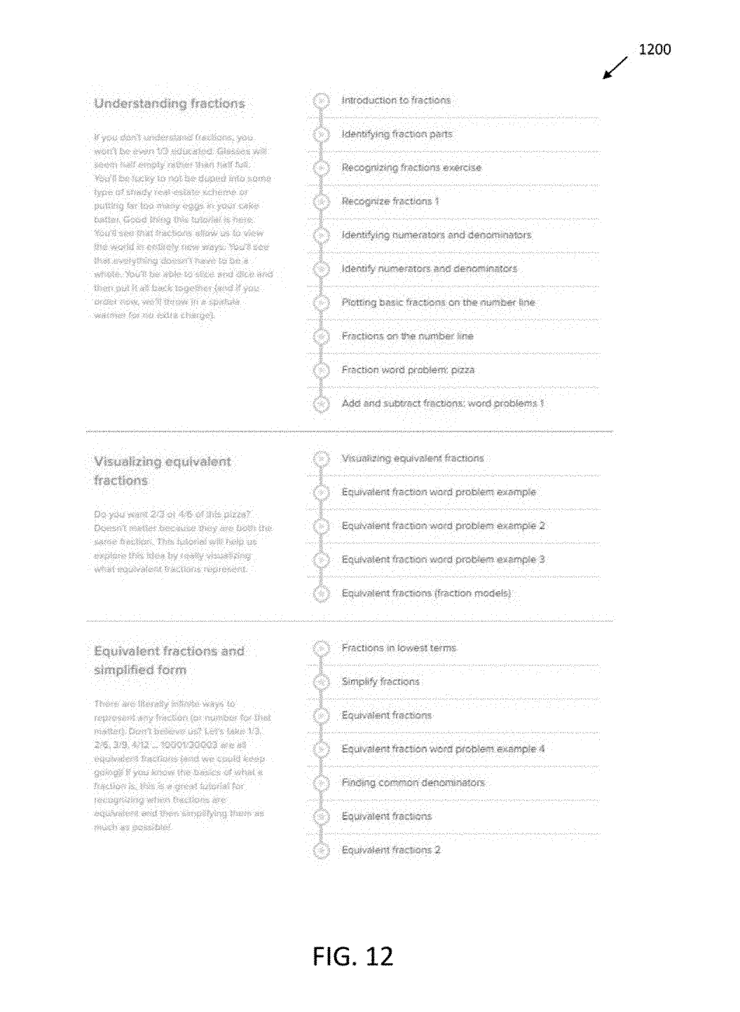

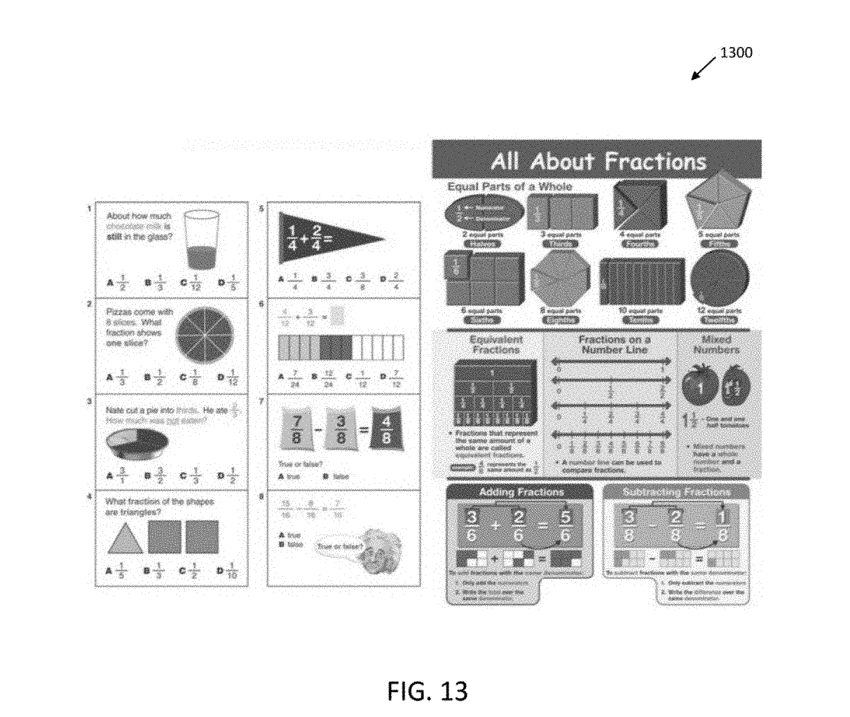

FIGS. 12 and 13 show two examples of targeted educational content that may be searched and identified in step 504. Specifically, FIG. 12 shows an example of digital content 1200 for the topic of “Fractions” which is tagged with a grade level indicator of grade level 4 and a learning style preference indicator including the following learning style preferences: Linguistic and/or Math/Logic. As depicted in FIG. 12, digital content 1200 includes primarily written text and additionally includes a schematic depiction of links to other content subtopics. Thus, digital content 1300 is adapted for a user with a learning style preference including linguistic, visual, and/or math/logic attributes who optimally learns subject matter that is in a written format, which can be perceived with the eye, and/or that is presented in a logical manner.

FIG. 13 shows an example of digital content 1300 for the topic of “Fractions” which is tagged with a learning style preference indicator including the following learning style preferences: Visual and/or Naturalistic. As depicted in FIG. 13, digital content 1300 includes primarily pictorial content including images of foods and additionally includes a diagrams with short written descriptions. Thus, digital content 1300 is adapted for a user with a learning style preference including visual and/or naturalistic attributes who optimally learns subject matter that is in a visual format, which can be perceived with the eye, and/or that is presented in a manner related to nature.

Although only two examples of educational digital content formats are depicted, additional digital content having a variety of formats adapted to each learning style preference for this topic (and other subjects and topics) may be stored in database 104 or otherwise be accessible to assessment server 102. For example, educational digital content may include physical activities (such as e.g., drawing and/or assembly projects in digital or non-digital formats) which are tagged with a learning style preference indicator of physical/kinesthetic and are adapted for a user with a learning style preference including a physical/kinesthetic attribute. In another example, educational digital content may include audio and/or video content which are tagged with learning style preference indicator of auditory/aural and are adapted for a user with a learning style preference including an auditory/aural learner attribute. In even another example, various format for exams and/or standardized tests can be provided to each student based their respective assessed learning style preference.

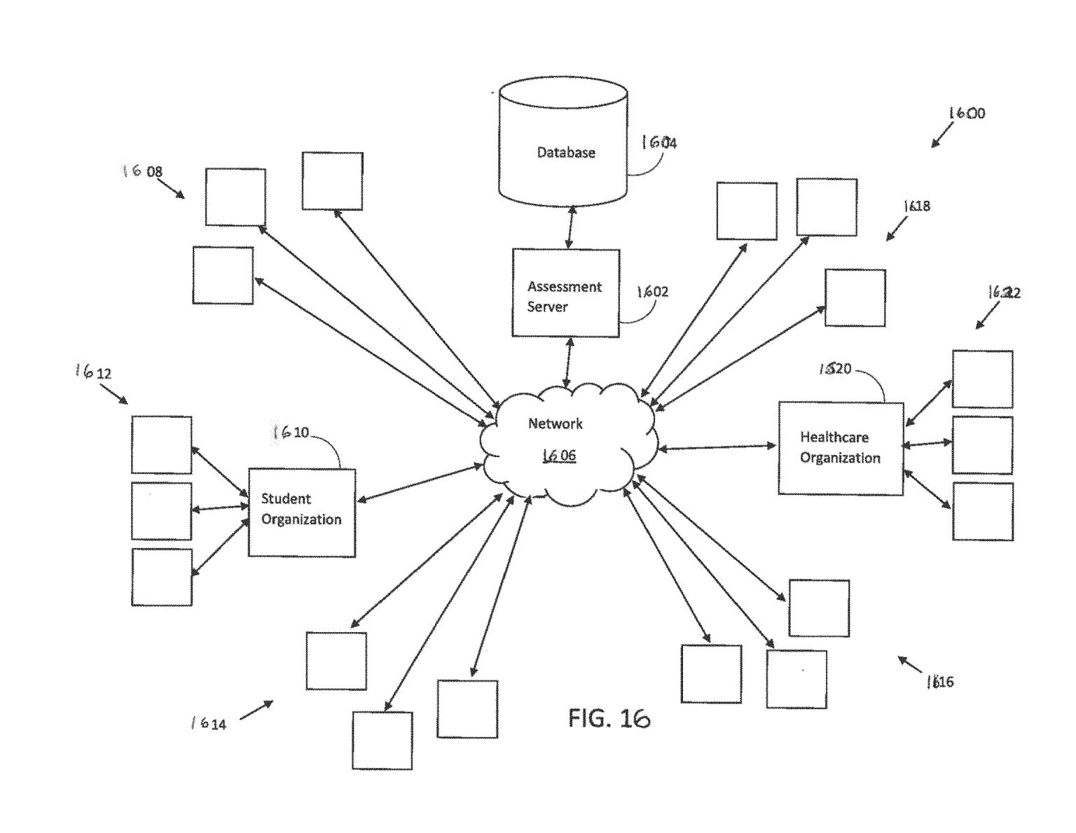

Returning to FIG. 6, at step 606, the identified or matched educational content is associated with the requesting user profile. The educational content may then be accessible to the user through a user portal (such as e.g., a student portal 1500 shown in FIG. 15). When the user selects an educational content item, the item is transmitted to and/or displayed at the user's computing device (step 508). Per steps 610 and 612, method 600 may optionally include tracking of the user's progress through the content items and additionally provide reminders and notifications of completion, motivation and rewards, and/or progress to a user such as a student, a teacher, a tutor, a parent, a counselor, etc. For example, notifications of a student's progress can be sent to a teacher via a teacher portal, such as teacher portal 1600 shown in FIG. 16. In some examples, communication is enabled via the user portals to allow communication regarding assessment outcomes and assignments.

Moreover, at step 610 as learning style preference assessment is performed over time, a students' response to the previously provided targeted educational content can be assessed and the students learning style preference assessment contained within the user's profile can be modified accordingly. For example, where a user is associated with a number of identified codes as depicted in FIG. 7 (e.g., “SLF” with Task 1A; “PK” with Task 1B; etc.), the effectiveness of the content provided for the previously identified learning style preference can be assessed and the learning style assessment can be modified accordingly. See, for example, the feedback loop between steps 304 and 306 depicted in FIG. 3. In this manner, not only can learning style preference assessment be performed independently of the effectiveness of the provision of targeted content, but the learning style preference assessment can be updated/tweaked over time in order to more effectively cater to a student's learning style needs.

It will be appreciated that the above described system, apparatus, and methods may address many of the issues identified with prior techniques for learning style preference assessment. Further, particularly with implementation of targeted educational content, the above described system, apparatus, and methods may have significant and broad-reaching impact on improving the quality of education that students receive.

### Exemplary Cognitive Ability Assessment

FIG. 16 illustrates an exemplary embodiment of a system 1600 for provision of cognitive ability and/or cognitive condition assessment. As depicted in FIG. 16, the system includes an assessment server 1602 in data communication with a database 1604 through a local network interface, as well as being in data communication with a network 1606. In the illustrated embodiment, the assessment server 1602 is accessible to various user computing devices via the network 1606, although it is readily appreciated that various ones of the user computing devices can be locally connected to the assessment server in addition or alternatively to being in data communication with other user computing devices via the network. Moreover, although the database 1604 is illustrated as being in data communication with the assessment server 1602 locally, it is readily appreciated that the database may be accessed via the network in alternative embodiments. Moreover, in so-called distributed database embodiments, multiple databases can be placed in data communication with the assessment server locally and/or via network 1606.

The aforementioned user computing devices include in the illustrated embodiment student computing devices 1608, a centralized student organization computing server 1610 in data communication with student accessible computing devices 1612, teacher and/or other education professional computing devices 1614, parent computing devices 1616, healthcare practitioner computing devices 1618, and a centralized healthcare organization (e.g., hospital, doctor's office, research facility, health insurance company, etc.) computing server 1620 in data communication with practitioner/patient accessible computing devices 1622. While a specific topology is illustrated, it is appreciated that various aspects of the illustrated topology could be readily changed. For example, computing servers (not shown) may be implemented between various ones of the computing devices 1608, 1614, 1616, 1618 or various computing devices can be implemented with combined functionality (e.g., a computing device may function as both a student computing device as well as a teacher and/or other education professional computing device, etc.). Moreover, computing servers (not shown) may be implemented between various ones of the computing devices 1608, 1614, 1616, 1618. In another example, various one of the computing devices and/or the assessment server may be in data communication with external databases (not shown) via the network 1606. These and other variants would be readily appreciated by one of ordinary skill given the contents of the present disclosure.

### Exemplary Cognitive Ability Assessment Server

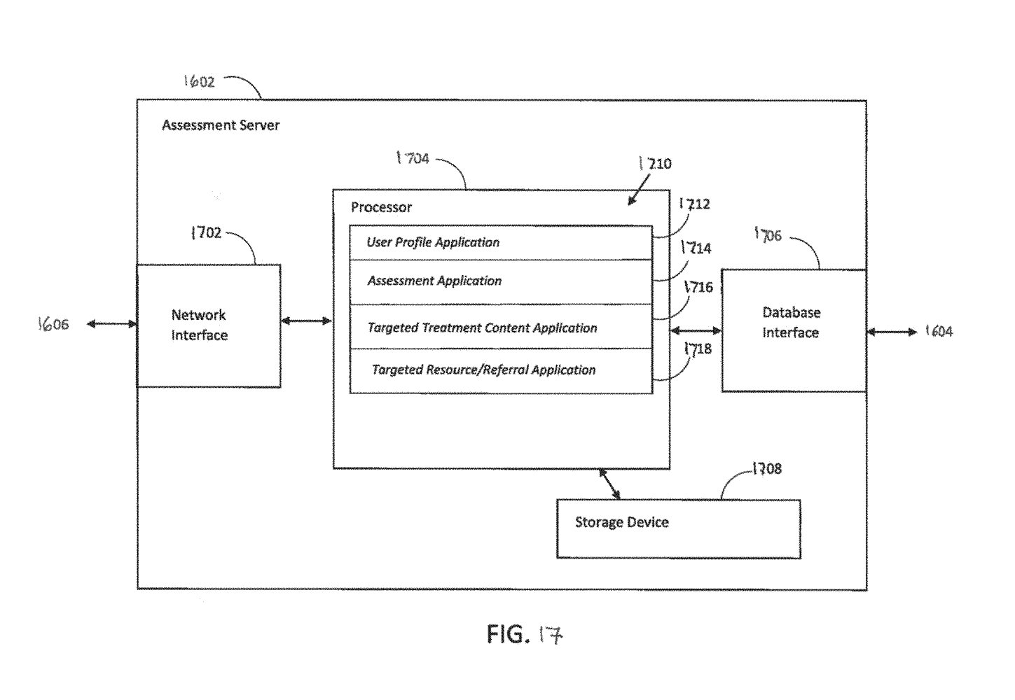

The block diagram shown in FIG. 17 depicts one exemplary embodiment of an assessment server 1602 for use in cognitive ability assessment. As depicted, the server 1602 generally includes a network interface 1702, a processor 1704, a database network interface 1706, and a storage device 1708. The network interface 1702 enables communication with the network 1606 illustrated in FIG. 16, while database network interface 1606 enables communication with database 1604 illustrated in FIG. 16. In an alternative embodiment, the database 1604 can be an internal component of the assessment server (such as consisting of storage device 1708). In yet another alternative embodiment, database network interface 1706 may be obviated altogether and access to database 1604 may occur via network interface 1702. The processor 1704 is configured to execute one or more applications 1710 thereon to carry out various functions of the assessment server 1602. In the illustrated embodiment, applications 1710 include a user profile application 1712, an assessment application 1714, a targeted treatment content application 1716, and a targeted resource and referral content application 1718. The aforementioned applications can be stored on storage device 1708, the database 1604 or a combination of both.

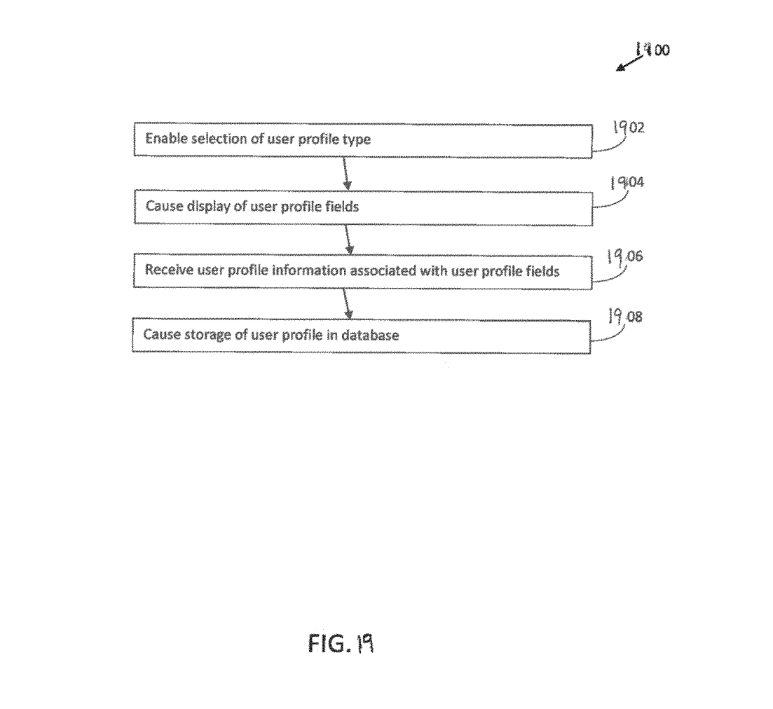

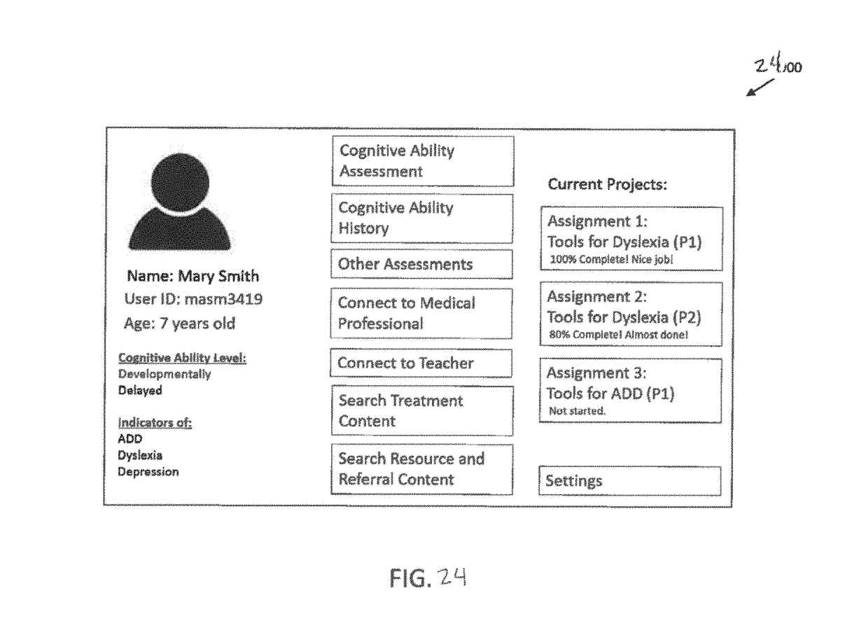

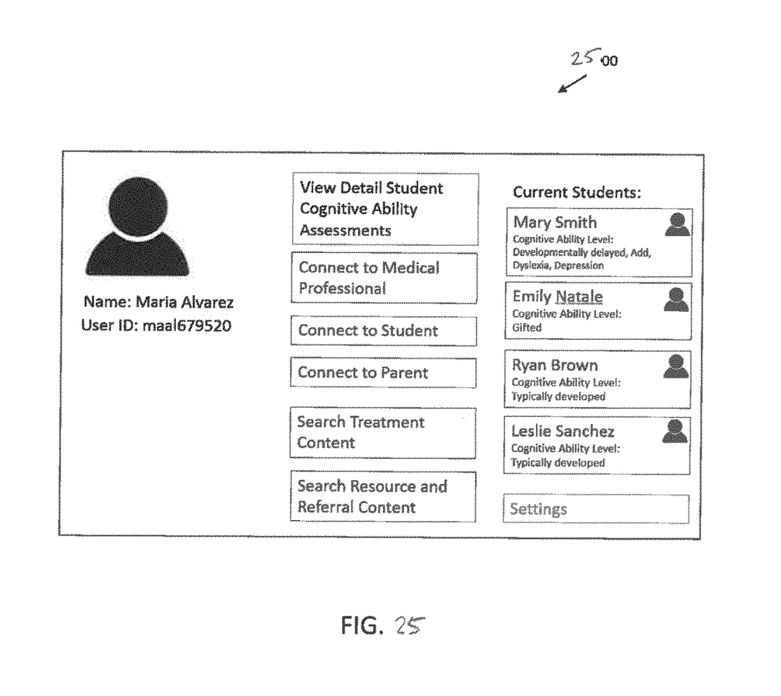

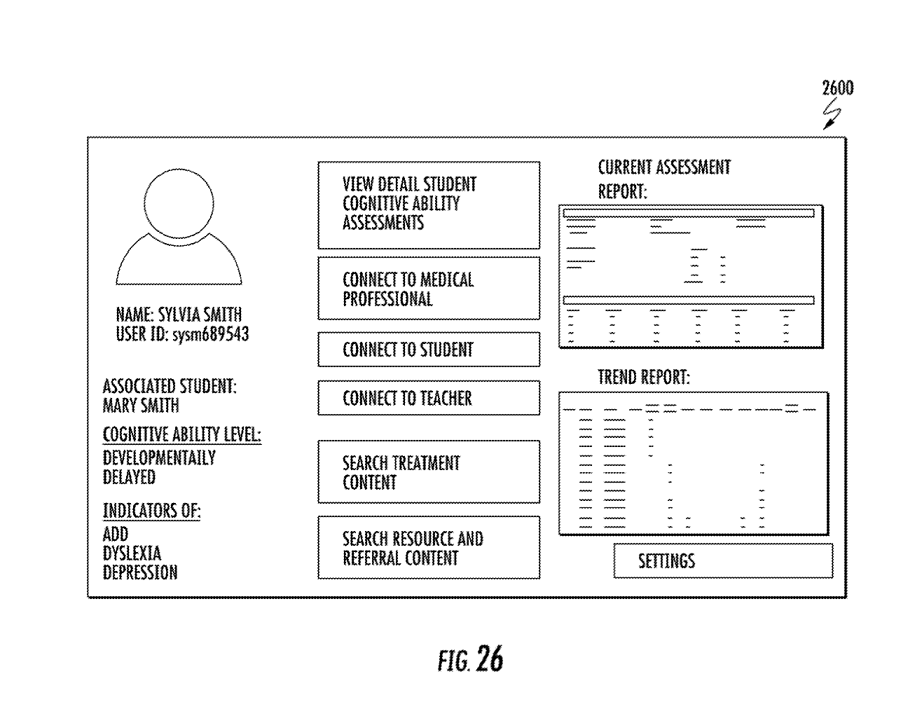

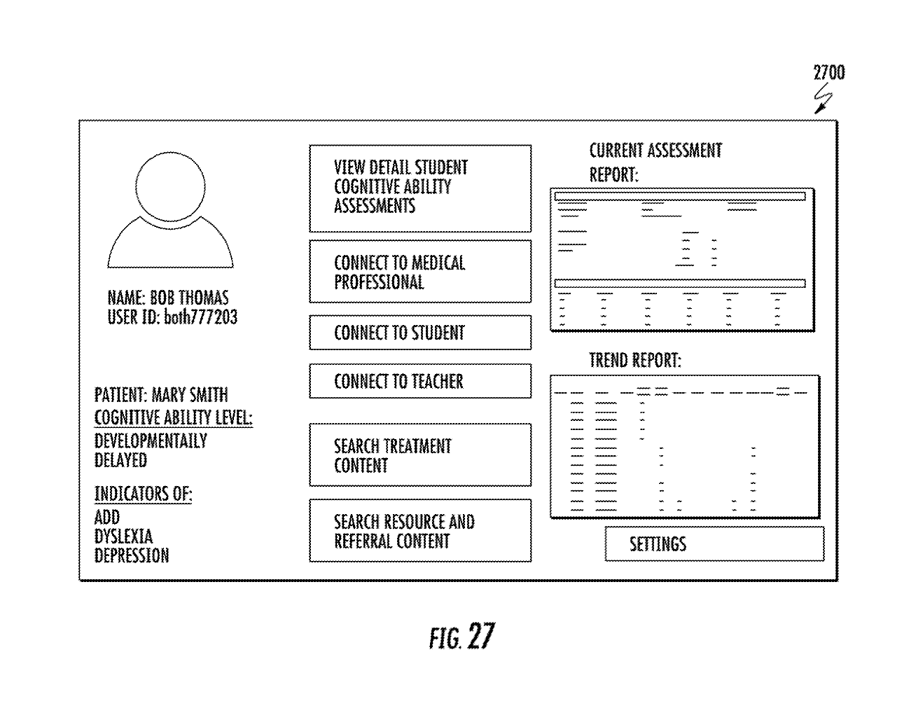

The user profile application 1712 enables collection of user information, such as a user's personal information, to create a user profile consisting of, for example, a student profile, a teacher profile, a counselor profile, a parent profile, a tutor profile, a healthcare professional/practitioner profile, etc. along with a stored identity associated with the user (e.g., a unique encoded identity). The aforementioned user information may include name, age, address, identity number, school information, grade level, academic interests, academic goals, career goals, academic experience, professional experience, contact information, ethnicity, etc. Behavioral records, certifications, test scores, graduation date, date of withdrawal, medical conditions, and/or psychological conditions can also be received, associated, and/or stored via the user profile application 1712. Moreover, based on the received user information, the user profile application 1712 can generate a user portal or profile (e.g., a student portal, a teacher portal, a parent portal, a tutor portal, a healthcare practitioner portal, etc.) in a graphical user interface (GUI) on a computing device of the user. The user portal or profile enables digital communication between individuals (e.g., students, groups of students, teachers, tutors, parents, and/or healthcare professionals). One exemplary method for generating and utilizing the user profile application 1712 is shown and discussed with reference to FIG. 19, while exemplary user portals are depicted in FIGS. 24-27 described subsequently herein.

The assessment application 1714 enables testing of an individual to determine a cognitive ability level of the individual. For example, a series of questions and/or tasks having two or more selectable and/or fill-in answers can be provided to an individual. Each of the questions and/or tasks is configured to test for various aspects of the individual's cognitive ability. Further, the questions and/or tasks can be configured to identify or diagnose one or more learning disabilities or psychological impairments. For example, psychological impairment may refer to a syndrome (e.g., PTSD, depression, etc.) characterized by clinically significant disturbance in an individual's cognition, emotion regulation, or behavior that reflects a dysfunction in the psychological, biological, or developmental processes underlying mental functioning. Psychological disorders are usually associated with significant distress in social, occupational, or other important activities. Significant distress can mean the person is unable to function, meet personal needs on their own, or are a danger to themselves or others.

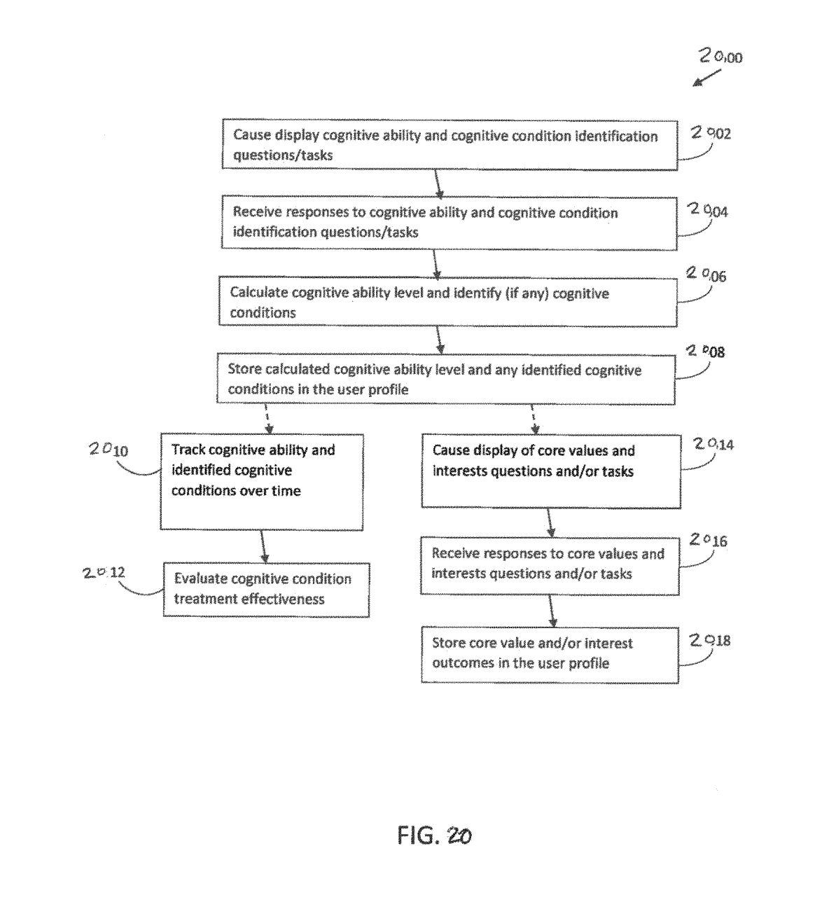

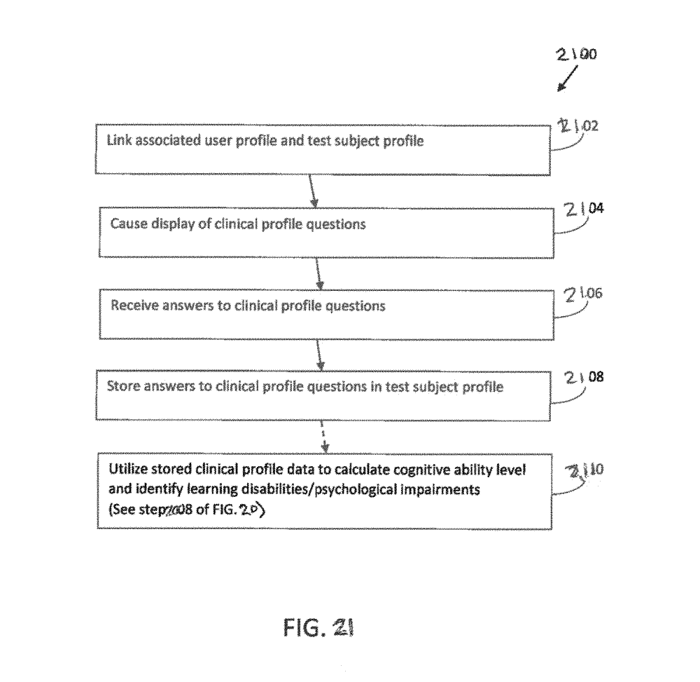

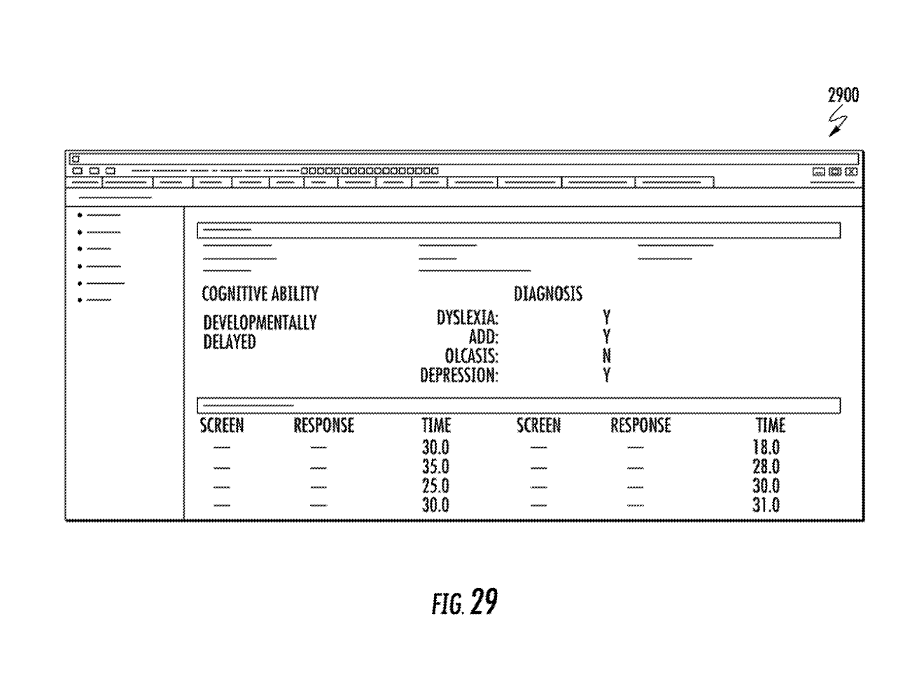

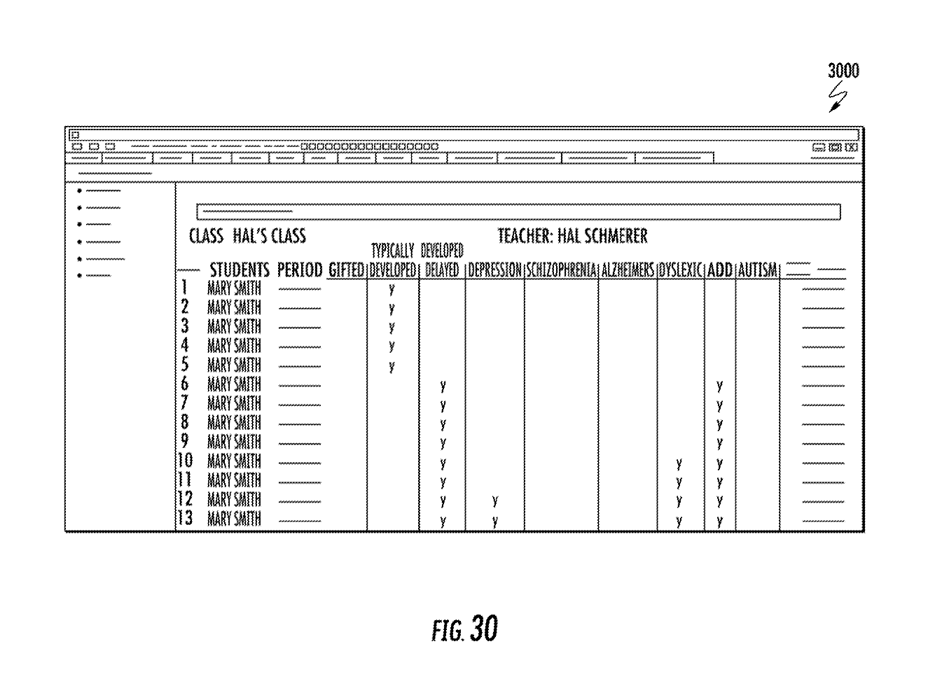

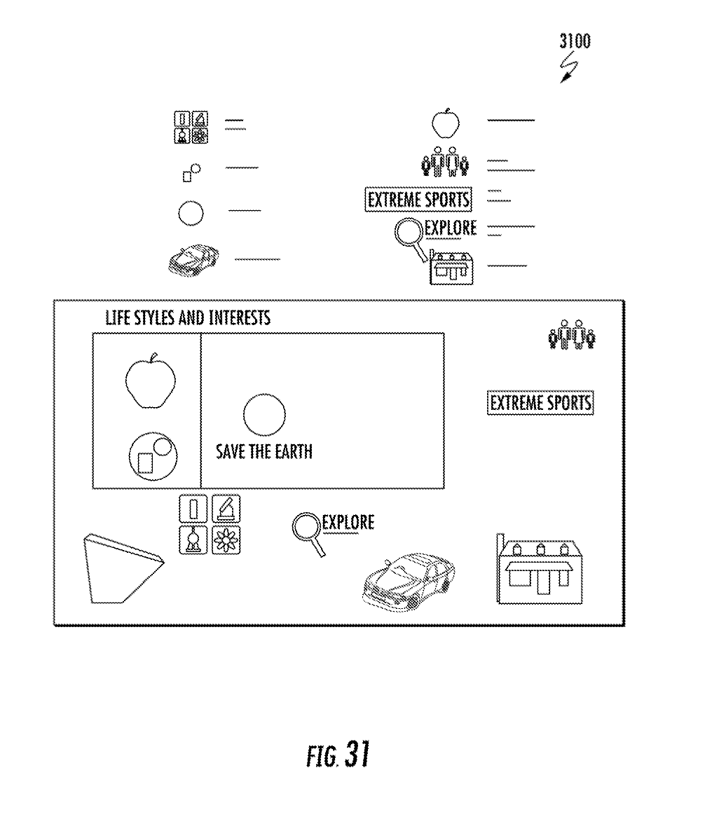

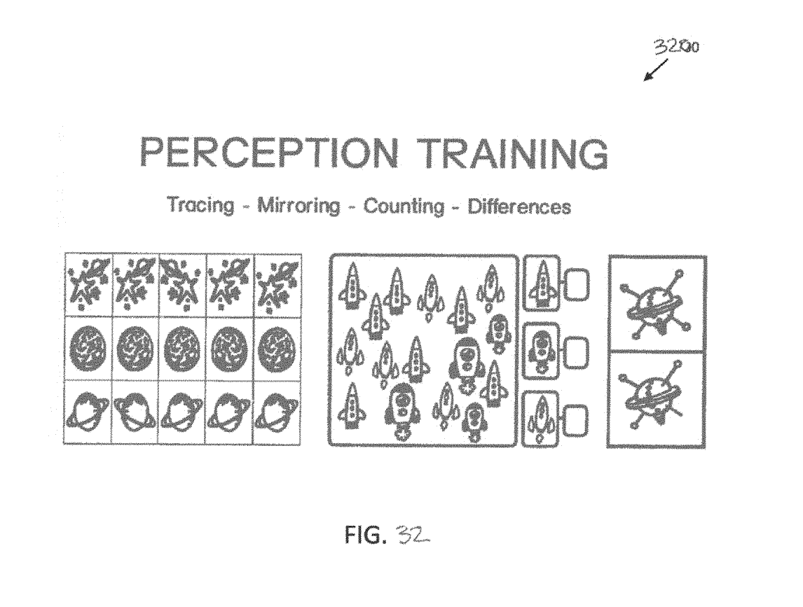

Based on the selections and/or responses received from the individual, the assessment application 1714 determines a cognitive ability level of the individual. Further, the assessment application 1714 can identify indicators (if any) of one or more cognitive conditions of the individual. Furthermore, the assessment application 1714 can assess executive functioning skills, core values, and/or interests of the individual. Further still, the assessment application 1714 can be used to create a clinical profile for the individual. In one example, a lifestyle questionnaire is administered to the individual (e.g., a test subject, a student, etc.) and/or another individual associated with the test subject (e.g., parent, teacher, counselor, healthcare practitioner, etc.). Results of the cognitive ability assessment, results of the lifestyle questionnaire, executive functioning skills, core values, interests, and/or any identified cognitive conditions are then stored within the test subjects' user profile. Additionally, execution of the assessment application can be repeated over time in order to identify consistency, changes, and/or patterns in cognitive ability, identified cognitive conditions, executive functioning skills, core values, and/or interests for a given individual. For example, the assessment application may be executed at regular intervals such as weekly, monthly, quarterly, bi-annually, annually, etc. Further, repetition of assessment can be used to evaluate effectiveness of cognitive treatment (e.g., counseling, specialized training, digital content exercises, medication, etc.). One exemplary method for the assessment application 1714 is shown and described subsequently herein with reference to FIGS. 20 and 21, while a schematic depiction of developmental ability modules, questions/tasks, and outputs are depicted in FIG. 29, exemplary assessment result reports are shown in FIGS. 30 and 31, and an example core value/interests assessment is shown in FIG. 32. Further, an example cognitive ability question and possible outcomes are shown in Appendix I, while example questions/tasks for cognitive condition identification or assessment are shown in Appendix II and example topics for creating a test subject clinical profile are shown in Appendix III. Appendix V includes various topics and questions/tasks for the so-called diagnostic and research application utilized with, for example, assessment server 1602.

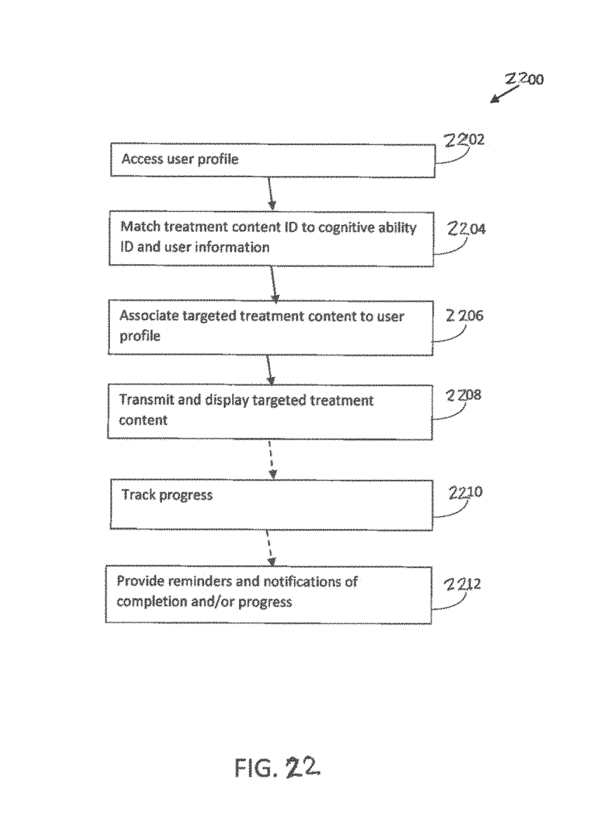

The targeted treatment content application 1716 enables the matching of learning/training content (e.g., assignments and exercises for adapting to or treating learning disabilities or other cognitive conditions) to individuals which are specific to identified cognitive conditions for each individual as determined, for example, via the assessment application 1714. For example, database 1604 may store digital treatment content in a variety of content compositions which are targeted to specific cognitive conditions. In one specific example, each of the digital treatment content items is encoded with a tag to identify and/or associate the content item with one or more cognitive conditions. A look-up table or analysis algorithm for identifying and delivering targeted cognitive condition-specific treatment content to individuals is used to match content to each individual and provide the content to the individual such as, for example, through a student portal accessible through a GUI of a computing device. Further, progress of the user through the digital content can be track and notifications associated with a status of the targeted treatment content can be provided (e.g., notifications of new assignments sent to students, notifications including reminders to complete sent to students, notifications of completion sent to parents or teachers, etc.). Additionally or alternatively, treatment content may be tangible content, such as DVDs, CDs, portable storage media, etc., which may be delivered to the student via a non-digital mechanism (e.g., postal delivery, in-store purchase, etc.). In such examples, database 1604 includes inventory data that includes categorization and/or codes (e.g., tags) associating each of the tangible content items with the identified cognitive condition for a given individual. Orders for delivery can be automatically generated based on the identified cognitive condition code of the individual and/or a user facilitated request for specified tangible content. One exemplary method of providing targeted treatment content is shown and discussed with reference to FIG. 22 described subsequently herein, while exemplary treatment content examples are depicted in FIGS. 32-34 described subsequently herein.

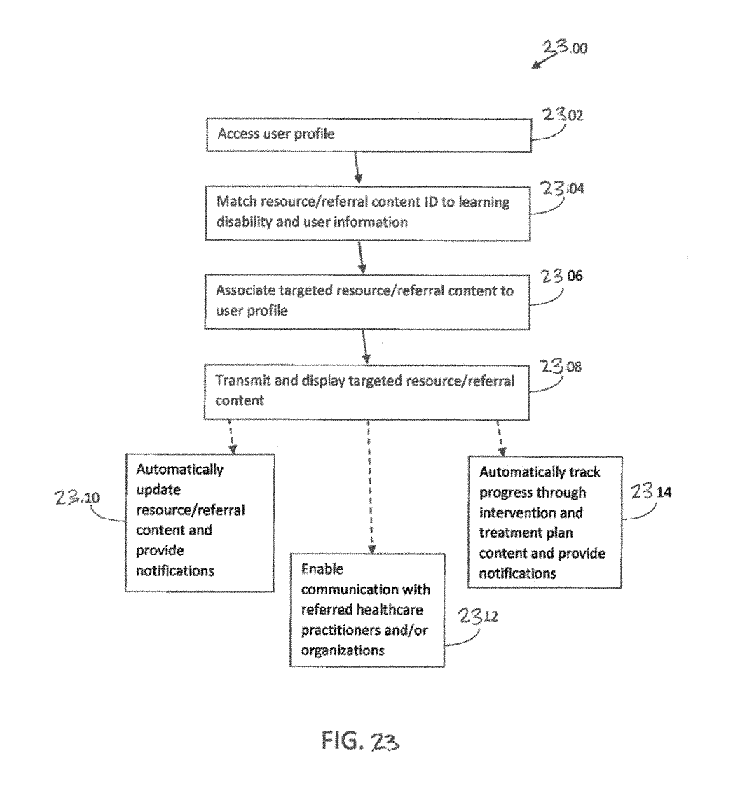

The targeted resource and referral application 1718 enables matching of resource content (e.g., treatment recommendations, scholarly articles, clinical study information, etc.) and/or referrals to healthcare practitioners and/or institutions for individuals which are specific to identified cognitive conditions of each individual as determined, for example, via the assessment application 1714. For example, database 1604 and/or medical and/or psychological health institution computing devices 1620 may store treatment recommendations, clinical study data, referral, and/or intervention and treatment plan content in a variety of content compositions which are each targeted to one or more specific cognitive conditions. In one specific example, each of the cognitive condition resource and/or referral items is encoded with a tag to identify and/or associate the content item with one or more specific cognitive conditions. A look-up table or analysis algorithm for identifying and delivering cognitive condition-specific resource/referral content to individuals is used to match content to each individual and provide the content to the individual or another associated individual such as, for example, through a student, teacher, parent, and/or healthcare practitioner portal accessible through GUIs of the individuals' respective computing devices. One exemplary method of providing cognitive condition-specific resource and/or referral content is shown and discussed with reference to FIG. 23 described subsequently herein, while exemplary recommended treatments (which can be included in resource content) are described in Appendix IV.

### Methods

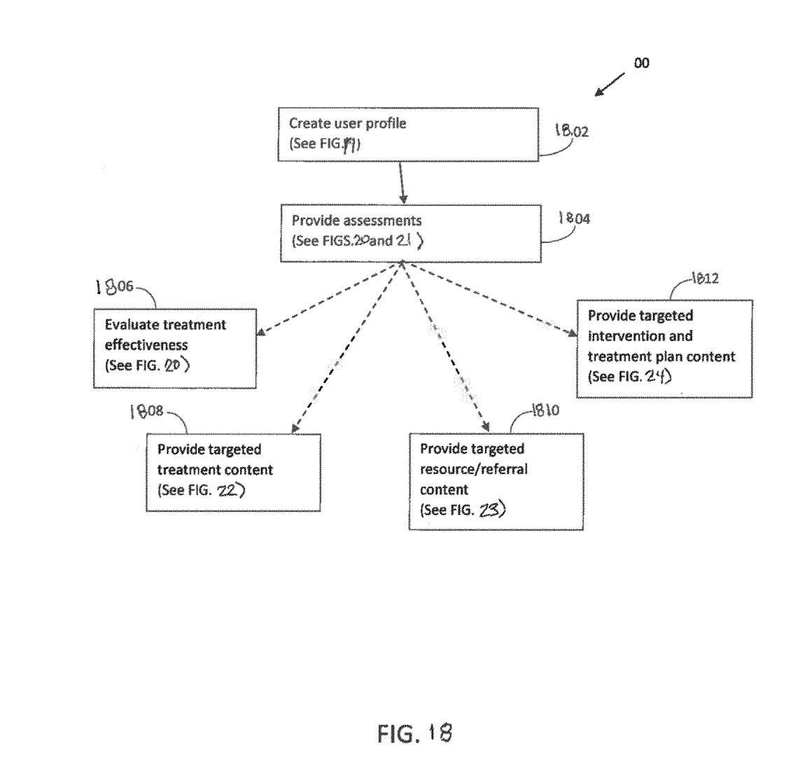

Referring now to FIG. 18 an exemplary methodology 1800 for utilizing the various applications contained with the assessment server 1602 are illustrated for purposes of facilitating the overall understanding and use of the methodologies described herein. At step 1802, a user profile is initially created using the user profile application 1712. Next, at step 1804, cognitive ability of a user is assessed and/or cognitive conditions (if any) of a user are identified using the assessment application 1714. Additionally, core values, interests, and/or lifestyle are assessed using the assessment application 1714. The calculated cognitive ability level, core values, interests, lifestyle descriptors, and/or any identified cognitive conditions are stored in the user profile. After the various assessments, the method 1800 optionally includes providing evaluation of treatment effectiveness via assessment application 1714 (step 1806), providing targeted treatment content via the targeted treatment content application 1716 (step 1808), providing targeted resource and referral content via the targeted resource and referral application 1718 (step 1810), and/or providing targeted intervention and treatment plan content via the targeted intervention and treatment plan application 1720 (step 1812).

### Creation of User Profiles

An exemplary methodology 1900 for creating a user profile is shown in FIG. 19. At step 1902, prior to the entering of user information, the user is first presented with user profile types and prompted to selects a user profile type. For example, the user may be a student and select or enter student criteria to create a student profile. In another example, the user may be a teacher and select or enter teacher criteria to create a teacher profile. In yet another example, the user may be a parent and select and/or enter parent criteria to create a parent profile. In even another example, the user may be a healthcare practitioner and/or enter healthcare practitioner criteria to create a healthcare practitioner profile. At step 1904, various user profile data entry fields are displayed to a user in order to facilitate collection of user information. For example, the data entry fields are displayed on a graphical user interface (GUI) on a user's computing device. These various user profile data entry fields include, for example, name for the user, age of the user, current or prior addresses, user identity number, school information associated with the user, user's current grade level, ethnicity, user's academic interests, user's academic goals, user's career goals, user's academic experience, user's professional experience, degrees, etc. Additionally, a credential and/or password may be required during initial creation of the user profile. Further, the created user profiles can be stored as searchable lists in database 1604 for later retrieval of specific user profiles, groups of user profiles and/or based on user information contained within a given user profile.

At step 1906, the user information is received from the user in, for example, various prompted fields in a GUI displayed on a user's computing device. Additionally, other user information may be automatically populated such as, for example, the user's academic records, user's behavioral records, certifications, other test scores, medical history, and/or psychological history. The user profile is then saved and stored (such as, for example, storing the user profile in database 1604 illustrated in FIG. 16) at step 1908. Further, the user and/or the system may create a log in ID and/or password for subsequent user access to system 1600. Example user profiles/portals 2400, 2500, 2600, and 2700 for a student, a teacher, a parent, and a healthcare professional are shown in FIGS. 24-27, respectively. In some examples, communication is enabled via the user portals to allow communication between various ones of the student, the teacher, the parent, and/or the medical professional.

### Cognitive Ability Assessment

An exemplary methodology 2000 for cognitive ability assessment is shown in FIG. 20. After creating and storing the user profile, cognitive ability assessment can be immediately carried out. Further, cognitive conditions, executive functioning skills, core values, and/or interests can additionally be assessed. Alternatively, the user profile may be saved and logged into at a later time to complete one or more of the various assessments. In either example, upon initiation of cognitive ability assessment, questions and/or tasks are displayed to the user at step 2002. A series of questions and/or tasks having fill-in and/or two or more selectable answers is provided to the user. In the present example, one question is displayed to the user and after receiving the user answer the following question is displayed. Further, at least a portion of the questions and/or tasks are each configured to determine a cognitive ability level of the user (i.e., test subject). Furthermore, a portion of the questions and/or tasks are each configured to test for identification of one or more cognitive conditions (e.g., learning disabilities, neurobehavioral disorders, psychological factors, psychological impairments or disorders, and/or social emotional functioning disabilities). In an alternate example, the questions and/or tasks are each designed to test only for cognitive ability and do not include cognitive condition diagnostic questions and/or tasks. The user's selections, answers, and/or responses are transmitted to and received at the assessment server (step 2004), where the cognitive ability level is calculated (step 2006).

Questions and/or tasks for cognitive ability assessment and cognitive condition identification are designed to target specific developmental ability or age groups. Thus, the questions and/or tasks presented to the user may be based on the age of the user. In one example, three developmental ability tests are available (i.e., stored in database 1604) and selectively provided depending on the age of the user (e.g., 3-4 years old, 5-8 years old, 9-13 years old, 14-18 years old, 19-24 years old, and adults of greater than 24 years of age) stored in the user profile. In other examples, developmental ability can be based on or classified by different age groupings and/or can include more or fewer developmental ability groupings. In even other examples, developmental ability can be based on an alternate user/test subject attribute (e.g., grade level).

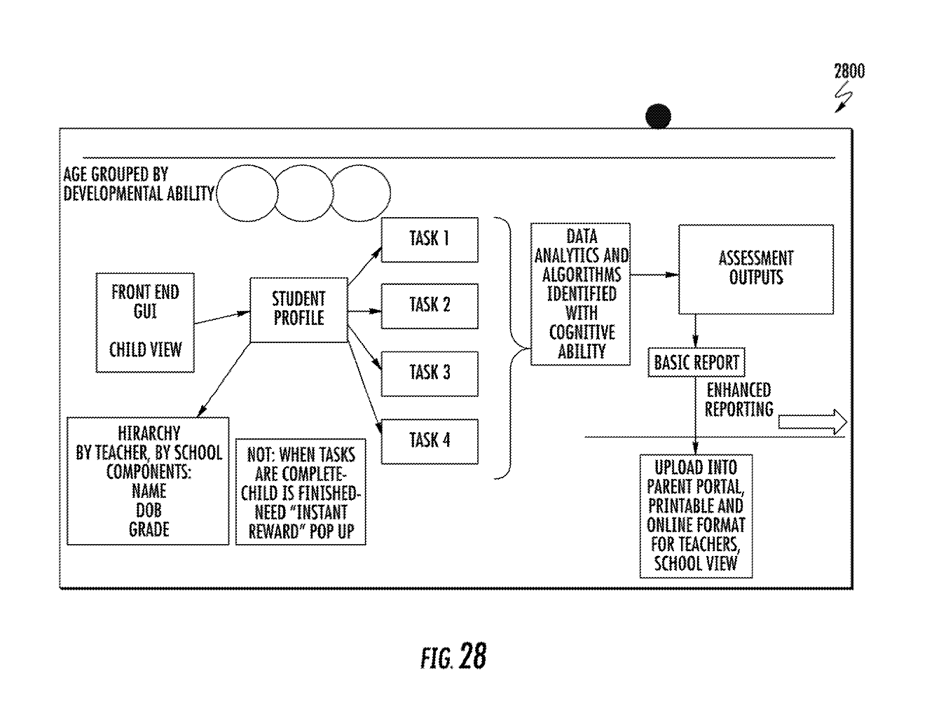

A schematic depiction 2800 of a series of questions for cognitive ability assessment (which may be stored in, for example, database 1604 and accessible to the assessment server 1602) is shown in FIG. 28. Additionally, an example of various criteria for typically developed, gifted, and cognitively delayed cognitive ability designations and an example question for cognitive ability assessment are shown in Appendix I. As discussed elsewhere herein, questions for cognitive ability assessment are designed/configured to test for cognitive ability of a specific developmental ability group. Within each developmental ability grouping, each task is targeted to be completed within a pre-determined time period (e.g., 30 seconds). The appropriate pre-determined time period and/or complexity of the questions/tasks can be determined based on the standard deviation from the mean of a statistically significant sample size of individuals within the specified developmental ability group (e.g., age group). Thus, results of assessment of a test subject (e.g., a user, a student, etc.) showing the test subject is able to complete questions for their respective developmental ability group within the pre-determined time period are indicative of a typically developed cognitive ability. Further, results of assessment of a test subject (e.g., a user, a student, etc.) showing the test subject is unable to complete questions for their respective developmental ability group within the pre-determined time period are indicative of a delayed cognitive ability. Furthermore, results of assessment of a test subject (e.g., a user, a student, etc.) showing the test subject is able to complete questions for their respective developmental ability group and an advanced developmental ability group (e.g., an older age grouping) within the pre-determined time period are indicative of a gifted cognitive ability.

Additionally or alternatively, results of cognitive ability assessment can be based on “hesitation” (i.e., a hesitation period) in answering each question. For example, the timing of the test subject to provide an answer for a question/task (i.e., a time to complete the question/task) can be recorded using a computerized tracking clock. An averaged time to complete each question can be determined based on the standard deviation from the mean of a statistically significant sample size of individuals within the specified developmental ability group (e.g., a specified age group). Thus, results of assessment of a test subject (e.g., a user, a student, etc.) showing the test subject is able to complete questions for their respective developmental ability group with average hesitation (i.e., a completion time that is average) are indicative of a typically developed cognitive ability. Further, results of assessment of a test subject (e.g., a user, a student, etc.) showing the test subject is unable to complete questions for their respective developmental ability group high hesitation (i.e., a completion time that is above average) are indicative of a delayed cognitive ability. Furthermore, results of assessment of a test subject (e.g., a user, a student, etc.) showing the test subject is able to complete questions for their respective developmental ability group and/or an advanced developmental ability group (e.g., an older age developmental ability group) with low hesitation (i.e., a completion time that is below average) are indicative of a gifted cognitive ability.

Returning to the example question shown in Appendix I, the question is designed and/or configured for a 5-8 year old developmental ability group. Specifically, an image is displayed on a GUI of a user computing device showing a group of students and a teacher in a class discussing plants and photosynthesis. For example, the image may include a diagram of a photosynthetic and cellular respiration cycles. The test subject/user is then asked (e.g., via an auditory/verbal cue) to select which item of a group does not belong or is different from the other items in the group. In this example, the selectable group of items include a plant, a sun, water, and a bulldozer. The test subject then selects one of the items (via e.g., a mouse click, a touch on a touch screen) and a time period for the selection as well as the test subject's answer are recorded. Selection of the bulldozer will result in recording a correct (e.g., “Y”) answer, while selection of the plant, the sun, or the water will result in recording of an incorrect (e.g., “N”) answer. If the test subject fails to answer the question within a pre-determined time period (e.g., 30 seconds), then the question is timed out and a non-selection (e.g., “X”) is recorded. In either case, a subsequent question is then displayed on the GUI until the test subject completes all questions/tasks for the cognitive ability assessment.

In one embodiment, an outcome (i.e. an indicated cognitive ability level) of the question/task is dependent upon the age of the test subject, the selected answer, and selection of the answer within a pre-determined time period. Accordingly, in one example, the test subject is 3 years old and selects the correct answer within the predetermined time period, indicating a gifted cognitive ability. In another example, the test subject is 6 years old and selects the correct answer within the pre-determined time period, indicating a typically developed cognitive ability. In yet another example, the test subject is 6 years old and selects the wrong answer within the pre-determined time period, indicating a delayed cognitive ability. In still another example, the test subject is 6 years old and does not select an answer within the pre-determined time period, indicating a delayed cognitive ability.

In another embodiment, an outcome (i.e. an indicated cognitive ability level) of the question/task is dependent upon the age of the test subject, the selected answer, selection of the answer within a pre-determined time period, and the specific time in which the selection was made by the test subject. Accordingly, in one example, the test subject is 3 years old and selects the correct answer within the predetermined time period, indicating a gifted cognitive ability. In the aforementioned example, the hesitation period can be any duration. In another example, the test subject is 6 years old and selects the correct answer with a hesitation period that is less than the average range for the 5-8 year old developmental ability group, indicating a gifted cognitive ability. In yet another example, the test subject is 6 years old and selects the correct answer within the pre-determined time period with a hesitation period that is within the average range for the 5-8 year old developmental ability group, indicating a typically developed cognitive ability. In yet another example, the test subject is 6 years old and selects the correct answer within the pre-determined time period with a hesitation period that is greater the average range for the 5-8 year old developmental ability group, indicating a delayed cognitive ability. In even another example, the test subject is 6 years old and selects the wrong answer within the pre-determined time period, indicating a delayed cognitive ability. In the aforementioned example, the hesitation period can be any duration. In still another example, the test subject is 6 years old and does not select an answer within the pre-determined time period, indicating a delayed cognitive ability. As no selection is provided in the latter example, no hesitation period is recorded.

In addition to calculating and displaying an overall cognitive ability level, one or more identified or diagnosed cognitive conditions (e.g., learning disabilities, neurobehavioral disorders, psychological factors, psychological impairments or disorders, and/or social emotional functioning disabilities) can be assessed and determined via method 2000. In one embodiment, one or more questions/tasks displayed to the user in the cognitive ability assessment (such as, e.g., a portion of the questions shown in FIG. 28) are designed/configured to test for one or more cognitive conditions of the test subject. Examples of various questions/tasks for identification of cognitive conditions that may be included in the cognitive ability assessment are shown in Appendix II.

In addition to receiving a selection and recording a hesitation period, one or more of the questions/tasks for identification of cognitive conditions may record and analyze “eye tracking” of the test subject in determining/calculating an outcome. Thus, in examples which record and assess eye tracking, the user computing device is data communication with an eye tracking device such as e.g., an eye wear article or a detection device (e.g., video camera) directed towards the test subject's eyes. In alternate embodiments, eye tracking may be excluded from assessment or eye tracking may be a component of cognitive ability level determination/calculation. For example, eye tracking may be utilized to assess optokinetic reflex and optokinetic nystagmus for a given individual.

Optokinetic reflex refers to a combination of a saccade (e.g., quick, simultaneous movement of both eyes between two or more phases of fixation in the same direction) and smooth pursuit eye movements. It is generally observed when an individual follows a moving object with their eyes but their head remains stationary, which then moves out of the field of vision at which point their eye moves back into position it was in when it first saw the object. Saccade can be associated with a shift in frequency of an emitted signal or a movement of a body part or device. Eye movement measurements of saccade can be used to investigate psychiatric disorders. For example, ADHD is characterized by an increase of anti-saccade errors and an increase in delays for visually guided saccade. Smooth pursuit (e.g., so-called “smooth sweeping”) refers to voluntary movements of both eyes in order to closely follow a moving object. Smooth pursuit is tightly coupled for closed loop pursuit and spatial attention. During the close loop phase selective attention is coupled to the pursuit target such that untracked targets which move in the same direction with the target are pooled processed by the visual system. Eye movement measurements of smooth pursuit can be used to investigate psychiatric disorders. For example, schizophrenic patients have trouble pursing fast targets due to less activation in the front eye field. Optokinetic nystagmus generally consists of initial slow phases in the direction of the stimulus (smooth pursuits), followed by fast, corrective phases (saccade). Presence of nystagmus indicates an intact visual pathway.

Additionally, so-called augmented reality (AR) can be utilized for cognitive assessments. AR can be utilized in various sensory formats such as visual, auditory or physical (e.g., moving) or combinations of the foregoing. For example, the sensory format chosen for a given individual may be selected by the individual themselves or, alternatively, be selected by another individual such as a parent or a teacher. The questions and/or tasks used in cognitive assessment could then take the form of, for example, a combination of AR and eye tracking in order to help assess various cognitive traits associated with that individual.

Returning to Appendix II, example modules A-G include questions/tasks for identification of attention deficit hyperactivity disorder (ADHD), autism, dyslexia, Alzheimer's, schizophrenia, immune deficiency, and depression, respectively. In one example, as indicated in module B, questions/tasks can be configured to determine whether an individual's cognitive ability assessment includes indicators for autism. In order to carry out the assessment for autism without use of eye tracking, questions/tasks can be designed to test for tactile aversion. In one specific implementation, an example task includes displaying an image of a child with finger paints and another image of a child with a paint brush. The test subject is prompted (e.g., via an auditory/verbal cue) to select which activity they would prefer. Selection (e.g., a mouse click, a touch on a touch screen, etc.) by the test subject is recorded. During subsequent analysis/calculation of the test subject's recorded answers (such as e.g., via an analysis algorithm of assessment application 1714), selection of the image including the paint brush is an indicator of autism. Additionally or alternatively, in order to carry out the assessment for autism utilizing eye tracking, questions/tasks can be designed to test for a reduced velocity of smooth pursuit. Accordingly, in another specific implementation, an example task includes displaying vertically rising and falling balloons moving at various velocities (e.g., 10 deg/sec, 20 deg/sec, and 30 deg/sec). The balloons have a variety of colors and the test subject is prompted (e.g., via an auditory/verbal cue) to select (e.g., a mouse click, a touch on a touch screen, etc.) only one color of balloons (e.g., select only yellow balloons). A number of correctly selected balloons within a pre-determined time period (e.g., 30 seconds) and eye movements of the test subject are recorded. During subsequent analysis/calculation of the test subject's recorded answers (such as e.g., via an analysis algorithm of assessment application 1714), a lower than average score and/or reduced velocity of smooth pursuit are indicators of autism.

In another example, as indicated in module C, questions/tasks can be configured to determine whether an individual's cognitive ability assessment includes indicators for dyslexia. In order to carry out the assessment for dyslexia, questions/tasks can be designed to test for interference processing to test for reduced mismatch negativity (MMN) and/or late discriminative negativity (LDN). In one specific implementation, an example task includes playing an auditory stimuli (e.g., music having complex sounds of fast temporal variations in duration, intensity, and/or frequency of tones) and displaying an image of a vanilla ice cream cone and another image of a chocolate ice cream cone. As the auditory stimuli is maintained, the test subject is prompted (e.g., via an auditory/verbal cue) to select (e.g., a mouse click, a touch on a touch screen, etc.) one of the ice cream flavors. A selection of one of the images or a non-selection is recorded. During subsequent analysis/calculation of the test subject's recorded answers (such as e.g., via an analysis algorithm of assessment application 1714), a non-selection is an indicator of dyslexia. In another specific implementation, an example task includes displaying images of various objects in horizontal and vertical irregular patterns. Further, distinct sounds associated with each object are projected as the test subject is prompted (e.g., via an auditory/verbal cue) to select (e.g., a mouse click, a touch on a touch screen, etc.) the fastest moving object. A number of correctly selected objects within a pre-determined time period (e.g., 30 seconds) are recorded. During subsequent analysis/calculation of the test subject's recorded answers (such as e.g., via an analysis algorithm of assessment application 1714), a lower than average score is an indicator of dyslexia.

Also shown in Appendix II, module H includes executive functioning skill characteristics that may be tested in combination with cognitive ability assessment and learning disabilities/psychological impairment identification. Evaluation of executive functioning skills may be included in analysis/calculation of results for cognitive ability assessment and learning disabilities/psychological impairment identification. For example, results of evaluation of executive functioning skills can be used in calculation in order to differentiate indicators of PTSD vs. other cognitive impairments. Additionally or alternatively, analysis of executive functioning skills can be “stand alone”. For example, results of evaluation of executive functioning skills can be used to identify opportunities for development in test subject's having a TD cognitive ability level and/or to identify an appropriate therapy for an individual after identification/diagnosis of one or more learning disabilities/psychological impairments. Example executive functioning skills that can be evaluated include, but are not limited to: impulse control, emotional control, flexible thinking, working memory, self-monitoring, planning and prioritizing, task initiation, and organization.

Returning to FIG. 20, as described above, upon completion of answering each question/task by the test subject, the recorded answers/data associated with each question/task are transmitted to the assessment server 1602 where the cognitive ability level for the user is calculated and/or one or more (if any) cognitive conditions are identified (such as, e.g., via the assessment application 1614) and stored in the respective user profile (step 2008). Results of the assessment can then be displayed on a computing device.

FIG. 29 shows an example assessment recordation 2900 generated via assessment application 1714 which may be displayed on a GUI of a user accessible computing device (such as, e.g., computing devices 1608, 1612, 1614, 1616, 1618, 1622). In the example depicted in FIG. 29, general student information (such as e.g., information collected to create the user profile via method 1900) is included at a top portion of the assessment recordation 3000. At an opposing bottom portion, questions/tasks included in the assessment are identified by a screen number (e.g., 1A.1, 1A.2, 1B.1, etc.). Correct responses for questions/tasks are indicated by “Y”, while incorrect responses are indicated by “N”. Further, a hesitation period (i.e., a duration of time between display of the question and receipt of a selection from the test subject) is displayed. Questions/tasks for which the test subject did not provide an answer within the pre-determined time period (e.g., 30 seconds) are indicated by “X”. As depicted in FIG. 29, the various results (i.e., correct selections, incorrect selections, non-selections, and/or hesitation periods) are input into one or more analysis algorithms (such as an analysis algorithm of assessment application 1714) to yield and display an overall cognitive ability result. In the present example, the cognitive ability outcome is “Developmentally Delayed”. Further, the various results (i.e., correct selections, incorrect selections, non-selections, hesitation periods, and/or eye tracking data) are input into one or more analysis algorithms (such as an analysis algorithm of assessment application 1714) to yield and display any identified cognitive conditions. In the present example, identified cognitive conditions include “Dyslexic”, “ADD”, and “Depression”.

As shown in FIG. 20, method 2000 optionally further includes tracking cognitive ability and any identified cognitive conditions over time via periodic repeated assessment of the test subject (e.g., cognitive ability assessment performed every three months) at step 2010. FIG. 30 includes an example trend analysis table 3000 for cognitive ability assessment of one example user. As depicted in FIG. 30, cognitive ability assessment was repeated at three month intervals. Specifically, assessments at 2015 Sep. 1 and 2015Dec. 1 show a developmentally delayed cognitive ability level, as well as indicators of depression, dyslexia, and ADD; assessments at 2016Mar. 1 and 2016 Jun. 1 show a developmentally delayed cognitive ability level, as well as indicators of dyslexia and ADD; assessments between 2016 Sep. 1 and 2017 Jun. 1 show a developmentally delayed cognitive ability level, as well as an indicator of ADD; and assessments between 2017 Sep. 1 and 2018 Sep. 1 show a typically developed cognitive ability level. Results of periodic cognitive ability assessment can be used to assess treatment effectiveness at step 2012. In one example, assessment of treatment effectiveness can be calculated/determined via one or more analysis algorithms (e.g., such as an analysis algorithm of assessment application 1714). Additionally or alternatively, treatment effectiveness can be analyzed by a healthcare professional or education professional.

Also optionally, method 2000 can further include assessment of core values and interests of the test subject. For example, at step 2014, method 2000 includes display of core value and interests questions/tasks. Responses from the test subject may be received (step 2016) and outcomes stored in the user profile (step 2018). FIG. 31 shows one example format 3100 for collecting core value and interest data. In this example, images represent various core values included in a legend (i.e., science learning, health and wellness, middle class, family, sustainability, adventure and curious, extrinsic motivated, and white collar). Each of the images can be selected (e.g., a mouse click, a touch on a touch screen, drag and drop into a selection box, etc.) by the user/test subject at the user computing device and received at assessment server 1602 for storage in the user profile. In other examples, core value and interests may be assessed via questions (rather than selection only task) and/or fewer or additional core values and interests may be assessed.

Furthermore, in addition to data (e.g., user profile data and cognitive assessment data) collected from the test subject, other data can be collected from another user associated with the test subject (e.g., a parent, a caregiver, a teacher, or a medical professional) for use in overall cognitive ability assessment. An exemplary method 2100 for collecting additional data from another user associated with the test subject is shown in FIG. 21. Prior to method 2100, the associated user creates a user profile using method 1900 shown in FIG. 19. Subsequently, at step 2102, the associated user profile (e.g., parent or other caregiver profile, teacher profile, medical professional profile, etc.) is linked to the test subject profile (e.g., a profile of a child, a student, and/or a patient of the associated user). Clinical profile questions (e.g., in a questionnaire format) are displayed at a computing device of the associated user and answers are received from the associated user at steps 2102 and 2104, respectively. One example of clinical profile data components that can be collected from the associated user are included in Appendix III. Specifically, an associated user questionnaire includes questions directed to: (i) environmental factors (e.g., adoption, bilingual, presence of parent, other family occurrences/characteristics, etc.), (ii) demographics (e.g., race, household income, zip code, etc.), (iii) test subject behavioral attributes in an educational environment (e.g., disciplinary infractions, expulsion/suspension occurrences, absences/tardiness, etc.), (iv) observed emotional cognition (e.g., ratings of happiness, sadness, anger, etc.), and (v) early childhood behaviors (e.g., temperament, self-regulation, adaptive self-control, etc.). It will be appreciated that answers for the clinical profile questionnaire may be additionally or alternatively received from the test subject (such as e.g., depending on the age of the test subject).

Returning to FIG. 21, at step 2108 the received answers are stored in the test subject profile (i.e., the test subject profile linked to the associated user profile at step 2102). In one embodiment, the stored clinical profile data may be accessed by a healthcare professional after cognitive ability assessment of the test subject. In another embodiment, as indicated at step 2110, the clinical profile data can optionally be utilized in calculation of the cognitive ability level and identification of any cognitive conditions of the test subject.

In one embodiment, results of the aforementioned evaluations (methods 2000 and 2100) are early warning indicators (EWIs) of cognitive conditions (i.e., carried out during general cognitive ability assessment or pre-screening for EWIs). In another embodiment, results of cognitive condition evaluation are a component of diagnosis determination carried out by a healthcare professional in combination with other assessments (e.g., interviews, in-person assessment, etc.). In even another embodiment, cognitive condition evaluation is carried out after a test subject has received treatment for a previously identified EWI or diagnosis of one or more cognitive conditions (i.e., post-assessment) in order to evaluate treatment effectiveness.

### Provision of Targeted Treatment Content

An exemplary method 2200 for providing targeted treatment content (e.g., treatment digital content specific to a user's identified cognitive conditions) is shown in FIG. 22. In some examples, the method 2200 is initiated in response to a request for treatment content from a user. Specifically, the user may request treatment content related to one or more learning disabilities, neurobehavioral disorders, psychological factors, psychological impairments or disorders, and/or social emotional functioning disabilities. Alternatively, the method 2200 may automatically be carried out after completion of cognitive ability assessment (such as e.g., cognitive ability assessment via method 2000).

At step 2202, the assessment server 1602 accesses a user profile stored in database 1604 to obtain identified cognitive conditions associated with the user and/or other user information (e.g., age, grade-level, linked medical professional ID, etc.). At step 2204, method 2200 includes matching (e.g., searching and identification) of treatment content for content that is appropriate and/or designed for one or more specific cognitive conditions such as, e.g., those shown in Appendix II and discussed elsewhere herein. Further, the treatment content may additionally be related to other user information, such as, e.g., age group, grade-level, gender, etc.

In order to perform matching of treatment content to a user's identified cognitive conditions searches digital treatment content. For example, the search may include a look-up table or analysis algorithm for identifying and delivering targeted cognitive condition-specific treatment content. Additionally, or alternatively, assessment server 1602 may have searchable access to other treatment content such as, for example, content stored in other databases, content accessible via the Internet or other controlled or uncontrolled networks, etc.

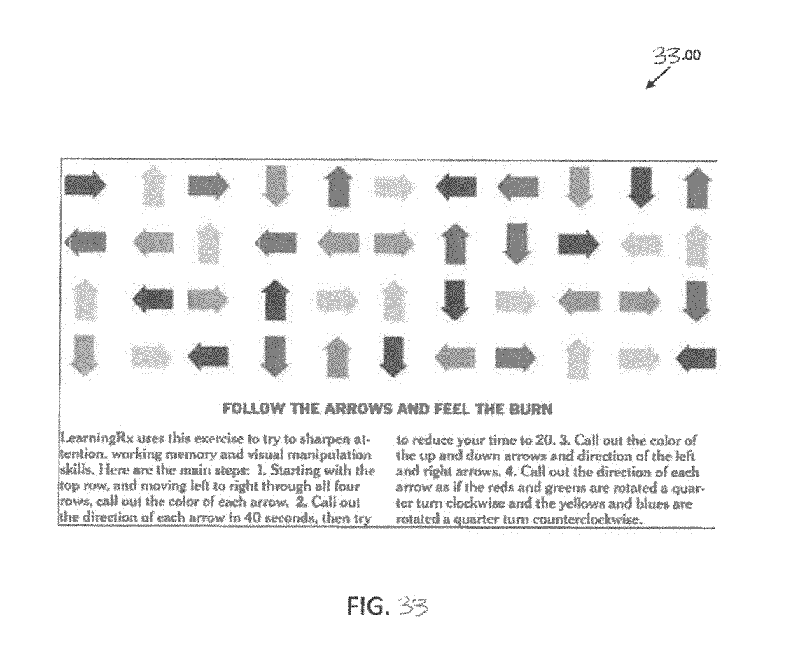

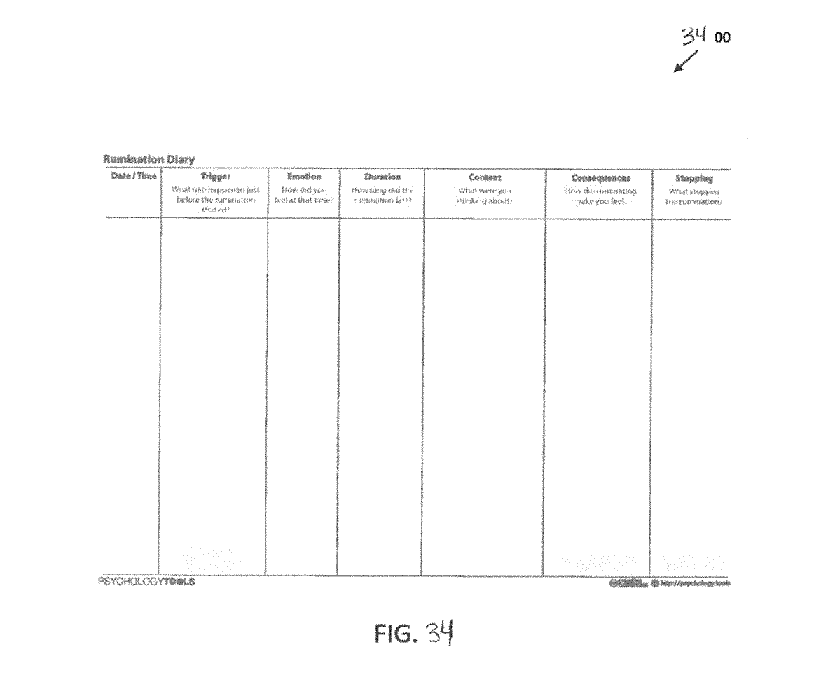

FIGS. 32-34 show examples of targeted cognitive condition-specific treatment content that may be searched and identified in step 2204 during matching of treatment digital content to the user information. Specifically, FIG. 32 shows an example of digital content 3200 including treatment visual exercises for dyslexia, while FIG. 33 shows an example of digital content 3300 including treatment visual and verbal exercises for ADHD and FIG. 34 shows an example of digital content 3400 including rumination diary for treatment of depression. Although only three examples of cognitive condition-specific treatment content are depicted, additional digital content having a variety of exercises adapted to each cognitive condition may be stored in database 1604 or otherwise be accessible to assessment server 1602. For example, treatment content may include physical activities (such as e.g., drawing and/or assembly projects in digital or non-digital formats, physical exercise programs, etc.) which are each tagged with a cognitive condition indicator.

Returning to FIG. 22, at step 2206, the identified or matched treatment content is associated with the requesting user profile. The treatment digital content may then be accessible to the user through a user portal (such as e.g., the student portal 2400 shown in FIG. 24). When the user selects a treatment digital content item, the item is transmitted to and/or displayed at the user's computing device (step 2208). Per steps 2210 and 2212, method 2200 may optionally include tracking of the user's progress through the digital content items and additionally provide reminders and notifications of completion, motivation and rewards, and/or progress to a user such as a student, a teacher, a tutor, a parent, a counselor, a medical professional, etc. For example, notifications of a student's progress can be sent as a communication to a teacher, a parent, and/or a medical professional associated with the user (i.e., the test subject) via the teacher portal 2500, the parent portal 2600, and the medical professional portal 2700, respectively.

It will be appreciated that a similar method may be used for delivery of targeted content to other individuals (i.e., test subjects that do not have identified learning disabilities/psychological impairments). For example, for test subject's having a “gifted” assessed cognitive ability level, educational or training content designed or configured for gifted students may be matched to a user profile, associated to the user profile, and transmitted and displayed in the user portal. Further, progress of the user through the content may be tracked and notifications/reminders can be sent to a computing device of the user (i.e., the test subject/student) and/or another computing device of a user associated with the test subject (e.g., a parent, a teacher, etc.).

### Provision of Targeted Resource and Referral Content

An exemplary method 2300 for providing targeted resource and referral content (e.g., resource and referral digital content specific to a user's cognitive conditions) is shown in FIG. 23. In some examples, the method 2300 is initiated in response to a request for resource and referral content from a user (e.g., a student, a parent, a teacher, a medical professional, etc.).

Specifically, the user may request resource and referral content related to one or more learning disabilities, neurobehavioral disorders, psychological factors, psychological impairments or disorders, and/or social emotional functioning disabilities. Alternatively, the method 2300 may automatically be carried out after completion of cognitive ability assessment (such as e.g., cognitive ability assessment via method 2000).

At step 2302, the assessment server 1602 accesses a user profile stored in database 1604 to obtain identified cognitive conditions associated with the user and/or other user information (e.g., age, grade-level, linked medical professional ID, etc.). At step 2304, method 2300 includes matching (e.g., searching and identification) of resource and referral content for content that includes resources (e.g., scholarly articles, websites, data from clinical studies, treatment recommendations, etc.) and referrals (e.g., referrals to healthcare practitioners or healthcare facilities) for one or more cognitive conditions such as, e.g., those shown in Appendix II and discussed elsewhere herein. Further, the resource and referral content may additionally be related to other user information, such as, e.g., age group, grade-level, gender etc.

In order to perform matching of resource and referral content to a user's identified cognitive conditions and other user information, database 1604 stores and searches resource and referral digital content. For example, the search may include a look-up table or analysis algorithm for identifying and delivering targeted resource and referral digital content. Additionally, or alternatively, assessment server 1602 may have searchable access to other resource and referral digital content such as, for example, digital content stored in other databases, digital content accessible via the Internet or other controlled or uncontrolled networks, etc.

At step 2306, the identified or matched resource and referral digital content is associated with the requesting user profile. The resource and referral digital content may then be accessible to the user through a user portal (such as e.g., the student portal 2400 shown in FIG. 24). When the user selects a resource and referral digital content item, the item is transmitted to and/or displayed at the user's computing device (step 2308). Per step 2310, method 2300 may optionally include automatically providing notifications to a user (such as e.g., a student, a teacher, a tutor, a parent, a counselor, a medical professional, etc.) as new resource and referral content related to the test subject/user becomes available. For example, notifications of newly available resource and referral content can be sent as a communication to a test subject/user, a teacher, a parent, and/or a medical professional associated with the user (i.e., the test subject) via the student portal 2400, the teacher portal 2500, the parent portal 2600, and the medical professional portal 2700, respectively. Further, per step 2312, method 2300 may optionally include enabling direct communication to referred healthcare practitioners and/or healthcare facilities, such as e.g., communication through a user portal. Examples of recommended therapies (e.g., neurotherapy, prescription and non-prescription medication, cognitive behavior therapy, and/or other innovative therapies) that can be recommended via method 2300 are shown in Appendix IV.

In some examples, resource and referral content can be intervention and treatment plan content implemented via assessment server 1602. In such examples, method 2300 can optionally include automatically tracking progress of the user (e.g., student) through the intervention and treatment plan and/or provide notifications of progress to the user or another individual associated with the user (e.g., a parent, a healthcare practitioner, etc.).

It will be appreciated that the above described system, apparatus, and methods may address many of the issues identified with prior techniques for cognitive ability level and/or learning disability/psychological impairment assessment. Further, particularly with implementation of targeted treatment content and targeted resource and referral content, the above described system, apparatus, and methods may have significant and broad-reaching impact on improving the quality of education and mental healthcare that students receive.

### Exemplary Learning Style Assessment System

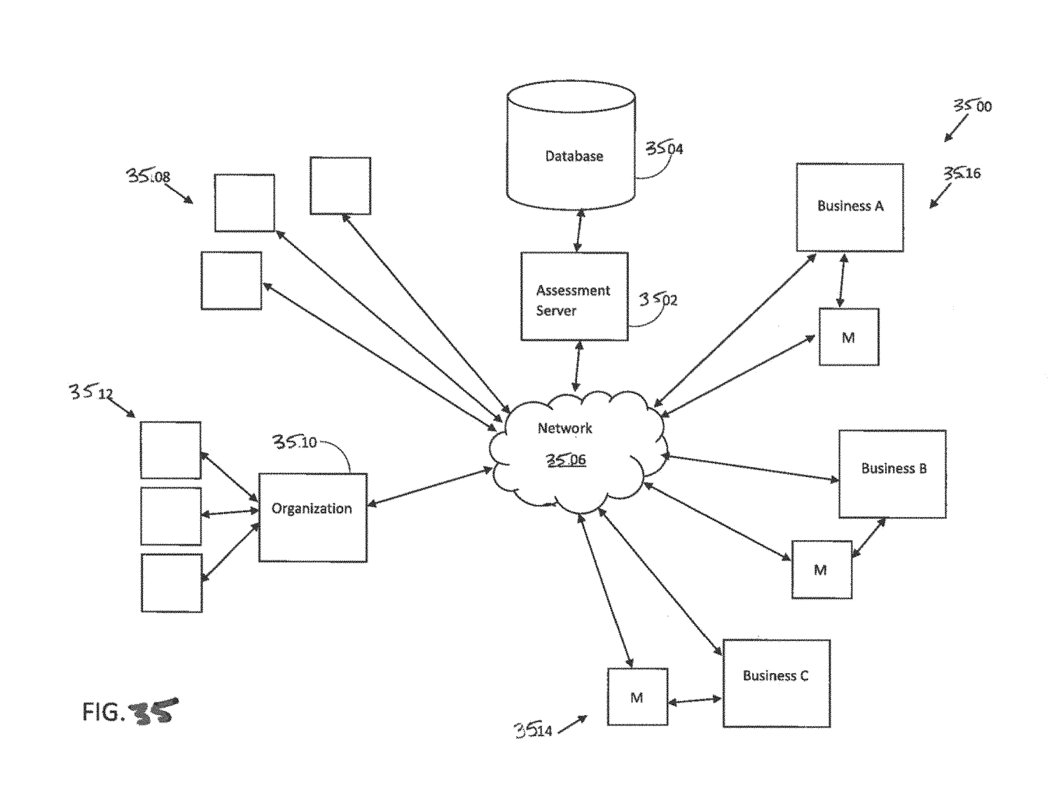

FIG. 35 illustrates an exemplary embodiment of a system 3500 for provision of learning style preference assessment. As depicted in FIG. 35, the system includes an assessment server 3502 that is in data communication with both a database 3504 through a first network interface as well as a network 3506 (e.g., the Internet) through a second network interface. In the illustrated embodiment, the assessment server 3502 is accessible to various user computing devices 3508, 3512, 3514, 3516 via the network 3506, although it is readily appreciated that various ones of the user computing devices can be locally connected to the assessment server. Although the database 3504 is illustrated as being in data communication with the assessment server 3502 locally via the first network interface, it is readily appreciated that the database may be accessed via the network 3506 in alternative embodiments. Moreover, in so-called distributed database embodiments, multiple databases can be placed in data communication with the assessment server 3502 locally and/or via network 3506.

The aforementioned user computing devices include in the illustrated embodiment home computing devices 3508, a centralized student organization computing server 3510 in data communication with user accessible computing devices 3512, manager computing devices 3514, and business computing devices 3516. While a specific topology is illustrated, it is appreciated that various aspects of the illustrated topology could be readily changed. For example, computing servers (not shown) may be implemented between various ones of the computing devices 3508, 3514, 3516 or various computing devices can be implemented with combined functionality (e.g., a computing device may function as both a manager computing device as well as a business computing device, etc.). In another example, various one of the computing devices may alternatively be in data communication with external databases directly (i.e., without having to go through the assessment server 3502) via the network 3506. These and other variants would be readily appreciated by one of ordinary skill given the contents of the present disclosure.

### Exemplary Learning Style Preference Assessment Server

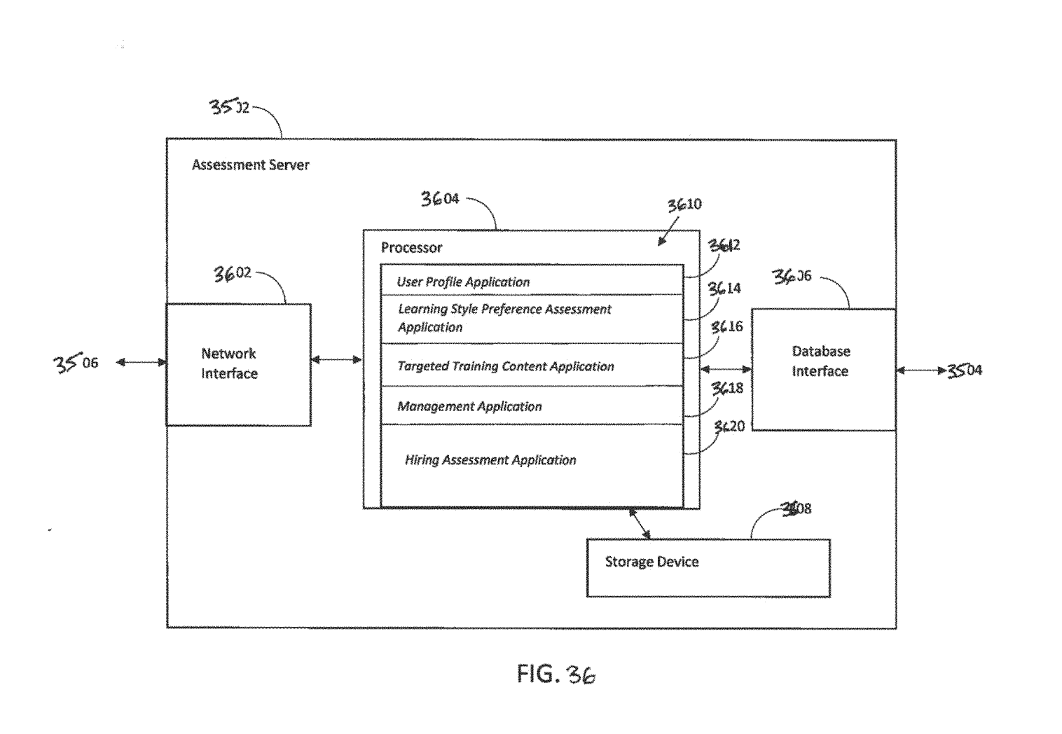

FIG. 36 depicts one exemplary embodiment of an assessment server 3502 for use in learning style preference assessment. As depicted, the server 3502 generally comprises a network interface 3602, a processing apparatus 3604, a database network interface 3606, and a storage device 3608. The network interface 3602 enables communication with the network 3506 illustrated in FIG. 35, while database network interface 3606 enables communication with database 3504 illustrated in FIG. 35. In an alternative embodiment, the database 3504 can be an internal component of the assessment server (such as consisting of storage device 3608). In yet another alternative embodiment, database network interface 3606 may be obviated altogether and access to database 3504 may occur via network interface 3602. The processing apparatus 3604 is configured to execute various applications 3610 thereon to carry out various functions for the assessment server 3502. In the illustrated embodiment, applications 3610 include a user profile application 3612, a learning style preference assessment application 3614, targeted training content application 3616, management application 3618, and hiring assessment application 3620. The aforementioned applications can be stored on storage device 3608, the database 3504 or a combination of both.

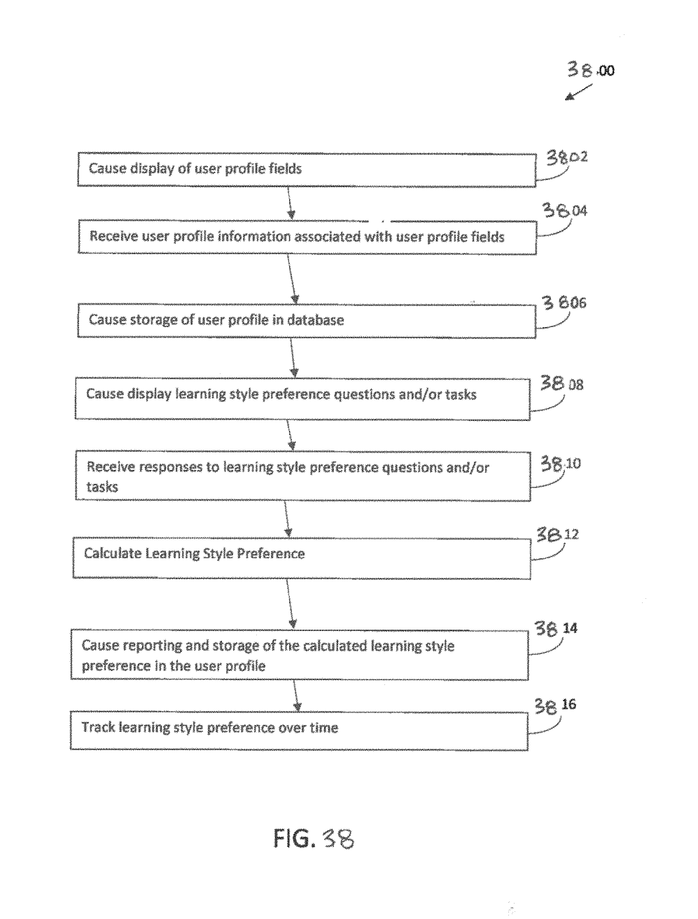

The user profile application 3612 enables collection of user information, such as a user's personal information, to create a user profile consisting of, for example, a new hire candidate profile, an employee profile, a manager profile, a business entity profile, etc. along with a stored identity associated with the user (e.g., a unique encoded identity). The aforementioned user information may include name, address, identity number, career goals, academic experience, professional experience, contact information, etc. Behavioral records, certifications, and test scores can be associated and stored within the user profile application. Moreover, based on the received user information, the user profile application 3612 can generate a user portal (e.g., a new hire candidate portal, an employee portal, a manager portal, a business entity portal, etc.) in a graphical user interface (GUI) on a computing device of the user. One exemplary method for generating and utilizing the user profile application 3612 is shown and discussed with reference to FIG. 38, while exemplary user portals are depicted in FIGS. 47, 48, and 49 described subsequently herein.

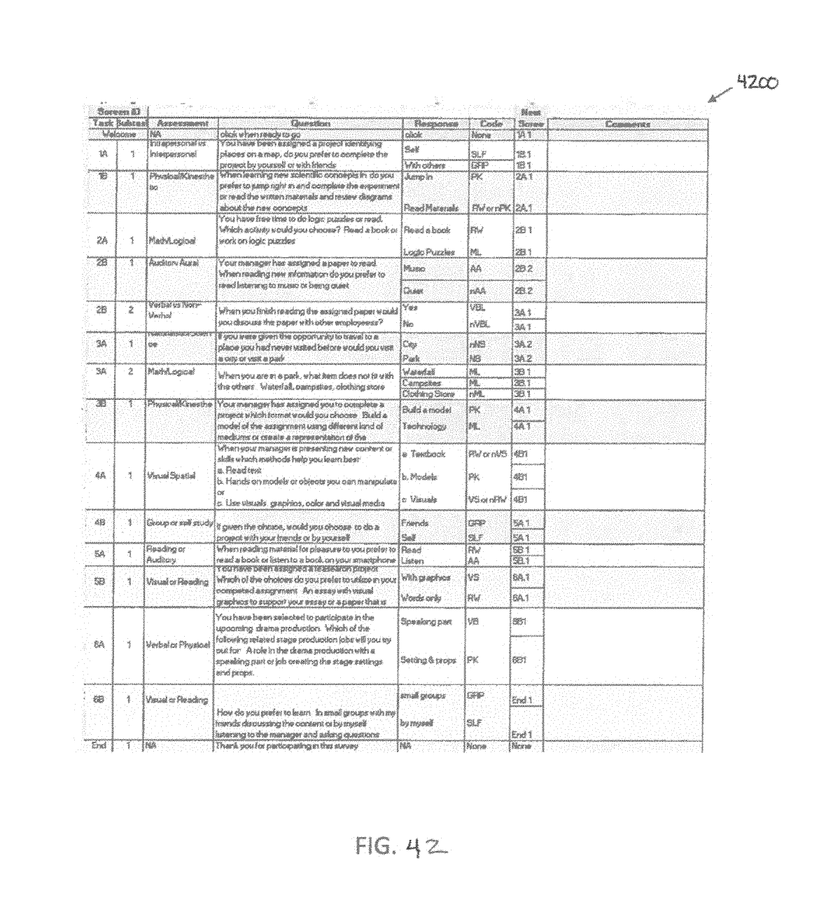

The learning style preference assessment application 3614 enables testing of an individual to determine a preferred learning style. For example, a series of questions and/or tasks having two or more selectable and/or fill-in answers is provided to the individual. In yet another example, multi-sensory assessment is performed via the inclusion of visual (i.e., displayed information), touch (e.g., via the use of touch pads, etc.) and/or auditory cues (e.g., music, etc.) provided by way of the computing device. In addition, the series of questions and/or tasks can take the form of pictures and/or video having two or more selectable responses for the provided pictures and/or video. In addition to receiving the aforementioned selection/response, in one or more implementations, the learning style assessment application may record and analyze “eye tracking” of the test subject in determining/calculating an outcome. Thus, in examples which record and assess eye tracking, the user computing device is in data communication with an eye tracking device such as e.g., an eye wear article or a detection device (e.g., video camera) directed towards the test subject's eyes. In alternate embodiments, eye tracking may be excluded from assessment. Each of the questions and/or tasks may be configured to test for various aspects of a given user's preferred learning style such as learning modalities (e.g., physical/kinesthetic, non-physical/kinesthetic, auditory/aural, non-auditory/aural, naturalistic/science, non-naturalistic/science, math/logic, non-math/logic, visual/spatial, non-visual/spatial, reading/writing, non-reading/writing, etc.), social interactions (e.g., group-oriented, self-oriented, etc.), and/or methods of expression (e.g., verbal/linguistic, non-verbal/linguistic, etc.). Based on the selections and/or responses received from the individual, the learning style preference assessment application 3614 determines a preferred learning style for the individual. The result of the learning style preference assessment is then stored within that user's user profile. Additionally, the execution of the learning style preference assessment application can be repeated over time in order to identify consistency, changes, and/or patterns in learning style preference for a given individual. For example, the learning style assessment application may be executed at regular intervals such as weekly, monthly, quarterly, bi-annually, annually, etc. One exemplary method for the learning style preference assessment application 3614 is shown and described subsequently herein with reference to FIG. 38, while example questions/tasks and learning style preferences/codes are depicted in FIGS. 42-44.

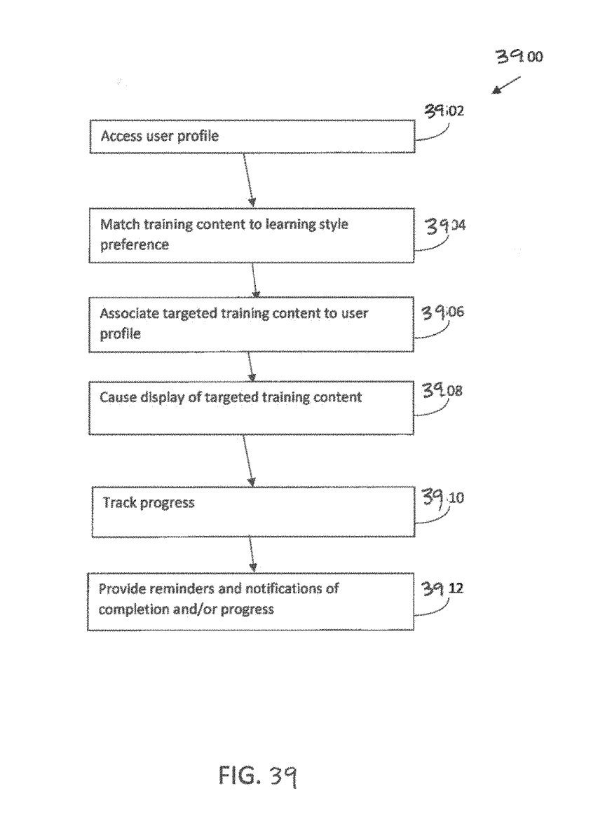

The targeted training content application 3616 enables the matching of content (e.g., safety procedure content, business entity policy content, equipment usage content, etc.) to individuals that is specific to the preferred learning style for each individual as determined, for example, via the learning style preference assessment application 3614. For example, database 3504 may store training digital content in a variety of formats that are designed for and/or facilitate learning in each of the various preferred learning styles. In one example, each of the training content items is encoded with a tag to identify and/or associate the content item with one or more of the preferred learning styles (e.g., learning style preference codes). A look-up table or analysis algorithm for identifying and delivering learning style-specific training content to individuals is used to match content to each individual and provide the content to the individual such as, for example, through a user portal accessible through a GUI of a computing device. Additionally, training content may be tangible content, such as DVDs, CDs, portable storage media, etc., which may be delivered to the user via a non-digital mechanism (e.g., postal delivery, in-store purchase, etc.). In such examples, database 3504 includes inventory data that includes categorization and/or codes (e.g., tags) associating each of the tangible content items with one or more of the preferred learning styles for a given individual. Orders for delivery can be automatically generated based on the learning style preference code of the individual and/or a user facilitated request for this tangible content. One exemplary method of providing targeted training content is shown and discussed with reference to FIG. 39 described subsequently herein, while examples of training content are depicted in FIGS. 45-46.

The management application 3618 enables provision of learning style preference-specific management content to an individual such as, for example, a human resources manager, a mentor, a third-party coach (e.g., a GenTree coach), a supervisor, etc. Additionally, management application 3618 enables training (e.g., certification) as well as generation of compiled (e.g., combined) learning style preferences for both: (1) a manager, coach, mentor, etc.; and (2) an employee or prospective employee, based on the results of their respective learning style preference assessment. For example, prior to execution of the management application 3618, a manager profile is created (via the user profile application 3612) and/or a learning style preference of a manager may be determined (via the learning style preference assessment application 3614). In other words, user profiles generated via the learning style preference assessment application 3614 for both, for example, an employee and a manager can be matched based on data stored in their respective user profiles. The management application 3618 then provides management training content to the manager via a manager portal. The management application 3618 may include tracking of progress through the management training content and a certification of completion of the training, which may be stored in the manager's user profile.

In another exemplary embodiment, the management application 3618 provides learning style preference-specific management content via the manager portal. In one example, the learning style preference-specific management content is based on the learning style preference of the employee. In another example, learning style preference-specific management content is based on a compiled learning style preference, which is selected based upon a combination of the manager learning style preference and the employee learning style preference as determined by their respective user profiles.

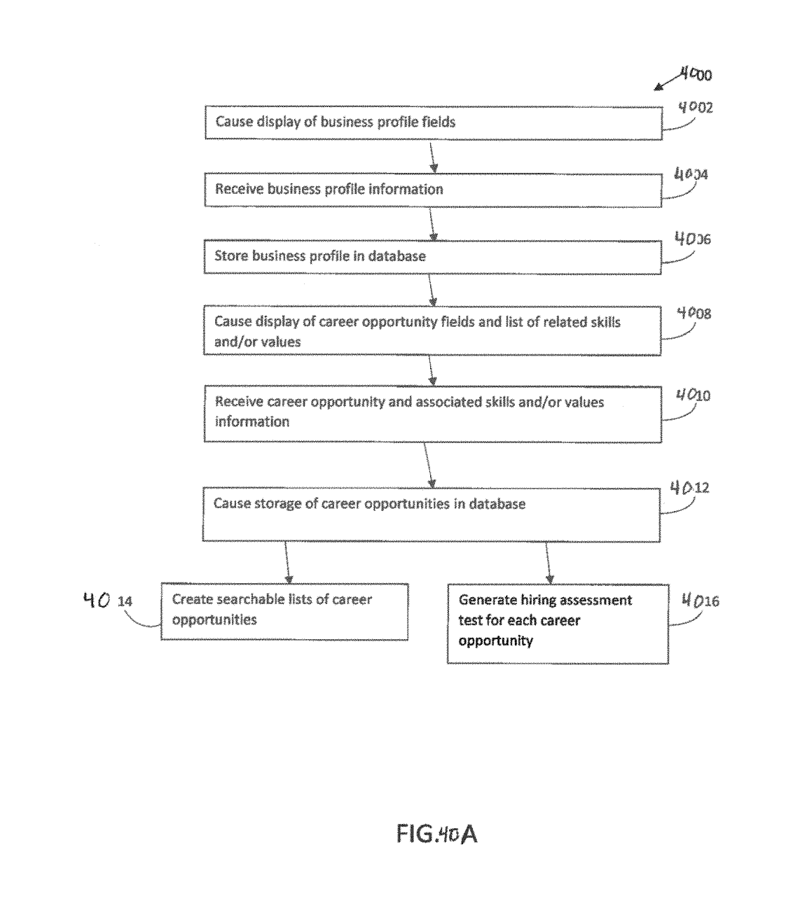

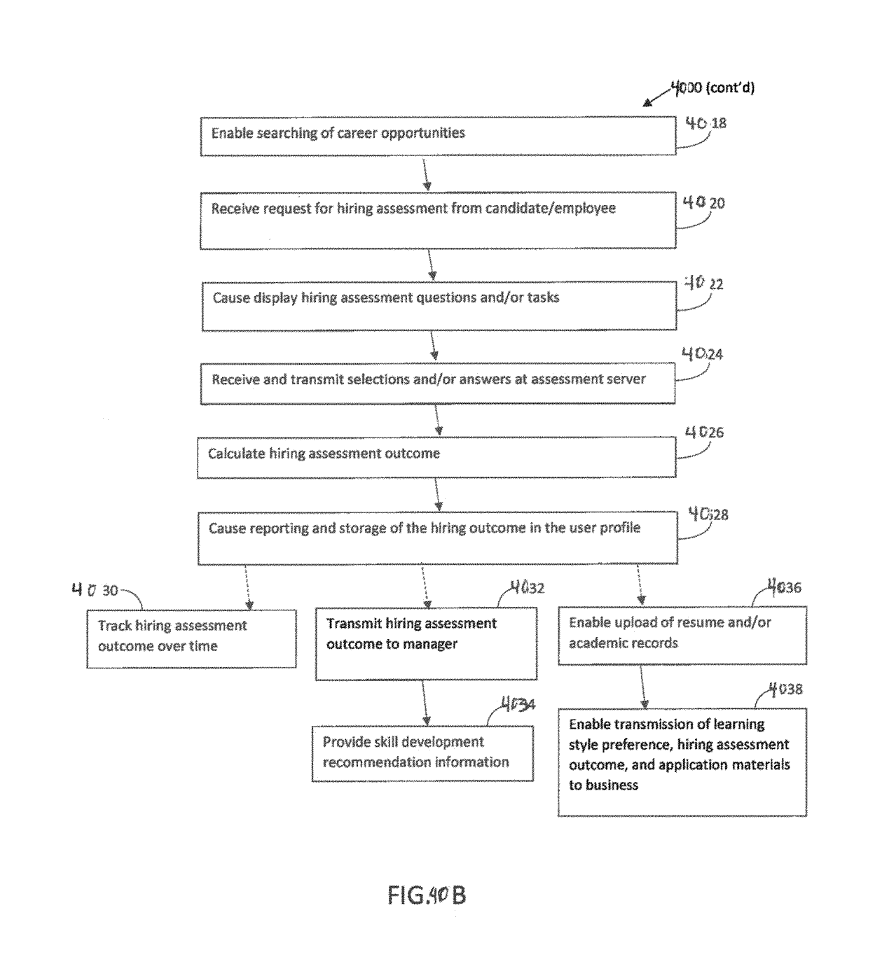

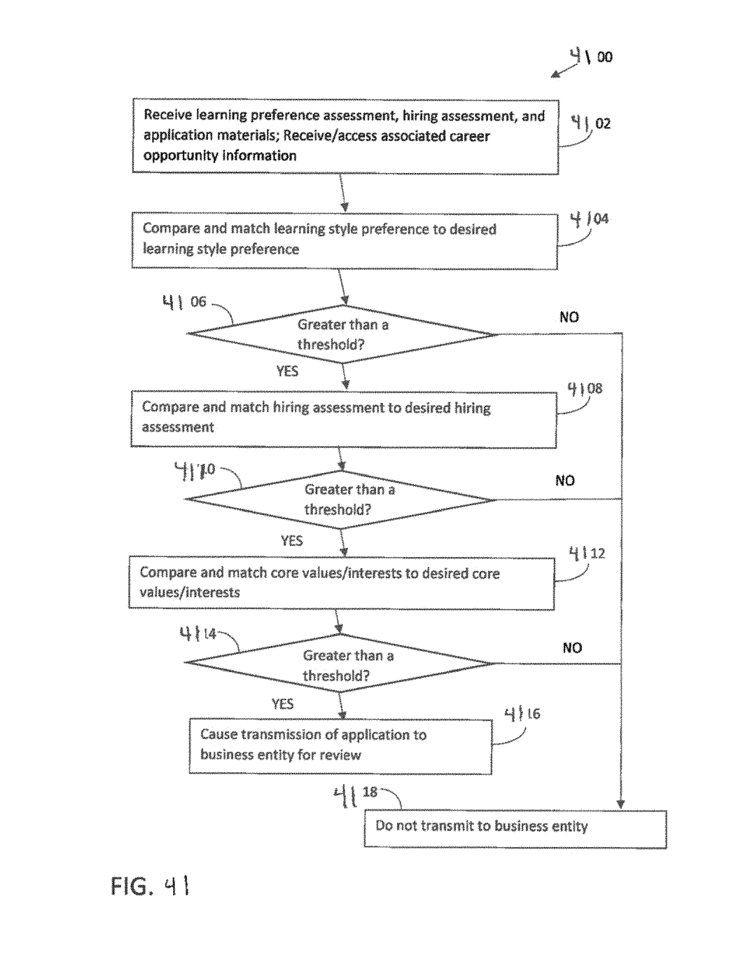

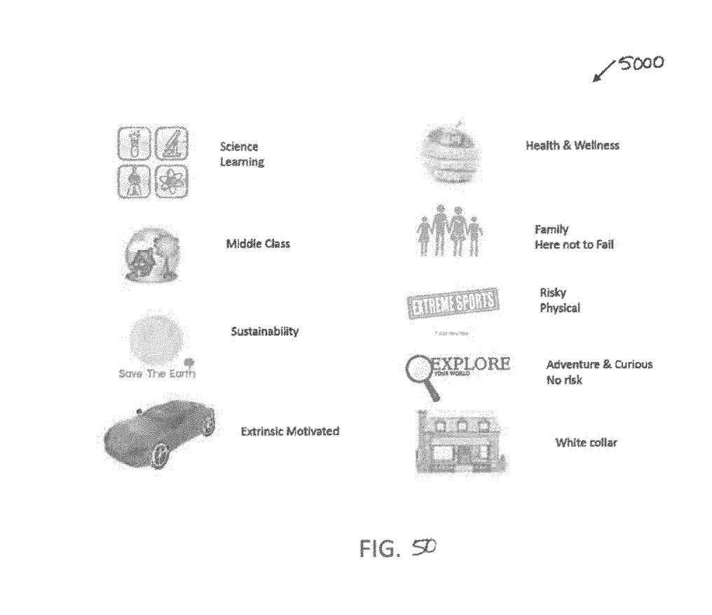

The hiring assessment application 3620 enables testing of an individual to determine an aptitude for selected executive functioning skills, knowledge-based skills, core values, and/or interests. Additionally, the hiring assessment application 3620 enables an individual to submit an application to a business and enables automatic pre-screening of applications. In one exemplary embodiment, a series of questions and/or tasks is provided to the individual. Each of the questions and/or tasks may be configured to test for various aspects of a new hire candidate or an employee's skills such as testing of an individual's executive functioning skills and/or their respective knowledge of relevant subject matter for a given business, job opening, technology area, etc. In one variant, executive functioning and/or knowledge based skills which are applicable to a specific field of study and/or professional career are pre-identified by a business. Thus, a new hire candidate or an employee may be assessed for suitability for a job by submitting questions and/or tasks that can be presented to the individual in a format specific to his/her learning style preference. Based on the selections and/or responses received from the individual, the hiring assessment application 3620 calculates a hiring assessment score and/or result for the individual using a hiring assessment analysis algorithm. The hiring assessment score and/or result may then be encoded and stored within that user's user profile. Further, hiring assessment may be repeated over time for each individual using the hiring assessment application 3620 to identify changes in the hiring assessment score and/or result. These changes over time may then be utilized in conjunction with a hiring assessment score and/or result, in order to help assess the individual's aptitude for a given career choice. The hiring assessment results and/or score can be submitted by a new hire candidate or an employee via, for example, a user portal as a portion of an application to a business. Further, the individual may upload and send academic records, learning style preference, and/or other application materials directly to a prospective employer, etc. using the assessment server. One exemplary methodology for using the hiring assessment application 3620 is shown and discussed with reference to FIGS. 40A-40B and 41, while examples of selectable core values are depicted in FIG. 50.

### Methods

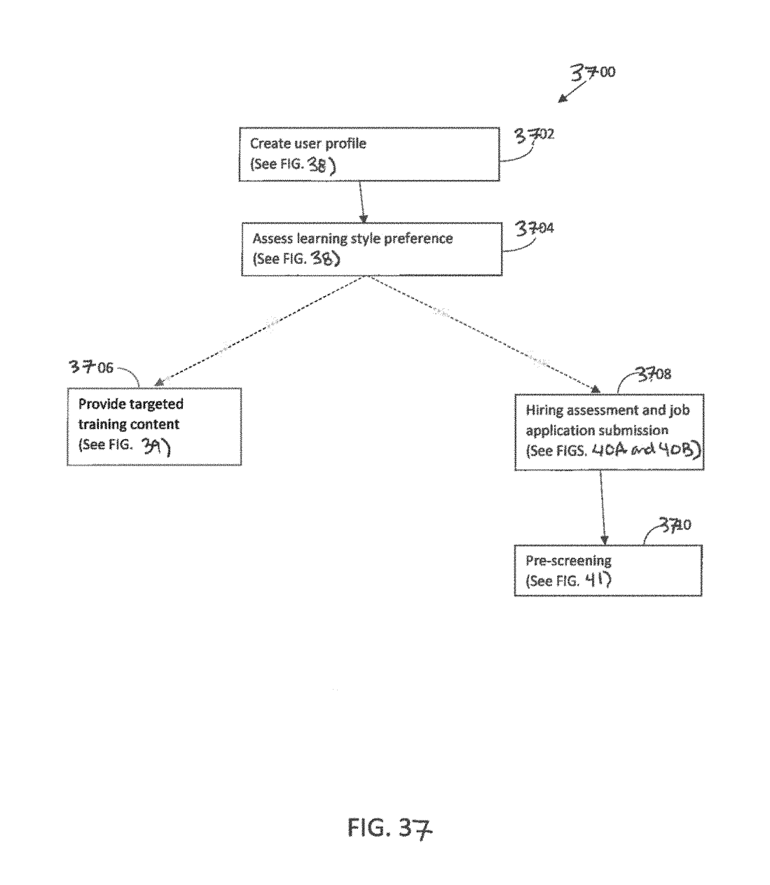

Referring now to FIG. 37 an exemplary methodology 3700 for utilizing the various applications contained with the assessment server are illustrated for purposes of facilitating the overall understanding and use of the methodologies described herein. At step 3702, a user profile is initially created using, for example, the user profile application 3612. Next, at step 3704, a learning style preference of a user is assessed using, for example, the learning style preference assessment application 3614 and the calculated learning style preference is stored in the user profile. After determining and storing the preferred learning style, the method optionally includes: (i) providing targeted training content using the targeted training content application 3616 at step 3706; and (ii) providing hiring assessment and/or job application submission and pre-screening methodologies using the hiring assessment application 3620 at steps 3708 and 3710.

### Learning Style Preference Assessment

An exemplary methodology 3800 for creating a user profile and assessing learning style preference over time is shown in FIG. 38. At step 3802, various user profile data entry fields are displayed to a user in order to facilitate collection of user information. For example, the data entry fields are displayed on a graphical user interface (GUI) on a user's computing device. These various user profile data entry fields include, for example, name of the user, age of the user, current or prior addresses, user identity number, user's career goals, user's academic experience, user's professional experience, etc. Additionally, or alternatively, prior to the entering of user information, the user may first select or be presented with a user profile type. For example, the user may be a new hire candidate and select or enter new hire criteria to create a new hire candidate profile. In another example, the user may be a current employee and select or enter employee criteria to create an employee profile. In yet another example, the user may be a manager and select or enter manager criteria to create a manager profile. In still another example, the user may be the representative of a business entity and select or enter entity criteria to create an entity profile. In yet another example, the user may be a mentor or third-party coach and select or enter a mentor profile. In any of these examples, a credential and/or password may be required to initiate creation of the user profile.

At step 3804, the user information is entered into the various prompted fields in, for example, the GUI displayed on a user's computing device. Additionally, other user information may be automatically populated such as, for example, the user's existing employment records, the user's academic records, user's behavioral records, certifications, and/or other test scores. The user profile is then saved and stored (such as, for example, storing the user profile in database 3504 illustrated in FIG. 35) at step 3806. Further, the user and/or the system may create a log in ID and/or password for subsequent user access to system 3500.

After creating and storing the user profile, learning style preference assessment may be immediately carried out. Alternatively, the user may save the user profile and log in at a later time to complete the learning style preference assessment. In either example, upon initiation of learning style preference assessment, questions and/or tasks are displayed to the user at step 3808. A series of questions and/or tasks having, for example, fill-in and/or two or more selectable answers is provided to the user. By way of example, one question is displayed to the user and after receiving the user answer the following question is displayed. Further, each of the questions and/or tasks is configured to test for one or more aspects or attributes of a preferred learning style such as learning modalities (e.g., physical/kinesthetic, non-physical/kinesthetic, auditory/aural, non-auditory/aural, naturalistic/science, non-naturalistic/science, math/logic, non-math/logic, visual/spatial, non-visual/spatial, reading/writing, non-reading/writing, etc.), social interactions (e.g., group-oriented, self-oriented, etc.), and/or methods of expression (e.g., verbal/linguistic, non-verbal/linguistic, etc.). The user's selections, answers, and/or responses are transmitted to and received at the assessment server (step 3810), where the learning style preference is calculated (step 3812).

An example table of a series of questions for learning style preference assessment 4200 is shown in FIG. 42, which may be stored in database 3504 and accessible to assessment server 3502. As depicted in FIG. 42, an example assessment table 4200 includes columns for: (i) task identity; (ii) learning style preference assessed via each task; (iii) text for each question; (iv) text for possible responses to each question; (v) learning style preference code results associated with each response; and (v) a next screen code for advancing to the following question. In one or more implementations, the questions contained in, for example, FIG. 42 can be dynamically updated, while the learning style preference codes associated with the questions could remain relatively static. By allowing the questions to be dynamically updated, more accurate assessment of an individual's learning style preference can be obtained. In yet other implementations, a subset of the questions contained within, for example, FIG. 42 can be selected for display based upon, for example, the age of the user, determined developmental ability of the user, etc. These and other variants would be readily apparent to one of ordinary skill given the contents of the present disclosure.

In one example, as indicated in table 4200, Task 1A is configured to determine whether an individual's learning style preference includes a preference for intrapersonal or interpersonal study. In order to carry out the assessment for Task 1A, the text “You have been assigned a project identifying places on a map. Do you prefer to complete the project by yourself or with friends?” is displayed on the GUI along with selectable answers “Self” and “With others”. If the user selects “Self”, the selection is recorded and the learning style preference code “SLF” is associated with Task 1A. Alternatively, if the user selects “With others”, the selection is recorded and the learning style preference code “GRP” is associated with Task 1A.

In another example, also indicated in table 4200, Task 1B is configured to determine whether an individual's learning style preference includes a preference for physical or kinesthetic study. In order to carry out the assessment task 1B, the text “When learning new concepts in science class do you prefer to jump right in and complete the experiment or read the written materials and review diagrams about the new concepts?” is displayed on the GUI along with selectable answers “Jump in” and “Read materials”. If the user selects “Jump in”, the selection is recorded and the learning style preference code “PK” is associated with Task 1B. Alternatively, if the user selects “Read materials”, the selection is recorded and the learning style preference code “RW” or “nPK” is associated with Task 1B.

Upon completion of answering each question, the results associated with each task (i.e., Tasks 1A-6B) are transmitted to the assessment server 3502 where the learning style preference for the user is calculated (such as, e.g., the via learning style preference assessment application 3614 and/or via the analysis algorithm configured to determine and calculate the learning style areas of strength and weakness). It will be appreciated that the table of questions for learning style preference assessment shown in FIG. 42 is merely exemplary and other implementations may include differing questions and assessments, more or fewer questions and/or tasks for assessment of learning style preference.

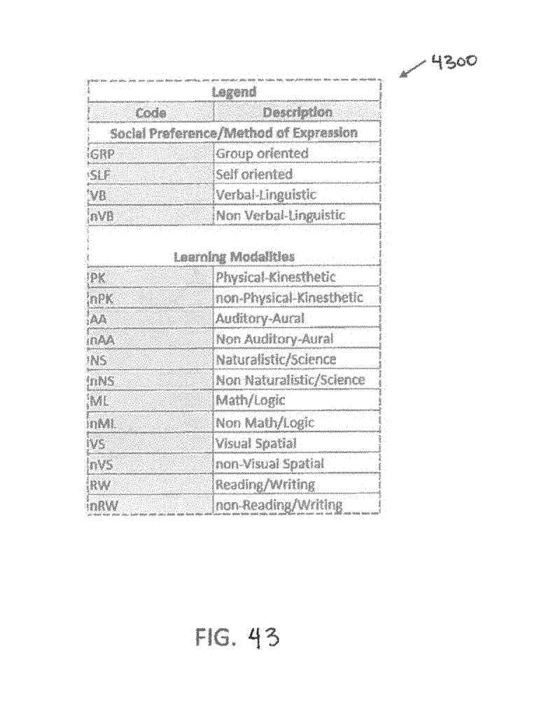

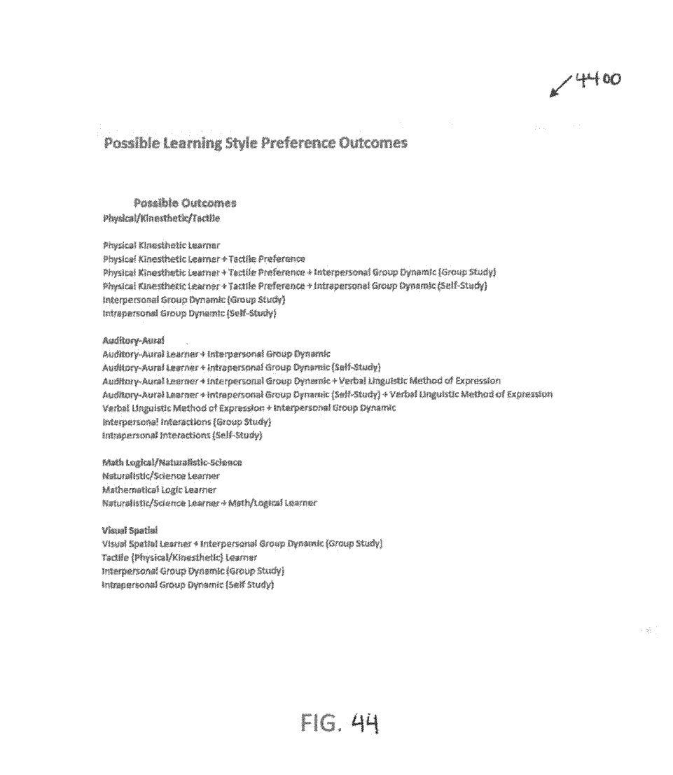

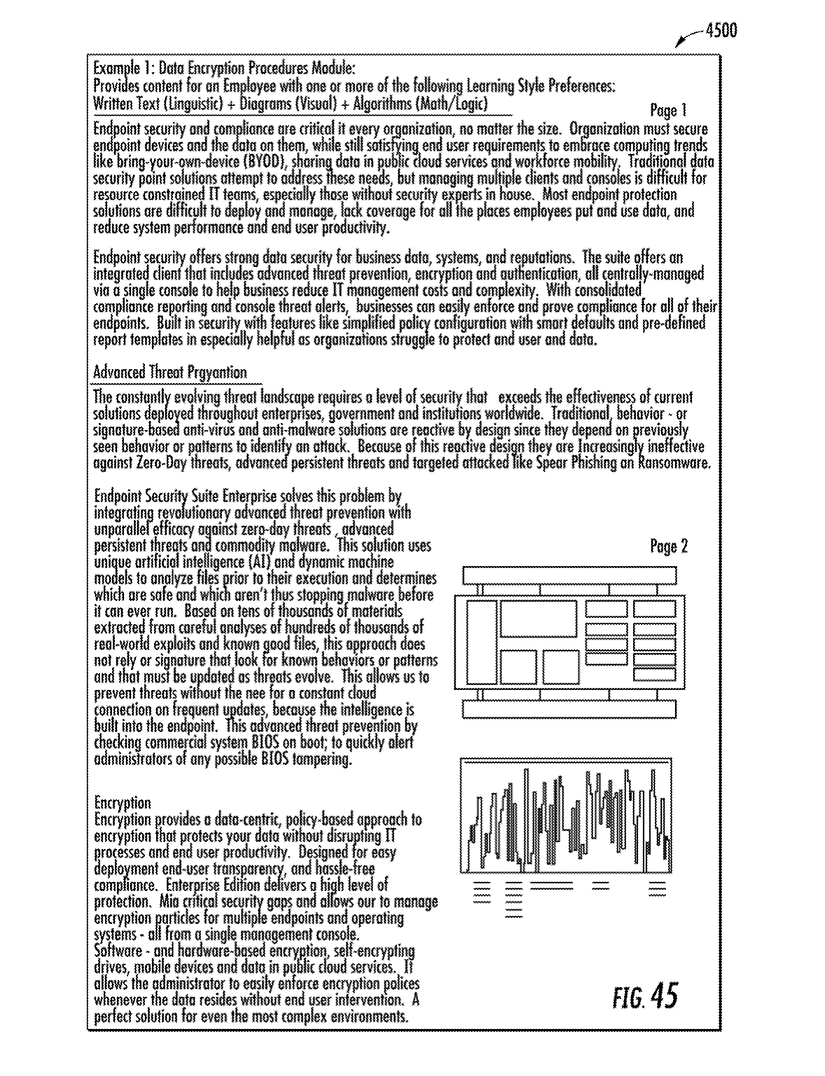

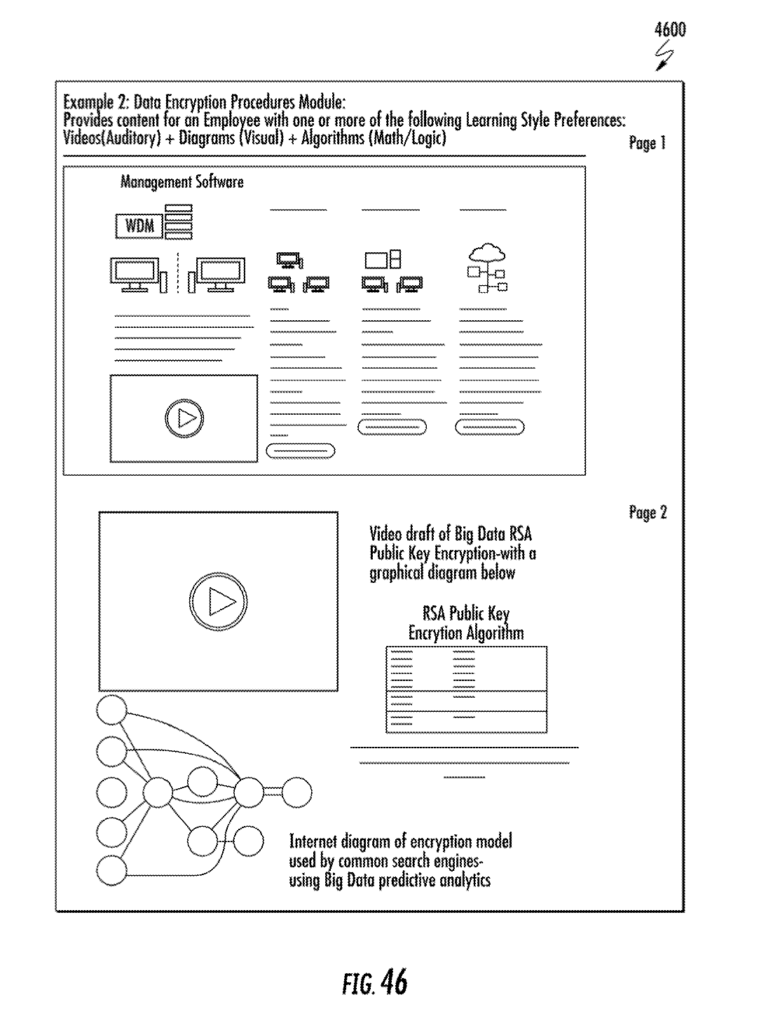

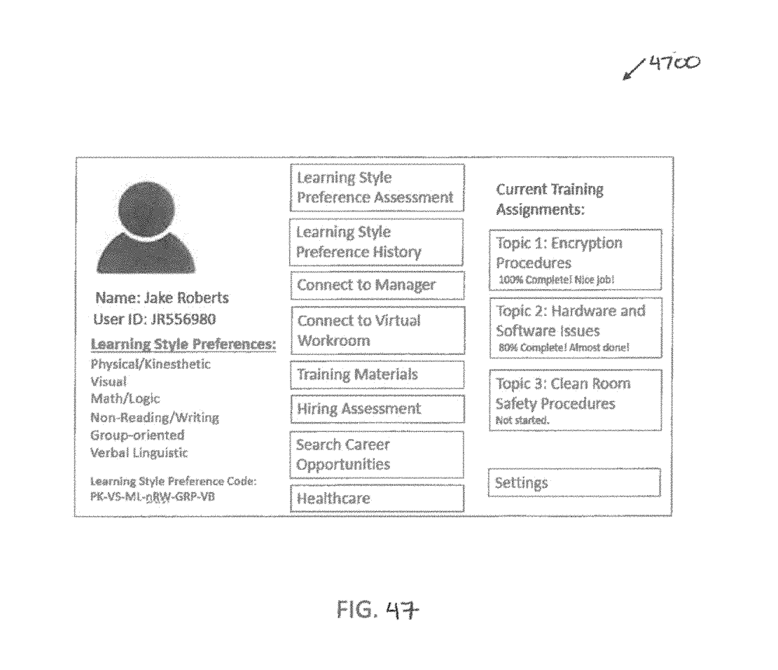

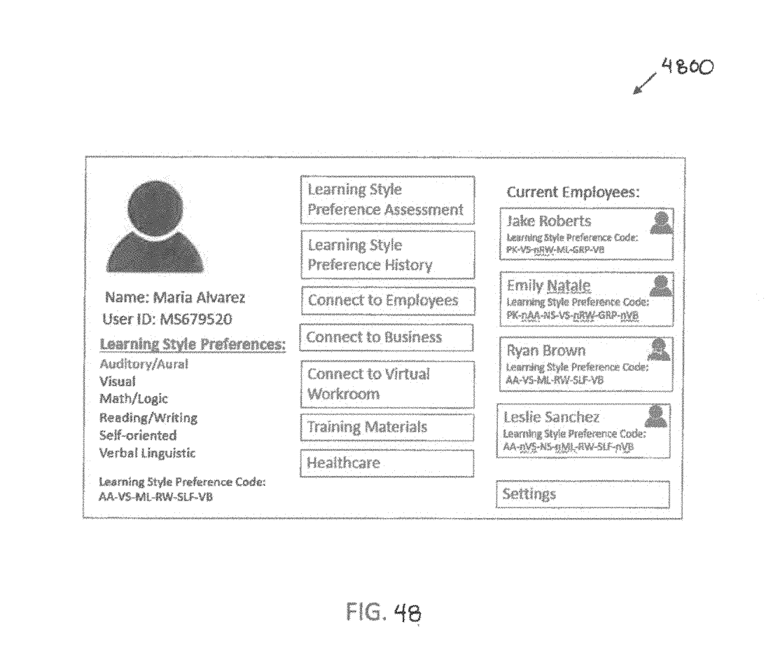

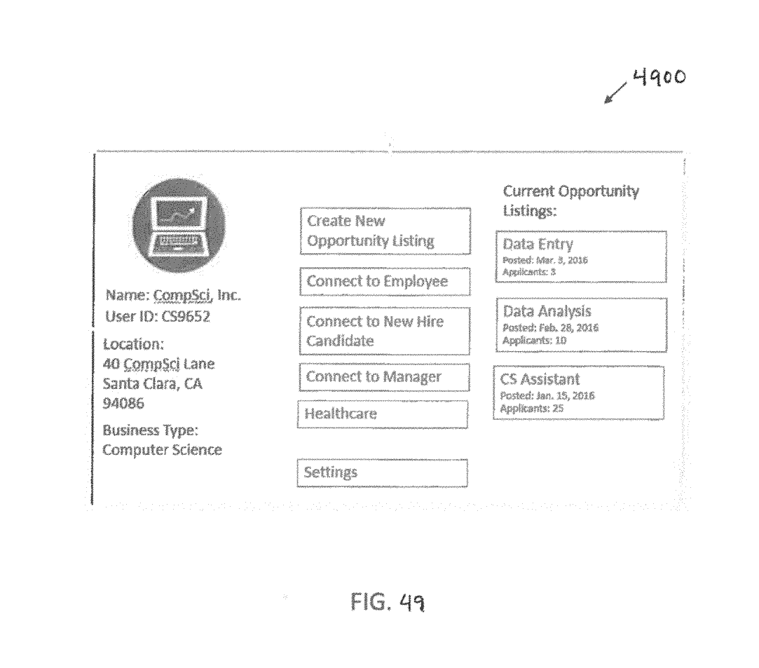

After calculating the encoded user's learning style preference, the encoded learning style preference is translated into a user-readable learning style preference. FIG. 43 shows an example table including a legend 4300 indicating learning style preference codes and the corresponding learning style attributes (e.g., social preferences, methods of expression, and learning modalities), while FIG. 44 shows an example Table 4400 including the various possible learning style preference outcomes that may be associated with the user. Returning to FIG. 38, at step 3814, the calculated learning style preference outcome (e.g., one or more of the learning style preferences shown in FIG. 44) is reported and/or stored in the user profile.

Lastly, at step 3816, learning style preference assessment may optionally be repeated so that a learning style preference of the user is updated over time and stored in the user profile. For example, the preferred learning style of a user may change as the user develops new cognitive skills. Further, changes and/or consistency in learning style preference may be tracked over time to identify patterns, shifts, and/or trends in one individual, multiple individuals, and/or groups of individuals. Moreover, an individual's response to a given content may result in an improvement in other learning style preferences.

### Provision of Targeted Training Content

An exemplary method 3900 for providing targeted training content (i.e., job-related training content specific to a user's learning style preference) is shown in FIG. 39. In some examples, the method 3900 is initiated in response to a request for training content from a user (such as the employee, employer or another third party (e.g., coach or mentor)). Alternatively, the method 3900 may automatically be carried out after completion of the learning style preference assessment and/or after assignment of training content to the user by the business entity.

At step 3902, the assessment server 3502 accesses a user profile stored in database 3504 to obtain the learning style preference associated with the user (e.g., a learning style preference or learning style preference code associated with a user ID). At step 3904, method 3900 includes searching and identification of training content for content that is appropriate and/or designed for one or more specific learning style preferences such as, for example, those listed in table 4400 shown in FIG. 44. In some examples, searching and identification of training content further includes a search for training content that has been assigned to the user by the business entity.

In order to perform matching of training content to a user's learning style preference, database 3504 stores and searches training content in multiple formats for a variety of job-related subject matter (e.g., safety, equipment usage, company policies, procedural information, etc.). For example, the search may include a look-up table or analysis algorithm for identifying and delivering learning style-specific training content. Additionally, or alternatively, assessment server 3502 may have searchable access to other training content such as, for example, content stored in other databases, content accessible via the Internet or other controlled or uncontrolled networks, etc.

FIGS. 45 and 46 show two examples of targeted training content that may be searched and identified in step 3904. Specifically, FIG. 45 shows an example of digital content 4500 for the topic of “Data Encryption Procedures”, which is tagged with a learning style preference indicator including the following learning style preferences: Linguistic, Visual, and/or Math/Logic. As depicted in FIG. 45, digital content 4500 includes primarily written text and additionally includes a schematic diagram and a graph. Thus, digital content 4500 is adapted for a user with a learning style preference including linguistic, visual, and/or math/logic attributes who optimally learns subject matter that is in a written format, that can be perceived with the eye, and/or that is presented in a logical manner.

FIG. 46 shows an alternate example of digital content 4600 for the topic of “Data Encryption Procedures”, which is tagged with a learning style preference indicator including the following learning style preferences: Auditory, Visual, and/or Math/Logic. As depicted in FIG. 46, digital content 4600 includes primarily video and audio content, and additionally includes a diagram with short written descriptions. Thus, digital content 4600 is adapted for a user with a learning style preference including auditory, visual, and/or math/logic attributes who optimally learns subject matter that is in an audio format, that can be perceived with the ear, and/or that is presented in a logical manner.

Although only two examples of digital training content formats are depicted, additional digital content having a variety of formats adapted to each learning style preference for various training content topics may be stored in database 3504 or otherwise be accessible to assessment server 3502. For example, training content may include physical activities (such as e.g., sketching and/or assembly projects) which are tagged with a learning style preference indicator of physical/kinesthetic and are adapted for a user with a learning style preference including a physical/kinesthetic attribute.

Returning to FIG. 39, at step 3906, the identified or matched training content is associated with the requesting or assigned user profile. The training content may then be accessible to the user through a user portal (such as e.g., an employee profile/portal 4700 shown in FIG. 47). When the user selects a training content item, the item is transmitted to and/or displayed at the user's computing device (step 3908). Per steps 3910 and 3912, method 3900 may optionally include tracking of the user's progress through the content items and additionally provide reminders and notifications of completion and/or progress to a user such as the employee, a manager, or a business entity representative, etc.

### Hiring Assessment

As described above, system 3500 may additionally enable application of an individual (e.g., a new hire candidate, a current employee, etc.) to a business. An exemplary method 4000 for hiring assessment is shown in FIGS. 40A and 40B. First, at step 4002, business profile fields are displayed at a user computing device (i.e., a computing device of a business representative). Business profile information may include name of the entity, location, links to websites of the entity, logos, descriptions, staff population, demographics, acceptance rates, hiring criteria, etc. An exemplary business entity portal 4900 generated from the user profile information is shown in FIG. 49. Next, the profile information is received by the assessment server 3502 (step 4004) and stored in database 3504 (step 4006).

After creating a profile for the business (i.e., an entity profile), one or more career opportunities may be added, associated, and/or stored with the entity profile. Accordingly, at step 4008, academic and/or professional opportunity fields are displayed such as, for example, title of the opportunity, subject area of the opportunity, dates of applicability, required application materials, other application requirements, contact information for the supervisor, hiring manager, and/or coach or mentor (e.g., a GenTree coach), etc.

Additionally, various desirable skills, knowledge, core values, or traits may be associated with the opportunity. For example, a selectable and/or fillable list of executive functioning skills is displayed. In another example, a selectable and/or fillable list of knowledge-based skills is displayed. In even another example, a selectable and/or fillable list of core values (e.g., personality traits) and/or interests is displayed. A representative of the entity can then fill-in and/or select information for association with the opportunity, which is received and stored at steps 4010 and 4012, respectively. Further, in some examples, the representative can indicate from the list of desired skills and/or core values which of those are required.

In one example, executive functioning skills can include: problem solving, decision making, critical thinking, job task planning, accuracy, and on-time delivery. Further, technology (e.g., computer science) skills can include: identification of parts; identification of uses; demonstration of typing proficiency; use of technology tools to organize, interpret, and display data; publication of digital products; usage of word processing, spreadsheets, databases, and presentation software; usage of digital tools to locate, collect, organize, evaluate, and synthesize information; usage of digital tools to generate new ideas, products, or processes; practice safe uses of social networking and electronic communication; and/or analysis of capabilities and limitations of current and emerging technologies, etc. Furthermore, core values can include: trust, honesty, integrity, character, leadership characteristics, self-reliance, etc. Additional discussion of so-called core values is contained within Appendix A. It will be appreciated that the aforementioned skills/values are merely exemplary and may include fewer or more items. Further, such lists may be created for other types of career opportunities, such as, for example, chemical, engineering, biological, mathematical, retail, or other career opportunities.

Returning to FIG. 40A, the received and stored career opportunities are organized into one or more searchable lists or sub-databases stored in database 3504 (step 4014). Further, career opportunities can be stored in an external database (e.g., the Department of Labor database). In both examples, new hire candidate and/or current employees may then search opportunities by geographic location, type (e.g., full-time, part-time, etc.), subject matter (e.g., computer science, chemistry, microbiology, etc.), name of entity, most recent opportunities, and/or other search criteria.

At step 4016, a hiring assessment test is generated for each career opportunity based on the previously identified executive functioning, knowledge-based skills, and/or core values. In one exemplary embodiment, database 3504 may store questions and/or tasks associated with each selectable executive functioning skill, knowledge-based skill, and/or core value (e.g., including a tag to identify an associated skill or value), thereby allowing the assessment server 3502 to dynamically generate a hiring assessment test specific to the received career opportunity. Additionally, database 3504 can store questions and/or tasks associated with each selectable executive functioning, knowledge-based skill, and/or core value in various formats which are learning style preference-specific.

Thus, in another example, the assessment server 3502 will generate a hiring assessment test specific to both of the received career opportunity and the learning style preference of a requesting individual (e.g., new hire candidate or employee). In this latter example, generating the hiring assessment test will occur after receiving a request from a user (e.g., after step 4020 shown in FIG. 40B). In yet another example, the assessment server 3502 provides a generalized hiring assessment (such as e.g., testing for a broad range of executive functioning skills, knowledge-based skills, core values, and/or interests), which is non-specific in regards to career opportunities. The generalized hiring assessment may be presented to the individual in a format specific to the individual's preferred learning style.

As indicated in FIG. 40B, method 4000 further includes enabling an individual to search the career opportunities and receive a request for hiring assessment associated with one of the career opportunities at steps 4018 and 4020, respectively. Additionally or alternatively, in the example of providing a generalized hiring assessment test, the assessment server 3502 automatically searches and matches career opportunities after the individual has completed assessment of executive functioning skills, knowledge-based skills, core values, and/or interests. In this additional/alternate example, a list of career opportunities that match the individual's skills, values, and/or interests is displayed.

According to the aforementioned examples, in response to receiving the request, the hiring assessment questions and/or tasks are displayed to the user (e.g., the employee or new hire candidate) (step 4022), and the user's selections and/or answers are received and transmitted to the assessment server 3502 (step 4024). In an alternate example, the user can select and/or enter his or her core values and/or interests rather than providing answers to questions and/or tasks. One example of a selectable list of core values and interests 5000 is shown in FIG. 50.

Next, at step 4026, a hiring assessment score is calculated from received selections and/or answers. In some implementations, the score may be calculated as an overall percentage of the hiring assessment test and/or another form of overall score. Additionally, or alternatively, the score may be reported as individual percentages and/or “achieved” and “needs improvement” skills from executive functioning and knowledge-based skills identified in step 4006. The score may then be stored in the user profile (e.g., employee or new hire candidate profile) at step 4028. Further, the core values may additionally be stored in the user profile.

Optionally, at step 4030, hiring assessment scores may be tracked over time after repeated assessment in order to track changes (e.g., improvement) of the individual. Also optionally, at step 4032, for a current employee, the hiring assessment score can be transmitted to a manager or supervisor. Further, management recommendations are provided to the manager to assist the employee in improving his/her hiring assessment score (step 4034). In some examples, the recommendations are specific to the learning style preference of the employee and/or the manager.

In a final option, the user will upload application materials including, for example, his/her resume, academic records, personal essay, cover letter, and/or other application materials to his/her user profile (step 4036) and submit an application to the academic/career opportunity including the uploaded materials, the hiring assessment, the identified core values, the identified interests, and/or the learning style preference (step 4038).

### Pre-Screening

In one exemplary embodiment, the assessment server 3502 may “pre-screen” candidates (i.e., user applications) by limiting transmission of applications or returning a limited list of candidates to the business entity. Thus, the received applications can be limited to those that match specific criteria and/or have a hiring assessment score that is above a pre-determined threshold. An exemplary method for pre-screening applications is shown in FIG. 41.

At step 4102, the learning preference assessment, the hiring assessment, and application materials of a user are received along with the associated career opportunity information for which the user is applying to. Next, it is determined if the information provided by the user applying to the career opportunity is a match to the desired criteria of the business entity.

Specifically, at step 4104, the learning style preference of the user is compared and/or matched to the desired learning style preference. If the learning style preference match is below a pre-determined threshold (e.g., percentage of matching below a threshold, portions indicated as required are not matching, etc.) (step 4106), the user's application is not transmitted to the business entity. Alternatively, if the learning style preference match is above the pre-determined threshold, at step 4108 the user's hiring assessment outcome (e.g., score) is compared to a desired hiring assessment outcome. If the hiring assessment outcome match is below a pre-determined threshold (e.g., percentage of matching below a threshold, portions indicated as required are not matching, etc.) (step 4110), the user's application is not transmitted to the business entity. Alternatively, if the hiring assessment match is above the pre-determined threshold, at step 4112 the user's core values and interests are compared and/or matched to the desired core values and interests. If the core value and interests match is below a pre-determined threshold (e.g., percentage of matching below a threshold, portions indicated as required are not matching, etc.), the user's application is not transmitted to the business entity. Alternatively, if the core values and interests match is above the pre-determined threshold, the user's application is transmitted to the business entity (such as e.g., transmission to an HR manager) for further review.

In examples where the user's application is not transmitted to the business entity, the application may be stored in database 3504 and/or an automatic notification that the user did not meet criteria for the career opportunity may be sent to the user. Further, in other example methods, determination of matching of the information provided by the user applying to the career opportunity to the desired criteria of the business entity may be performed in any desired order (e.g., first hiring assessment match, next core values/interests match, and then learning style preference match, etc.) and/or may be performed substantially simultaneously.

### Exemplary Consumer Preference Assessment and Recommendation System

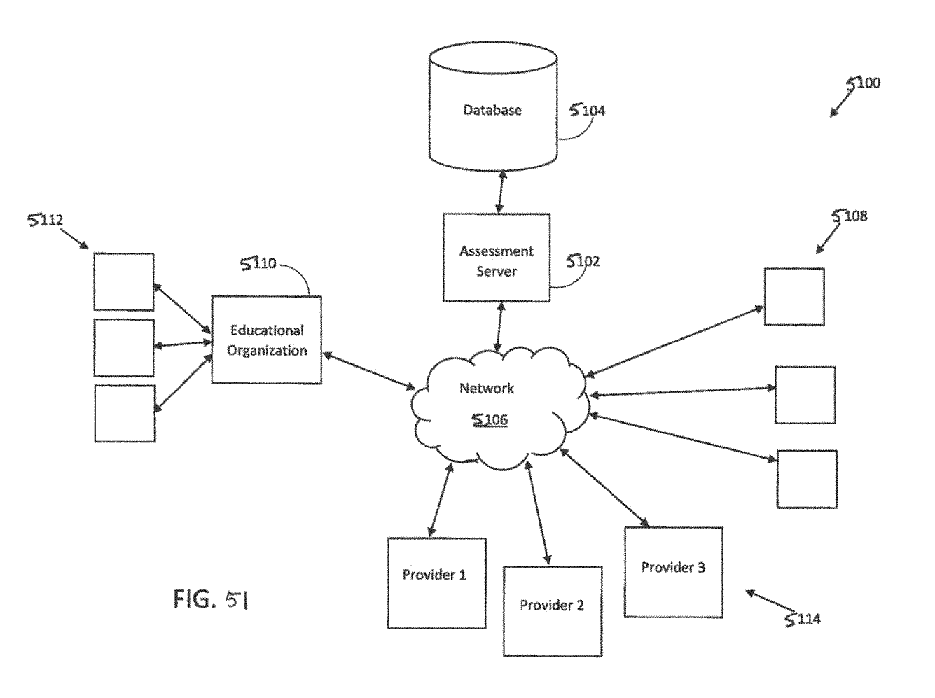

FIG. 51 illustrates an exemplary embodiment of a system 5100 for consumer preference assessment and providing content/product recommendations based thereon. As depicted in FIG. 51, the system 5100 includes an assessment and recommendation server 5102 that is in data communication with a database 5104 through a first network interface as well as a network 5106 (e.g., the Internet) through a second network interface. In the illustrated embodiment, the assessment and recommendation server 5102 is accessible to various user computing devices 5108, 5112, 5114, 5116 via the network 5106, although it is readily appreciated that various ones of the user computing devices can be locally connected to the assessment and recommendation server 5102. Although the database 5104 is illustrated as being in data communication with the assessment and recommendation server 5102 locally via a first network interface, it is readily appreciated that the database may be accessed via the network 5106 in alternative embodiments. Moreover, in so-called distributed database embodiments, multiple databases can be placed in data communication with the assessment and recommendation server 5102 locally and/or via network 5106.

The aforementioned user computing devices include, in the illustrated embodiment, home computing devices 5108, a centralized student organization computing server 5110 in data communication with user accessible computing devices 5112 as well as content provider and product provider computing devices 5114. While a specific topology is illustrated, it is appreciated that various aspects of the illustrated topology could be readily changed. For example, computing servers (not shown) may be implemented between various ones of the computing devices 5108, 5110, 5112, 5114 and various computing devices can be implemented with combined functionality. In addition, the topology could be readily expanded to include other types of computing devices such as, for example, healthcare provider computing devices; caregiver computing devices; business related computing devices; etc. Moreover, various ones of the computing devices may alternatively be in data communication with external databases directly (i.e., without having to go through the assessment and recommendation server 5102) via the network 5106. Moreover, the various assessment and recommendation functions of the assessment and recommendation server 5102 may be distributed across multiple devices. These and other variants would be readily appreciated by one of ordinary skill given the contents of the present disclosure.

### Exemplary Assessment and Recommendation Server

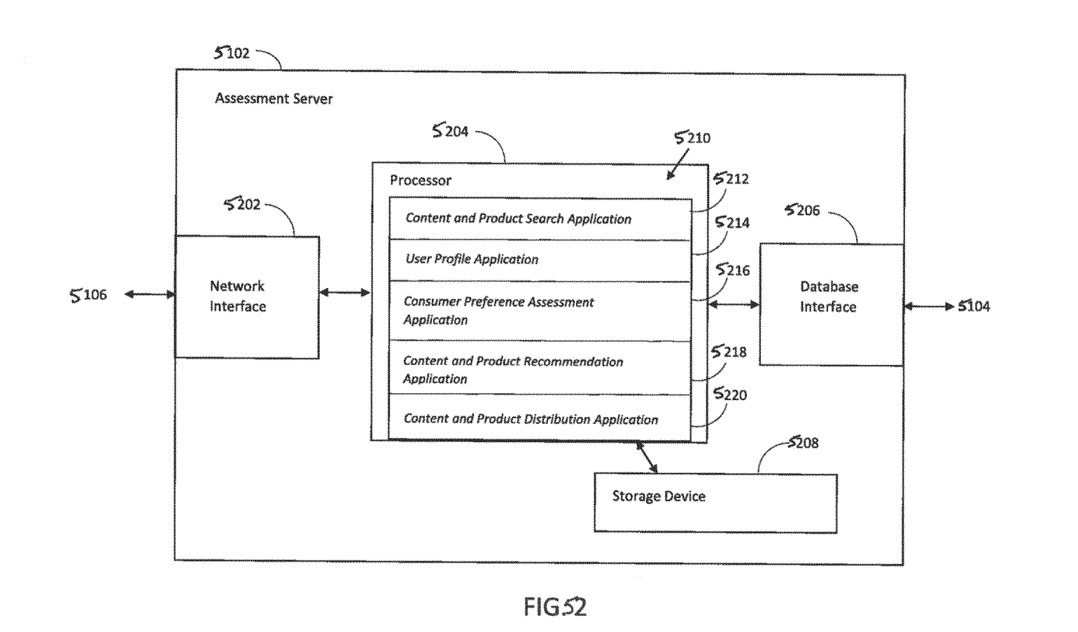

FIG. 52 depicts one exemplary embodiment of an assessment and recommendation server 5102 for use in consumer preference assessment (e.g., learning style preference assessment) and content and/or product recommendation in response thereto. As depicted, the server 5102 generally comprises a network interface 5202, a processing apparatus 5204, a database network interface 5206, and a storage device 5208. The network interface 5202 enables communication with the network 5106 illustrated in FIG. 51, while database network interface 5206 enables communication with the database 5104 illustrated in FIG. 51. In an alternative embodiment, the database 5104 can be an internal component of the assessment and recommendation server (such as consisting of storage device 5208). In yet another alternative embodiment, database network interface 5206 may be obviated altogether and access to database 5104 may occur via, for example, network interface 5202.

The processing apparatus 5204 is configured to execute various applications 5210 thereon to carry out various functions for the assessment and recommendation server 5102. In the illustrated embodiment, these applications 5210 include a content and product search application 5212, a user profile application 5214, a consumer preference assessment application 5216, a content and product recommendation application 5218, and a content and product distribution application 5220. The aforementioned applications can each be stored on one or more of the storage device 5208, database 5104 or combinations of the foregoing.

The content and product search application 5212 enables users to enter search parameters for content (e.g., digital content) and/or for products. For example, these search parameters may take the form of one or more queries that include search terms for the content and/or products of interest. Alternatively, or in addition to these queries, the user can be prompted for selection of categories for products and/or content via drop down menus and the like. Products can include tangible items, such as DVDs, CDs, portable storage media, papers, packets, games, books, models, kits, etc., which may be deliverable via a non-digital mechanism (e.g., postal delivery, other shipment, etc.), as well as intangible items such as, for example, digital content that is otherwise electronically deliverable. In one or more implementations, the available content and product inventory data additionally includes a categorization (e.g., inventory codes) that associate each of the content and/or product items with one or more predetermined consumer preferences via the use of, for example, learning style preference codes and/or other associated metadata (e.g., name, description, format, etc.).

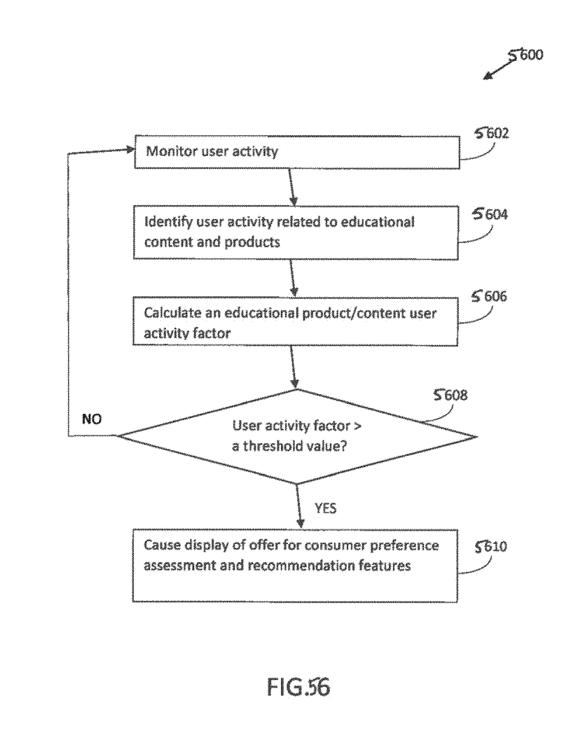

Accordingly, the listing of items provided in response to a user's query will not only include items that match the user's query, but will also be related to, for example, a user's preferred learning style as will be discussed in subsequent detail herein (see, for example, the discussion of the content and product recommendation application 5218 infra). Such content and product recommendations can be selected so as to be consistent with a user's determined consumer preferences or, alternatively, to address deficiencies associated with the user's determined consumer preference. Such product and content listings can be stored at, for example, database 5104, storage device 5208, distributor computing devices 5114, manufacturer databases (not shown) or combinations of the foregoing. After determining relevant matches, one or more lists of available content and/or products related to the user's queries is returned and displayed to the user. Exemplary methodology associated with the content and product search application 5212 is shown and discussed with reference to FIG. 56 infra.

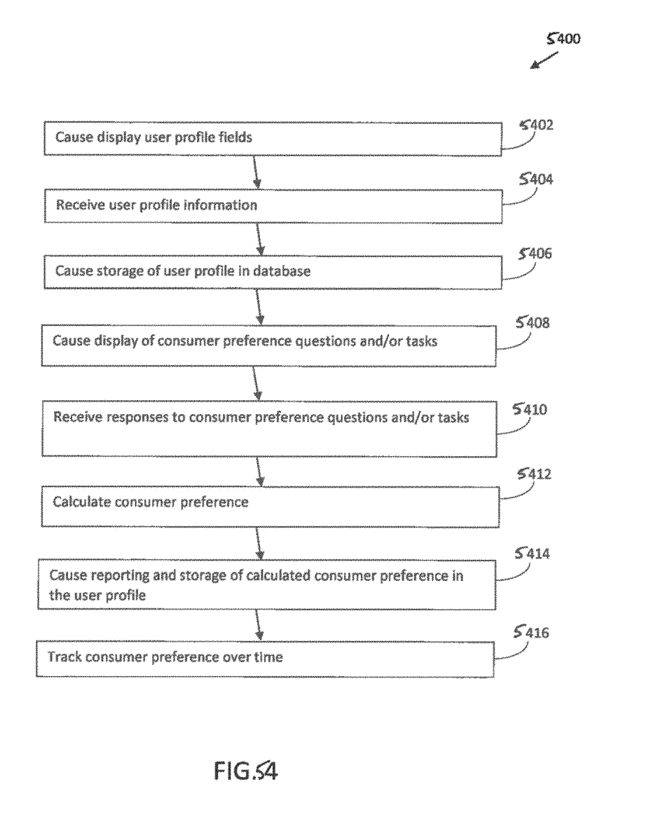

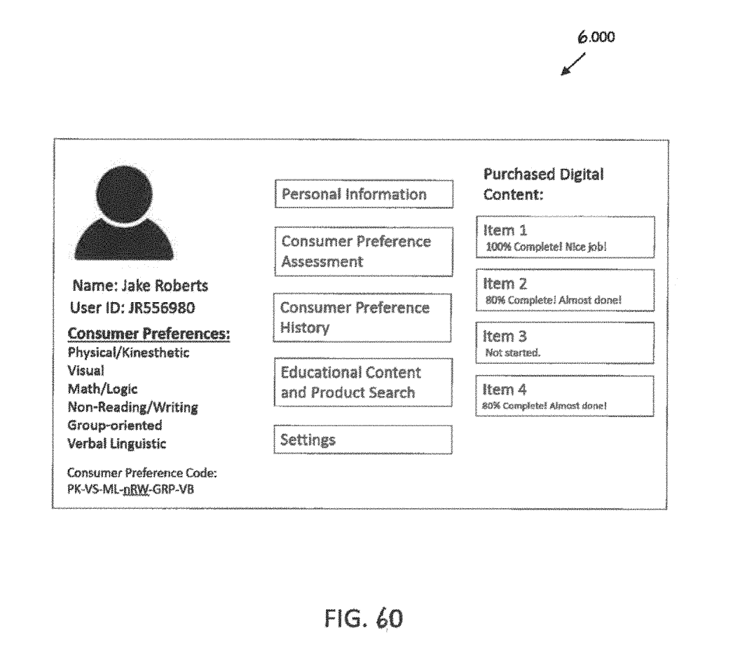

The user profile application 5214 enables collection of user information, such as a user's personal information, to create a user profile consisting of, for example, a student profile, a consumer profile, a provider profile, etc. along with a stored identity associated with the user (e.g., a unique encoded identity). The aforementioned user information may include name, age, address, identity number, school information, grade level, academic interests, academic goals, career goals, academic experience, professional experience, executive functioning skills, cognitive skills, contact information, etc. Moreover, based on the received user information, the user profile application 5214 can generate a user portal (e.g., a student portal, a consumer portal, a provider portal, etc.) in a GUI on a computing device of the user. One exemplary method for generating and utilizing the user profile application 5214 is shown and discussed with reference to FIG. 54, while exemplary user portals or profiles are depicted in FIGS. 60-62 described subsequently herein.

The consumer preference assessment application 5214 enables testing of an individual to determine, for example, a preferred learning style for the individual. For example, a series of questions and/or tasks having two or more selectable and/or fill-in answers are provided either directly or indirectly (via, for example, a teacher) to the individual. In yet another example, multi-sensory assessment is performed via the inclusion of two or more of visual (i.e., displayed pictorial or graphical information), touch (e.g., via the use of touch pads, etc.) and auditory cues (e.g., music, etc.) provided by way of the computing device. In addition, the series of questions and/or tasks can take the form of pictures and/or video having two or more selectable responses for the provided pictures and/or video. In yet other variants, consumer preference can be assessed via so-called augmented reality devices. These augmented reality devices can include, without limitation, for example, the Microsoft HoloLens®, Oculus Rift®, Google Glass® and the like.

Each of the questions and/or tasks are configured to test for various aspects of a given user's consumer preferences such as learning modalities (e.g., physical/kinesthetic, non-physical/kinesthetic, auditory/aural, non-auditory/aural, naturalistic/science, non-naturalistic/science, math/logic, non-math/logic, visual/spatial, non-visual/spatial, reading/writing, non-reading/writing, etc.), social interactions (e.g., group-oriented, self-oriented, etc.), and/or methods of expression (e.g., verbal/linguistic, non-verbal/linguistic, etc.). Based on the selections and/or responses received from the individual, the consumer preference assessment application 5214 determines, for example, a preferred learning style for the individual. The result of the consumer preference assessment is then stored within that user's user profile. Additionally, the execution of the consumer preference assessment application can be repeated over time in order to identify consistency, changes, and/or patterns in consumer preference for a given individual. For example, the consumer assessment application may be executed at regular intervals such as weekly, monthly, quarterly, bi-annually, annually, etc.

In addition to receiving the aforementioned selection/response, in one or more implementations, the consumer preference assessment application may additionally utilize “eye tracking” software in determining/calculating an outcome. The eye tracking software is utilized in conjunction with an eye tracking device. Eye tracking devices can take a variety of forms including, for example, cameras that are native to a user's computing device (e.g., a camera resident on a smartphone or tablet), discrete cameras that are utilized in conjunction with a user's computing device, or even optical head-mounted augmented reality display devices (e.g., Google Glass®). For example, eye tracking may be utilized to assess optokinetic reflex and optokinetic nystagmus for a given individual. Optokinetic reflex refers to a combination of a saccade (e.g., quick, simultaneous movement of both eyes between two or more phases of fixation in the same direction) and smooth pursuit eye movements. It is generally observed when an individual follows a moving object with their eyes but their head remains stationary, which then moves out of the field of vision at which point their eye moves back into position it was in when it first saw the object. Saccade can be associated with a shift in frequency of an emitted signal or a movement of a body part or device. Eye movement measurements of saccade can be used to investigate psychiatric disorders. For example, ADHD is characterized by an increase of anti-saccade errors and an increase in delays for visually guided saccade. Smooth pursuit (e.g., so-called “smooth sweeping”) refers to voluntary movements of both eyes in order to closely follow a moving object. Smooth pursuit is tightly coupled for closed loop pursuit and spatial attention. During the close loop phase selective attention is coupled to the pursuit target such that untracked targets which move in the same direction with the target are pooled processed by the visual system. Eye movement measurements of smooth pursuit can be used to investigate psychiatric disorders. For example, schizophrenic patients have trouble pursing fast targets due to less activation in the front eye field. Optokinetic nystagmus generally consists of initial slow phases in the direction of the stimulus (smooth pursuits), followed by fast, corrective phases (saccade). Presence of nystagmus indicates an intact visual pathway.

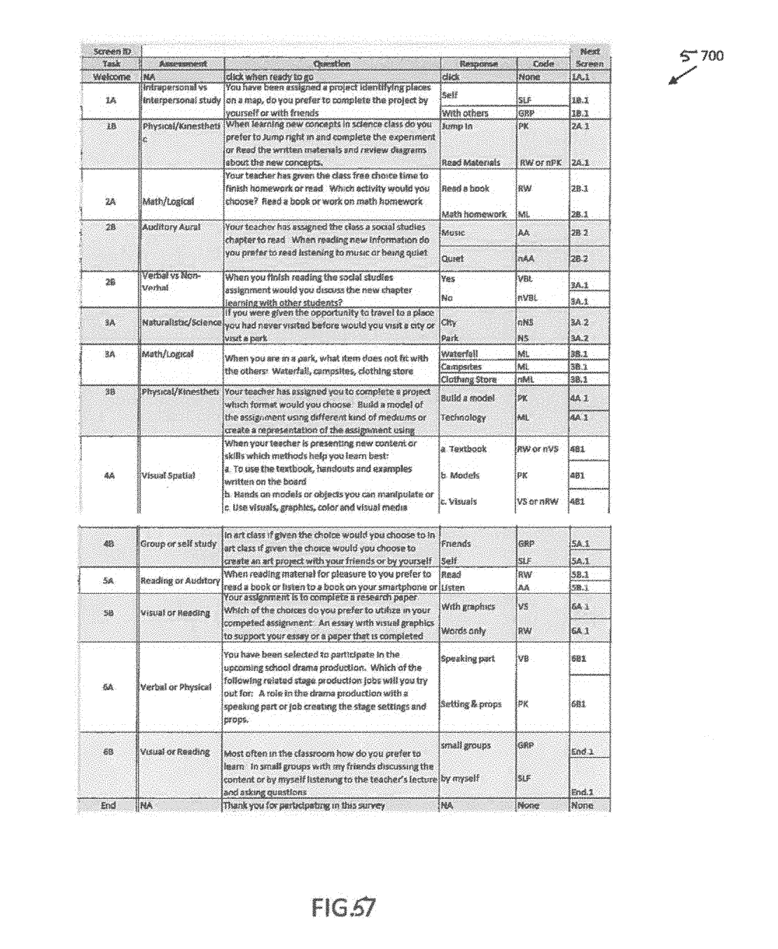

Additionally, so-called augmented reality (AR) can be utilized for cognitive assessments. AR can be utilized in various sensory formats such as visual, auditory or physical (e.g., moving) or combinations of the foregoing. For example, the sensory format chosen for a given individual may be selected by the individual themselves or, alternatively, be selected by another individual such as a parent or a teacher. The questions and/or tasks used in cognitive assessment could then take the form of, for example, a combination of AR and eye tracking in order to help assess various cognitive traits associated with that individual. By utilizing the results of AR and eye tracking to assess various characteristics of a particular individual, content and/or product recommendations can be specifically targeted based on a given individual's cognitive abilities. An exemplary methodology for the consumer preference assessment application 5214 is shown and described subsequently herein with reference to FIG. 54, while example questions/tasks and learning style preferences/codes are depicted in FIGS. 57-59 as well as in Appendices B and C.

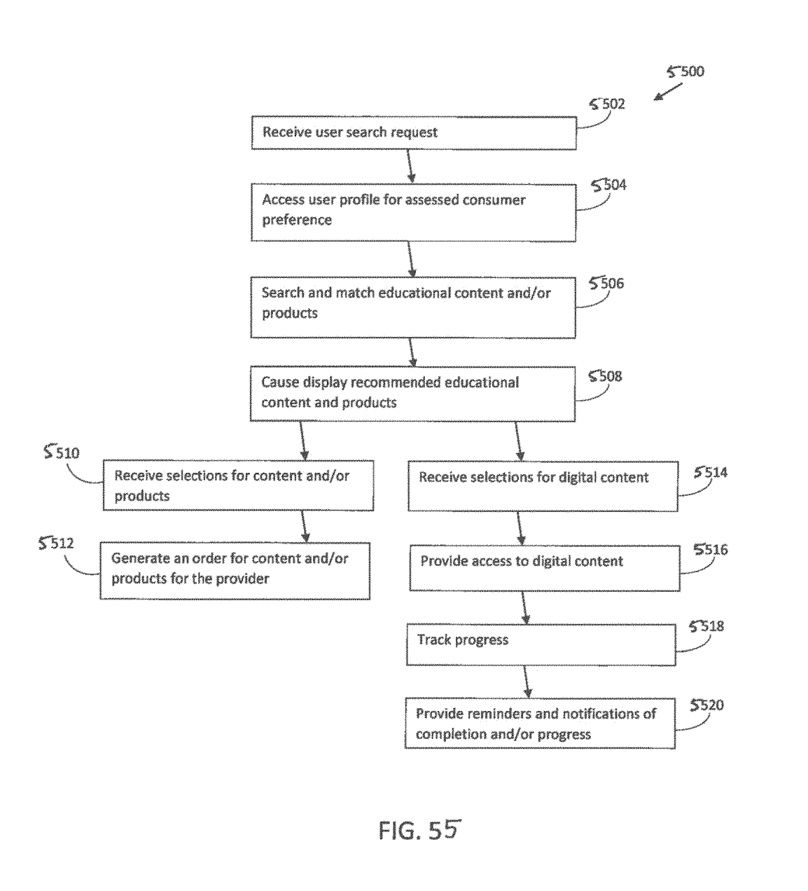

The content and product recommendation application 5218 enables the matching of content and/or products to a given individual that is associated with the identified consumer preference, as determined by the consumer preference assessment application 5216. Additionally, the content and product recommendation application 5218 enables the matching of content and/or products based on other information associated with a given individual including, for example, age, gender, grade level, academic interests, subject areas of interest, topics, historical user activity, etc. In one or more exemplary implementations, each of the content and products are encoded with an identifier that associates respective items with one or more consumer preferences (e.g., learning style preference codes) as well optionally other user specific information including the aforementioned age, gender, grade level, academic interests, subject areas of interest, topics, historical user activity, etc. Accordingly, when a user enters in a search query for particular content or products, the results displayed to the user will be customized to match, or otherwise be correlated with, one or more items contained within that user's profile. For example, in one such instance, content and/or product recommendations can be matched to address a given individual's strengths, or alternatively, content and/or product recommendations can be made so as to address a given individual's weakness for the purpose of, inter alia, enabling the given individual to improve upon their determined weaknesses. Such matching of content or products is enabled via the use of a look-up table or other matching algorithms for identifying and recommending consumer preference content and/or products. Exemplary methodology for the content and product recommendation application 5218 is shown and described subsequently herein with reference to FIG. 55.

The content and product distribution application 5220 enables content and/or product distributors to enter their inventory data via, for example, content and/or product distributors' computing devices 5114. Additionally, the content product and distribution application 5220 enables receipt of user selections as well as payment information for the content and/or products. Accordingly, after a user receives recommendations for content and/or products and makes the decision to purchase a specified item, the content product and distribution application 5220 facilitates the delivery of the item by, for example, enabling receipt of payment, generation of a content/product order, delivery of the content/product order to the distributor, delivery of payment to the distributor, and/or provision of the content/product to the user. In addition, and in instances where the user selection is for digital content, the content product and distribution application 5220 enables transmission and/or access of the digital content to the user. In such examples, the progress of the user through the digital content can be tracked and reminders and/or notifications of completion/progress may be sent to the user computing device. Exemplary methodology for the content product and distribution application 5220 is shown and described subsequently herein with reference to FIG. 55.

### Methods

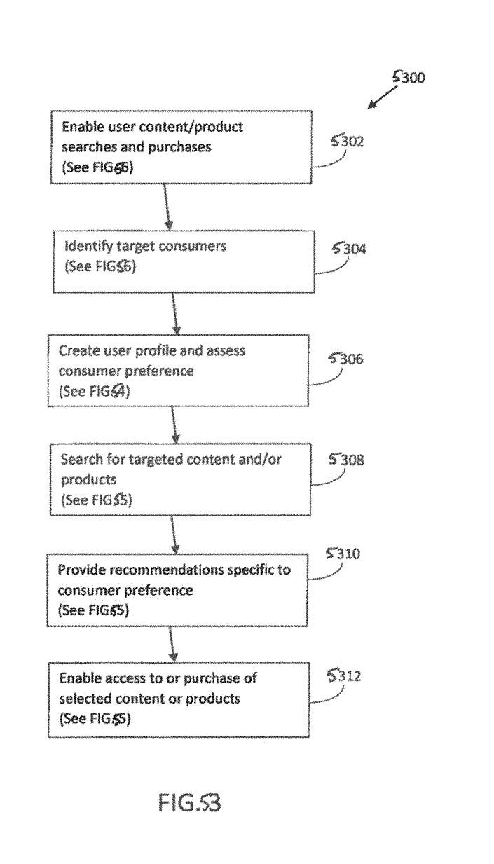

Referring now to FIG. 53 an exemplary methodology 5300 for utilizing the various applications contained with the assessment and recommendation server are illustrated for purposes of facilitating the overall understanding and use of the methodologies described herein. At step 5302, user content/product searches are enabled via, for example, the content and product search application 5212. At step 5304, target consumers are identified for consumer preference assessment and recommendation via, for example, the content and product search application 5212. At step 5306, a user profile is created via, for example, the user profile application 5214 and a user's consumer preference is determined via, for example, the consumer preference assessment application 5216. Subsequent to the determining and storing of a user's determined consumer preference in the user profile, recommendations for content and/or products specific to the determined consumer preference are provided to the user via, for example, the content and product recommendation application 5218 at step 5310. At step 5312, access to the purchase of content and/or products is enabled via, for example, the content and product distribution application 5220.

### Consumer Preference Assessment

An exemplary methodology 5400 for creating a user profile and assessing consumer preference over time is shown in FIG. 54. At step 5402, various user profile data entry fields are displayed to a user in order to facilitate collection of user information. For example, the data entry fields are displayed on a GUI on a user's computing device. These various user profile data entry fields include, for example, name of the user, age of the user, current or prior addresses, user identity number, user's career goals, user's academic experience, user's professional experience, etc. Additionally, or alternatively, prior to the entering of user information, the user may first select or be presented with a user profile type. For example, the user may be a student and select or enter student criteria to create a student profile. In another example, the user may be a mentor, parent, or teacher and select or enter consumer criteria to create a consumer profile. In yet another example, the user may be the representative of a business entity (i.e., content and/or product provider) and select and/or enter entity criteria to create an entity profile. In any of these examples, a credential and/or password may be required to initiate creation of the user profile.

At step 5404, the user information is entered into the various prompted fields in, for example, the GUI displayed on a user's computing device. Additionally, other user information may be automatically populated such as, for example, the user's existing employment records, the user's academic records, user's behavioral records, certifications, and/or other test scores. The user profile is then saved and stored (such as, for example, storing the user profile in database 5104 illustrated in FIG. 51) at step 5406. Further, the user and/or the system may create a log in ID and/or password for subsequent user access to system 5100.

After creating and storing the user profile, consumer preference assessment may be immediately carried out. Alternatively, the user may save the user profile and log in at a later time to complete the consumer preference assessment. In either example, upon initiation of consumer preference assessment, questions and/or tasks are displayed to the user at step 5408. A series of age-appropriate questions and/or tasks having, for example, fill-in and/or two or more selectable answers is provided to the user. By way of example, one question is displayed to the user and after receiving the user answer the following question is displayed. Further, each of the questions and/or tasks is configured to test for one or more aspects or attributes of, for example, a preferred learning style such as learning modalities (e.g., physical/kinesthetic, non-physical/kinesthetic, auditory/aural, non-auditory/aural, naturalistic/science, non-naturalistic/science, math/logic, non-math/logic, visual/spatial, non-visual/spatial, reading/writing, non-reading/writing, etc.), social interactions (e.g., group-oriented, self-oriented, etc.), and/or methods of expression (e.g., verbal/linguistic, non-verbal/linguistic, etc.). Additionally, the presentation and or receipt of a user's responses to the presented questions and/or tasks can be embodied within the aforementioned multi-sensory techniques including, for example, augmented reality equipment and/or eye tracking processes. The user's selections, answers, and/or responses are transmitted to and received at the assessment and recommendation server 5102 (step 5410), where the learning style preference is calculated (step 5412).

An example table of a series of questions for consumer preference assessment 5700 (in particular, learning style preference assessment) is shown in FIG. 57, which may be stored in database 5104 and accessible to assessment and recommendation server 5102. As depicted in FIG. 57, an example assessment table 5700 includes columns for: (i) task identity; (ii) learning style preference assessed via each task; (iii) text for each question; (iv) text for possible responses to each question; (v) learning style preference code results associated with each response; and (v) a next screen code for advancing to the following question. In one or more implementations, the questions contained in, for example, FIG. 57 can be dynamically updated, while the learning style preference codes associated with the questions could remain relatively static. By allowing the questions to be dynamically updated, more accurate assessment of an individual's learning style preference can be obtained. In yet other implementations, a subset of the questions contained within, for example, FIG. 57 can be selected for display based upon, for example, the age of the user, determined developmental ability of the user, etc. These and other variants would be readily apparent to one of ordinary skill given the contents of the present disclosure.

In one example, as indicated in table 5700, Task 1A is configured to determine whether an individual's learning style preference includes a preference for intrapersonal or interpersonal study. In order to carry out the assessment for Task 1A, the text “You have been assigned a project identifying places on a map. Do you prefer to complete the project by yourself or with friends?” is displayed on the GUI along with selectable answers “Self” and “With others”. If the user selects “Self”, the selection is recorded and the learning style preference code “SLF” is associated with Task 1A. Alternatively, if the user selects “With others”, the selection is recorded and the learning style preference code “GRP” is associated with Task 1A.

In another example, also indicated in table 5700, Task 1B is configured to determine whether an individual's learning style preference includes a preference for physical or kinesthetic study. In order to carry out the assessment task 1B, the text “When learning new concepts in science class do you prefer to jump right in and complete the experiment or read the written materials and review diagrams about the new concepts?” is displayed on the GUI along with selectable answers “Jump in” and “Read materials”. If the user selects “Jump in”, the selection is recorded and the learning style preference code “PK” is associated with Task 1B. Alternatively, if the user selects “Read materials”, the selection is recorded and the learning style preference code “RW” or “nPK” is associated with Task 1B.

Upon completion of answering each question, the results associated with each task (i.e., Tasks 1A-6B) are transmitted to the assessment and recommendation server 5102 where the learning style preference for the user is calculated (such as, e.g., the via learning style preference assessment application 5216 and/or via the analysis algorithm configured to determine and calculate the learning style areas of strength and weakness). It will be appreciated that the table of questions for learning style preference assessment shown in FIG. 57 is merely exemplary and other implementations may include differing questions and assessments, more or fewer questions and/or tasks for assessment of learning style preference. Further, other questions and/or tasks may be used to assess learning style preference for different age groups. For example, tasks and/or questions for assessing learning style preference for ages three to five years old is shown in Appendix B.

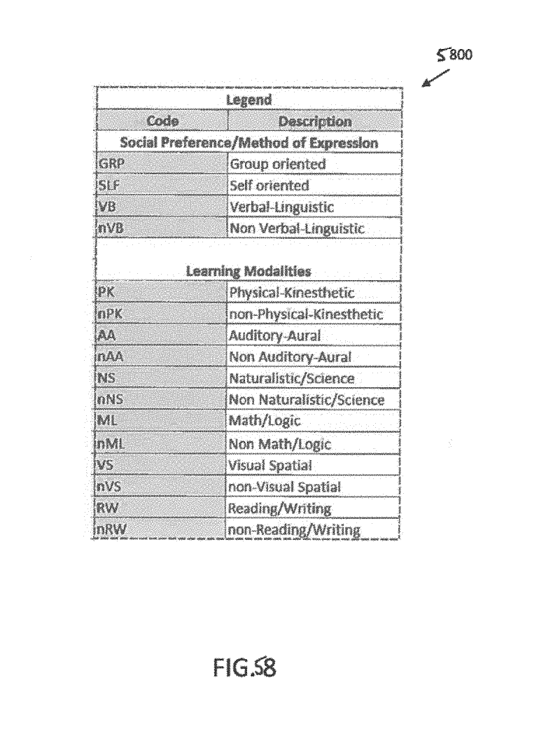

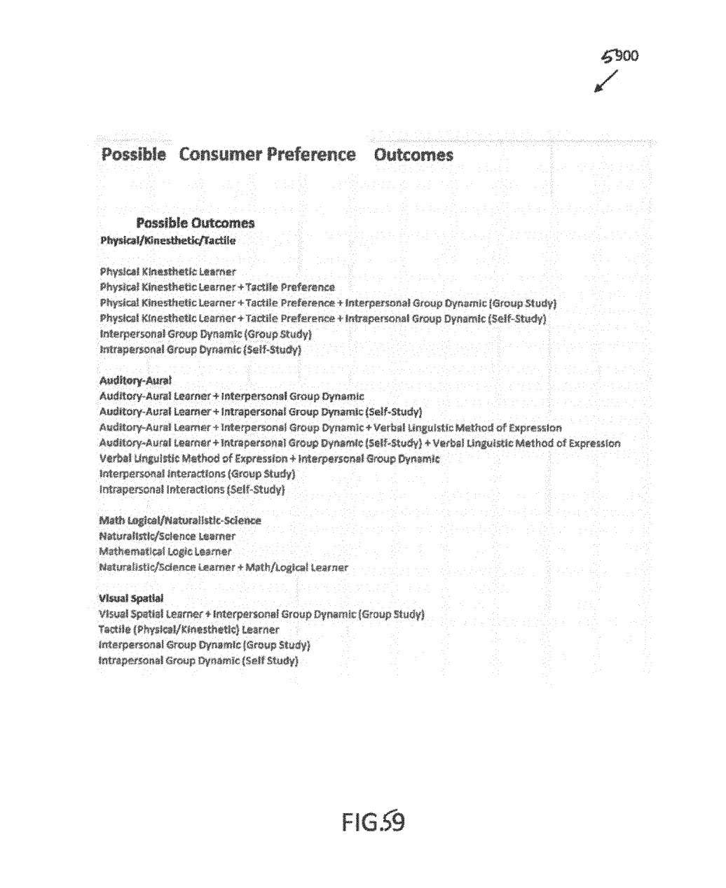

After calculating the encoded user's consumer preference (e.g., learning style preference), the encoded consumer preference is translated into a user-readable consumer preference. FIG. 58 shows an example table including a legend 5800 indicating consumer preference codes (e.g., learning style preference codes) and the corresponding learning style attributes (e.g., social preferences, methods of expression, and learning modalities), while FIG. 59 shows an example Table 5900 including the various possible learning style preference outcomes that may be associated with the user. Returning to FIG. 54, at step 5414, the calculated consumer preference outcome (e.g., one or more of the learning style preferences shown in FIG. 59) is reported and/or stored in the user profile.

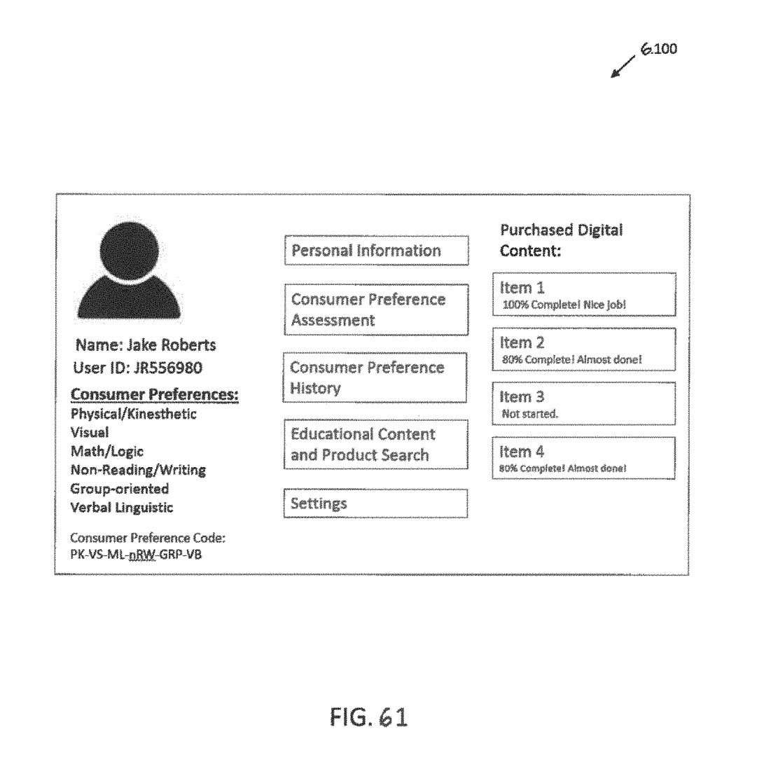

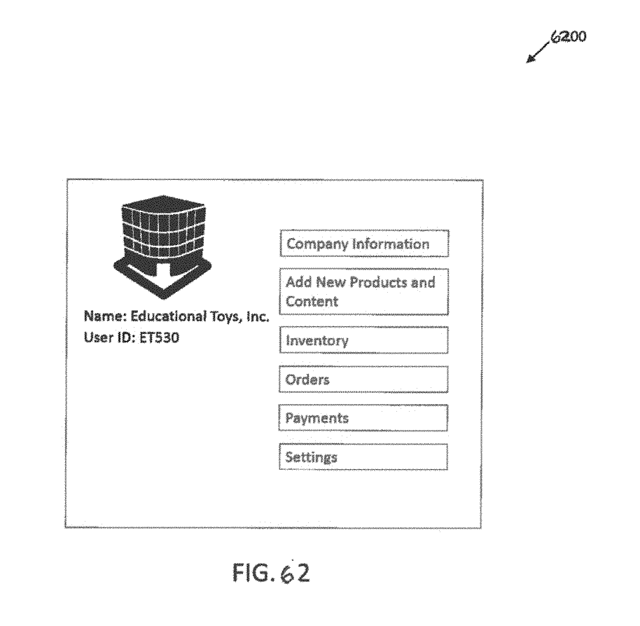

Lastly, at step 5416, consumer preference assessment may optionally be repeated so that a consumer preference of the user is updated over time and stored in the user profile. For example, a preferred learning style of a user may change as the user develops new cognitive skills. Further, changes and/or consistency in consumer preference may be tracked over time to identify patterns, shifts, and/or trends in one individual, multiple individuals, and/or groups of individuals. Moreover, an individual's response to a given content may result in an improvement in other consumer preferences, such as learning style preferences. In an alternative example, the user profile and/or the user's consumer preference can be selectively imported from another source (e.g., a school, a student organization, etc.), which may then be used in subsequent consumer preference-specific content and/or product recommendations. An example of a student user profile 6000 is depicted in FIG. 60. An example of a consumer user profile (i.e., a parent profile) 6100 is depicted in FIG. 61. An example of provider user profile 6200 is depicted in FIG. 62.

Provision of Recommended Educational Content and/or Products

Generally, enabling a search comprises allowing a user to enter one or more queries including search terms and/or selection of categories for content and/or products, and in response a content and product inventory is searched for items relevant to the search criteria and an assessed consumer preference. A listing of the identified relevant or recommended content and product items is then returned and displayed at the user computing device.

An exemplary method 5500 for providing educational and/or product recommendations (i.e., recommendations of educational content or products specific to a user's learning style preference) is shown in FIG. 55. In some examples, the method 5500 is initiated in response to a received request or user-entered search criteria for educational content or products. Alternatively, the method 5500 may automatically be carried out after completion of the learning style preference assessment.

At step 5502, the assessment and recommendation server 5102 receives a request for a content and/or product search from a user (e.g., a consumer, a parent, a student, a teacher, a tutor, etc.). In some examples, the user can request a general search for contents and/or products based on the assessed learning style preference (e.g., a learning style preference of the consumer, a learning style preference of another individual, etc.). In other examples, the user can enter search criteria, such as a subject area (e.g., match, science, literature, etc.) and/or a type of content/product (e.g., games, books, digital content, toys, etc.).

At step 5504, the assessment server 5102 accesses the requesting user's profile stored in database 5104 to obtain the consumer preference associated with the user (e.g., a learning style preference or learning style preference code associated with a user ID). In some examples, the consumer can selectively search for content/products for themselves and therefore the consumer preference associated with the consumer is accessed. In other examples, the consumer can selectively search for content/products for another associated individual (e.g., a student, a child, etc.) and therefore the consumer preference of the other individual is accessed. In such examples, the consumer can select an individual for which he/she is performing the search if the consumer has more than one associated other individuals. In additional other examples, the consumer can selectively search for content/products based on a compiled or combined consumer preference of the consumer and one or more individual profiles (e.g., multiple child profiles). In such examples, the assessment server may compile a combined consumer preference. An example compilation table that can be stored in database 5104 is shown in Appendix C.

At step 5506, method 5500 includes searching and matching of educational content and/or products for items that are appropriate and/or designed for one or more specific consumer preferences (e.g., learning style preferences) such as, e.g., those listed in table 5900 shown in FIG. 59. For example, in addition to matching content and/or products based on a learning style preference or a combined learning style preference, the assessment server 5102 can additionally refine the search according search criteria entered by the consumer (e.g., a subject area, a type of content/product, etc.) and/or other user information. For example, search results can be further refined by information stored in the user profile (e.g., age, sex, grade level, etc.), historical user activity (i.e., previous searches and/or purchases), and/or other criteria (e.g., price, popularity, etc.).

In order to perform matching of educational content and/or products to a user's consumer preference, assessment server 5102 searches inventory stored data database 5104 and/or provider databases (not shown). Each item in the inventory is tagged or otherwise identified with; for example, a learning style preference indicator and/or other metadata indicators (e.g., age appropriateness, sex appropriateness, grade-level appropriateness, popularity, etc.). Moreover, searching may include accessing a look-up table or analysis algorithm for identifying learning style-specific educational content and/or products.

At step 5508, the identified or matched educational content and/or products are returned to the requesting consumer and displayed in a list of recommended content and/or products at the user computing device. Next, user selections are received for content and/or products (step 5510) and orders for the selected content and/or products are generated and transmitted to the provider computing devices 5114 (step 5512). Further, payment may be collected from the user and transmitted to the provider.

Additionally or alternatively, in examples where the recommended items are digital content items, the educational digital content can be selected (step 5514) and then be accessible to the user through the user profile or portal (e.g., student portal 6000 shown in FIG. 60) (step 5516). Per steps 5518 and 5520, method 5500 may optionally include tracking of the user's progress through the content items and additionally provide reminders and notifications of completion and/or progress to the user (e.g., the consumer, another individual, etc.).

### Identification of Candidates for Consumer Preference-Specific Recommendation

As discussed with reference to FIG. 53, in one exemplary method consumers (as well as a consumer's caregiver(s), grandparents, etc.) are identified as candidates for consumer preference-specific recommendations of education content and/or products. For example, user activity may be monitored for searches and/or purchases of educational products and/or digital content. If a pre-determined threshold or parameter is met, the user may be presented with an option or offer to determine a consumer preference of an individual prior to purchase or additional searching. Additionally or alternatively, the user GUI may include an offer for consumer preference assessment unrelated to monitored user activity.

An exemplary method 5600 for user-activity based identification is shown in FIG. 56. At step 5602, user activity is monitored. For example, items that a user selects for viewing and/or items that a user purchases can be monitored during a shopping or browsing session. User activity related to educational content and/or products in then identified at step 5604.

Based on the user activity identified in step 5604, an educational product/content user activity factor is optionally calculated at step 5606. In one example, the activity factor may be a count of educational content and/or products viewed or purchased by the user. In another example, the activity factor may be a percentage of educational content and/or products viewed or purchased by the user within the total viewing/purchasing activity of the user. In either example, at step 5608, it is determined if the activity factor is above a threshold.

In one specific example, the activity threshold may be viewing/purchasing five educational content and/or product items. Accordingly, in this example, in response to the activity factor being less than five items, monitoring of user activity is continued (return to step 5602). Alternatively, in response to the activity factor being greater than five items, an offer or suggestion for consumer preference assessment and recommendation services is displayed to the consumer (step 5610).

In another specific example, the activity threshold may be viewing/purchasing 20% educational content and/or product items out of the user's total viewing/purchasing activity. Accordingly, in this example, in response to the activity factor being less than 20%, monitoring of user activity is continued (return to step 5602). Alternatively, in response to the activity factor being greater than 20%, an offer or suggestion for consumer preference assessment and recommendation services is displayed to the consumer (step 5610).

It will be appreciated that the above described system, apparatus, and methods may address many of the issues identified with prior techniques for content and/or product recommendation. Further, particularly with provision of recommendations based on an assessed learning style preference, the above described system, apparatus, and methods may have significant and broad-reaching impact on improving the quality of education or learning that students may receive using these educational content and/or products.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. A method for provision of single sensory and/or multi-sensory learning style preference assessment, the method comprising:
providing a plurality of questions via a graphical user interface (GUI) on a computing device, the provision of the plurality of questions configured to identify one or more learning style preference attributes;
receiving a plurality of responses from a test subject in response to the provision of the plurality of questions; and
using an assessment server:
calculating a single sensory and/or multi-sensory learning style preference for the test subject based on the received plurality of responses; and
storing the single sensory and/or multi-sensory learning style preference in a user profile for the test subject in memory.

2. The method of claim 1, wherein the calculated single sensory and/or multi-sensory learning style preferences comprise one or more of: naturalistic, logical, auditory, non-auditory, linguistic, non-linguistic, visual, non-visual, tactile, or non-tactile.

3. The method of claim 1, wherein the calculated single sensory and/or multi-sensory learning style preferences comprise an interpersonal preferred method of interaction, the interpersonal preferred method of interaction being one of group dynamic or self-study.

4. The method of claim 1, further comprising providing targeted educational digital content to the test subject in a format specific to the calculated single sensory and/or multi-sensory learning style preference.

5. The method of claim 4, further comprising tracking learning style preference for the test subject over a period of time, where the tracking of the learning style preference for the test subject over the period of time comprises providing additional questions via the computing device subsequent to the calculation of the single sensory and/or multi-sensory learning style preference for the test subject, the provision of the additional questions configured to identify the one or more learning style preference attributes;
receiving a plurality of additional responses from the test subject in response to the provision of the plurality of additional questions; and
using the assessment server:
calculating a single sensory and/or multi-sensory learning style preference for the test subject based on the received plurality of additional responses; and
storing the single sensory and/or multi-sensory learning style preference in the user profile for the test subject in memory.

6. The method of claim 5, wherein the period of time includes traversal by the test subject of a number of grades in school; and
adjusting the provision of targeted educational digital content to the test subject based at least in part on the tracking of learning style preference for the test subject over the period of time.

7. The method of claim 6, further comprising tracking a percentage of completion of the provided targeted educational digital content; and
providing the percentage of completion of the provided targeted educational digital content to a teacher of the test subject.

8. The method of claim 7, further comprising tracking the percentage of completion of the provided targeted educational digital content; and
providing the percentage of completion of the provided targeted educational digital content to a parent of the test subject.

9. The method of claim 6, further comprising tracking a percentage of completion of the provided targeted educational digital content; and
providing the percentage of completion of the provided targeted educational digital content to a tutor of the test subject.

10. A learning style preference assessment apparatus, comprising:
a data processing device configured to process data; and
a computer-readable storage apparatus having a computer program stored thereon, the computer program comprising a plurality of non-transitory computer-readable instructions which, when executed by the data processing device, are configured to cause the data processing device to:
(i) provide a plurality of questions, each of the questions having selectable responses that are configured to identify one or more learning style attributes;
(ii) receive a plurality of selected responses in response to the plurality of questions from one or more test subjects;
(iii) calculate a learning style preference for each of the one or more test subjects; and
(iv) provide digital content to the one or more test subjects in a format specific to the calculated learning style preference.

11. The learning style preference assessment apparatus of claim 10, wherein the plurality of non-transitory computer-readable instructions which, when executed by the data processing device, are further configured to cause the data processing device to:
receive student profile information for each of the one or more test subjects;
store the student profile information in a student user profile for each of the one or more test subjects; and
store the calculated learning style preference in the student user profile.

12. The learning style preference assessment apparatus of claim 11, wherein the plurality of non-transitory computer-readable instructions which, when executed by the data processing device, are further configured to cause the data processing device to:
receive teacher profile information for one or more teachers;
store the teacher profile information in a teacher user profile for each of the one or more teachers;
calculate an assignment for at least a portion of the one or more students to the one of the one or more teachers based at least in part on the stored calculated learning style preference in the student user profile and the stored teacher profile information; and
enable communication between the student user profile and the teacher user profile.

13. The learning style preference assessment apparatus of claim 10, wherein the learning style preference comprises: (1) a quantitative assessment where the learning style preference assessment is based off of specific measurements resultant from the user's selection of an answer to a given question and/or task; and (2) a qualitative assessment where the learning style preference assessment measures a user's perception of the test subjects reaction to a provided question.

14. The learning style preference assessment apparatus of claim 13, wherein the learning style preference comprises a measurement with respect to a cognitive learning preference, the cognitive learning preference being indicative of a preference for either of a visual representation, a mathematical/logical representation, or a social learning preference.

15. The learning style preference assessment apparatus of claim 10, wherein the calculated learning style preference comprise one or more of: naturalistic, logical, auditory, non-auditory, linguistic, non-linguistic, visual, non-visual, tactile, and non-tactile.

16. The learning style preference assessment apparatus of claim 10, wherein the calculated learning style preference comprises an interpersonal preferred method of interaction, the interpersonal preferred method of interaction being one of group dynamic or self-study.

17. The learning style preference assessment apparatus of claim 10, wherein the learning style preference assessment apparatus is further configured to track learning style preference over a period of time for a test subject of the one or more test subjects.

18. The learning style preference assessment apparatus of claim 17, wherein the period of time includes traversal by the test subject of a number of grades in school; and the learning style preference assessment apparatus is further configured to:
adjust the provision of targeted educational digital content to the test subject based at least in part on the tracking of learning style preference for the test subject over the period of time.

19. The learning style preference assessment apparatus of claim 18, wherein the learning style preference assessment apparatus is further configured to:
track a percentage of completion of the provided targeted educational digital content by the test subject; and
provide the percentage of completion of the provided targeted educational digital content to a teacher of the test subject.

20. The learning style preference assessment apparatus of claim 19, wherein the learning style preference assessment apparatus is further configured to:
track the percentage of completion of the provided targeted educational digital content by the test subject; and
provide the percentage of completion of the provided targeted educational digital content to a parent of the test subject.
